(19) United States
(12) Patent Application Publication
(10) Pub. No.: US 2026/0240714 A1
(43) Pub. Date: Aug. 20, 2026

(54) SYSTEMS AND METHODS TO ADMINISTER HYDROTHERAPY

(71) Applicant: Uday DEVANABOYINA, Fremont, CA (US)

(72) Inventor: Uday DEVANABOYINA, Fremont, CA (US)

(21) Appl. No.: 19/180,063

(22) Filed: Apr. 15, 2025

Related U.S. Application Data
(60) Provisional application No. 63/633,862, filed on Apr. 15, 2024.
(60) Provisional application No. 63/786,338, filed on Apr. 10, 2025.

(51) Int. Cl. A61H 9/00; A61H 31/00

(52) U.S. Cl. CPC A61H 9/0021; A61H 31/00; A61H 2201/0103; A61H 2201/0142; A61H 2201/0149; A61H 2201/1207; A61H 2201/1647; A61H 2201/1697; A61H 2201/5007; A61H 2201/5064; A61H 2201/5071; A61H 2201/5082; A61H 2203/0406; A61H 2203/0425

(57) ABSTRACT

According to an embodiment, it is a device comprising a one or more layer bag attached to the device, wherein the one or more layer bag comprises a compartment; wherein the one or more layer bag is filled with the liquid and folded to surround a portion of the user; wherein an inner layer of the one or more layer bag is a thin, flexible, and waterproof membrane that conforms closely to a body shape of the portion of the user and contours such that the user experiences hydrostatic forces and thermal effects of water immersion without direct contact with the liquid; wherein the device is adapted for exerting the hydrostatic forces around the portion of the user while sitting or standing in an upright position to experience buoyancy and simulate zero gravity; and wherein the device is configured to enclose the portion of the user for hydrotherapy.

### CROSS REFERENCE TO RELATED APPLICATIONS

This application claims the benefit under 35 U.S.C § 119 of U.S. Provisional Application No. 63/633,862, filed on Apr. 15, 2024, and U.S. Provisional Application No. 63/786,338, filed on Apr. 10, 2025, which are hereby incorporated by reference in its entirety.

### TECHNICAL FIELD

The present disclosure relates to a system and a method to exert a gradient of external compressive forces on the body of a person, including various internal organ systems, and redistribute the weight, while standing, sitting or lying down in a manner similar to how water exerts a gradient of hydrostatic forces on the body of the immersed person.

### BACKGROUND

Hydrotherapy has been used since ancient times for health benefits and relaxation. Hydrotherapy refers to treatment using the physical properties of water such as temperature, pressure, including massage jets, and hot and cold therapies. Aquatic therapy (aquatic exercise) refers to water-based exercises that offer therapeutic benefits including physical rehabilitation and fitness treatments, focused on functional restoration in many areas including orthopedic, sports, joint and back rehabilitation. Hydrotherapy has shown benefits in several disease conditions including but not limited hypertension, heart failure rehabilitation, hypertensive disorders of pregnancies (e.g., preeclampsia), back pain and spinal cord injuries and various musculoskeletal disorders. However, hydrotherapy is not accessible to everyone due to several factors including fear of drowning, cultural inhibition, infrastructure required to maintain clean and heated water, and adverse effect on the integrity of skin from prolonged exposure to water. Therefore, new innovative approaches are required to make hydrotherapy accessible to everyone.

As humans are bipedal and spend most of their daytime vertically either in standing or sitting position, their organs and physiological systems are subjected to gravitational forces. The effect of gravitational forces leads to various musculoskeletal and cardiovascular conditions including back pain, hypertension, edema, and accumulation of fluid in the dependent portions of the body, preeclampsia, hypotension in clinical shock, motion sickness due to sensory conflict, sleep apnea, heart failure, orthostatic hypotension, nocturia, chronic kidney disease, fluid loss in burn patients, intradialytic hypotension, etc. Several therapeutics options such as diuretics, anti-hypertensive medications, calcium channel blockers, analgesics, etc., and various medical devices are used, but these options do not provide complete relief. Several zero-gravity or anti-gravity chairs in the market require a person to be either reclining or horizontal position, and do not provide any health benefits, similar to hydrotherapy.

Therefore, there is a need for systems and methods to administer hydrotherapy without immersing the patient directly in a body of water. Therefore, there is a need to provide hydrotherapy benefits to the people in all positions including while standing up, seated or lying down, and while keeping them dry.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, disclosed is a device comprising one or more movable panels adapted for entering and exiting of a user; a multi-layer bag is attached to the device, wherein the multi-layer bag comprises an inner layer and an outer layer forming a compartment, and one or more ports; a reservoir comprising a liquid; an inlet pipe connecting the reservoir and the one or more ports to fill the liquid into the multi-layer bag; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the device is adapted for exerting the hydrostatic forces around the portion of the user while sitting or standing in an upright position to experience buoyancy and simulate zero gravity; and wherein the device is configured to enclose the portion of the user and is adapted for hydrotherapy.

According to an embodiment of the device, which optionally includes any one or more of previous embodiments, the device further comprises a pump connecting the reservoir and the inlet pipe to pump the liquid into the multi-layer bag, a power supply unit adapted to supply power to the pump, one or more air pockets on the multi-layer bag to vent out the air when the liquid is being filled, a control unit adapted to control the device, an emergency access button adapted for providing access to the user in case of an emergency, a breathable cover attached to the inner layer, a temperature control unit integrated with the device adapted to maintain the liquid at a predetermined temperature, one or more sensors to measure one or more of a pressure, a temperature, a humidity, a physiological signal of the user, a presence of the user, a weight of the user, one or more vents adapted for providing ventilation in the device for the user, or one or more linear actuators adapted to adjust an angle of a part of the device.

According to an embodiment of the device, which optionally includes any one or more of previous embodiments, the device further comprises cushions, one or more of wheels, a collapsible door, or water jets.

According to an embodiment of the device, which optionally includes any one or more of previous embodiments, the device further comprises roller blades, or pedal and crank.

According to an embodiment of the device, which optionally includes any one or more of previous embodiments, the device is adapted for rapid discharge of the liquid.

According to an embodiment of the device, which optionally includes any one or more of previous embodiments, the device further comprises auxiliary power supply unit.

According to an embodiment of the device, which optionally includes any one or more of previous embodiments, the multi-layer bag is a removable bag.

According to an embodiment of the device, which optionally includes any one or more of previous embodiments, the device is configured as a chair, a bed, a suit, a treadmill, a bike, a waterbirth device, a dry immersion jacuzzi, a patient transporter, or a cardiopulmonary resuscitation device.

According to an embodiment of the device, which optionally includes any one or more of previous embodiments, the device is further configured to increase or decrease volume of water in the multi-layer bag.

According to an embodiment of the device, which optionally includes any one or more of previous embodiments, the device is configured for use in treatment using the hydrotherapy in preeclampsia, clinical shock, hypertension, orthostatic hypotension, intradialytic hypotension, edema of lower extremities, burn injuries, sleep apnea, cardiovascular diseases, cardiopulmonary resuscitation, or dialysis.

According to an embodiment of the device, which optionally includes any one or more of previous embodiments, the device is adapted to be controlled remotely.

According to an embodiment of the device, which optionally includes any one or more of previous embodiments, the reservoir is adjustable in height.

According to an embodiment of the device, which optionally includes any one or more of previous embodiments, the device further comprises chest compression device.

According to an embodiment of the device, which optionally includes any one or more of previous embodiments, the power supply unit is connected to one of an external power supply and a battery.

According to an embodiment of the device, which optionally includes any one or more of previous embodiments, the one or more movable panels comprises one of a shutter door, roller door, a sliding door, and a hinged door.

According to an embodiment of the device, which optionally includes any one or more of previous embodiments, the emergency access button is adapted to change a configuration of the device for emergency access of the user and emptying the multi-layer bag of liquid within a predetermined time, wherein the predetermined time as per a medical regulation.

According to an embodiment, disclosed is a chair comprising one or more movable panels adapted for entering and exiting of a user; a multi-layer bag is attached to the chair, wherein the multi-layer bag an inner layer and an outer layer forming a compartment, and one or more ports; a reservoir comprising a liquid; one or more air pockets on the multi-layer bag; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the chair is adapted for exerting the hydrostatic forces around the portion of the user while sitting or standing in an upright position to experience buoyancy and simulate zero gravity; and wherein the chair is configured to enclose the portion of the user and is adapted for hydrotherapy.

According to an embodiment of the chair, which optionally includes any one or more of previous embodiments, the chair further comprises a pump connecting the reservoir and the one or more ports to pump the liquid into the multi-layer bag, a power supply unit adapted to supply power to the pump; a breathable cover attached to the inner layer, a temperature control unit integrated with the chair adapted to maintain the liquid at a predetermined temperature, one or more sensors to measure one or more of a pressure, a temperature, a humidity, a physiological signal of the user, a presence of the user, a weight of the user, a control unit adapted to control the chair, an emergency access button adapted for providing access to the user in case of an emergency, one or more vents adapted for providing ventilation in the chair for the user, or one or more linear actuators for adjusting one or more of an angle of a backrest and an angle of a footrest of the chair.

According to an embodiment of the chair, which optionally includes any one or more of previous embodiments, the chair comprises wheels adapted for moving the chair on a floor.

According to an embodiment of the chair, which optionally includes any one or more of previous embodiments, the multi-layer bag is removable.

According to an embodiment of the chair, which optionally includes any one or more of previous embodiments, the chair further comprises cushions.

According to an embodiment of the chair, which optionally includes any one or more of previous embodiments, the chair further comprises a collapsible door.

According to an embodiment, disclosed is a bed comprising one or more movable panels adapted for entering and exiting of a user; a multi-layer bag is attached to the bed, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the bed is adapted for exerting the hydrostatic forces around the portion of the user while sitting or standing in an upright position to experience buoyancy and simulate zero gravity; and wherein the bed is configured to enclose the portion of the user and is adapted for hydrotherapy.

According to an embodiment of the bed, which optionally includes any one or more of previous embodiments, the bed further comprises a reservoir comprising a liquid, one or more air pockets on the multi-layer bag, a breathable cover attached to the inner layer, a temperature control unit integrated with the bed adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag,
a power supply unit adapted to supply power to the pump, a control unit adapted to control the bed, an emergency access button adapted for providing access to the user in case of an emergency, one or more vents adapted for providing ventilation in the bed for the user, or one or more linear actuators for adjusting one or more of an angle of a backrest and an angle of a footrest of the bed.

According to an embodiment of the bed, which optionally includes any one or more of previous embodiments, the bed comprises wheels adapted for moving the bed on a floor.

According to an embodiment of the bed, which optionally includes any one or more of previous embodiments, the multi-layer bag is removable.

According to an embodiment of the bed, which optionally includes any one or more of previous embodiments, the bed further comprises cushions.

According to an embodiment of the bed, which optionally includes any one or more of previous embodiments, the bed further comprises a collapsible door.

According to an embodiment, disclosed is a suit comprising one or more openings adapted for entering and exiting of a user; a multi-layer bag is attached to the suit, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the suit is adapted for exerting the hydrostatic forces around the portion of the user while sitting or standing in an upright position to experience buoyancy and simulate zero gravity; and wherein the suit is configured to enclose the portion of the user and is adapted for hydrotherapy.

According to an embodiment of the suit, which optionally includes any one or more of previous embodiments, the suit further comprises one or more air pockets on the multi-layer bag, a breathable cover attached to the inner layer, a reservoir comprising a liquid, a temperature control unit integrated with the suit adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag,
a power supply unit adapted to supply power to the pump, a control unit adapted to control the suit, an emergency access button adapted for providing access to the user in case of an emergency, or one or more vents adapted to provide ventilation in the suit for the user, and wherein the multi-layer bag is removable.

According to an embodiment, disclosed is a treadmill comprising one or more movable panels adapted for entering and exiting of a user; a multi-layer bag is attached to the treadmill, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the treadmill is adapted for exerting the hydrostatic forces around the portion of the user while sitting or standing in an upright position to experience buoyancy and simulate zero gravity; and wherein the treadmill is configured to enclose the portion of the user and is adapted for hydrotherapy.

According to an embodiment of the treadmill, which optionally includes any one or more of previous embodiments, the treadmill further comprises one or more air pockets on the multi-layer bag, a breathable cover attached to the inner layer, a reservoir comprising a liquid, a temperature control unit integrated with the treadmill adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the treadmill, an emergency access button adapted for providing access to the user in case of an emergency, one or more vents adapted for providing ventilation in the device for the user, or roller blades.

According to an embodiment of the treadmill, which optionally includes any one or more of previous embodiments, the treadmill further comprises auxiliary power supply unit.

According to an embodiment, disclosed is a bike comprising one or more movable panels adapted for entering and exiting of a user; a multi-layer bag is attached to the bike, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the bike is adapted for exerting the hydrostatic forces around the portion of the user while sitting or standing in an upright position to experience buoyancy and simulate zero gravity; and wherein the bike is configured to enclose the portion of the user and is adapted for hydrotherapy.

According to an embodiment of the bike, which optionally includes any one or more of previous embodiments, the bike further comprises one or more air pockets on the multi-layer bag, a breathable cover attached to the inner layer, a reservoir comprising a liquid, a temperature control unit integrated with the bike adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the bike, an emergency access button adapted for providing access to the user in case of an emergency, one or more vents adapted for providing ventilation in the device for the user, or wheels adapted for transportability of the bike.

According to an embodiment of the bike, which optionally includes any one or more of previous embodiments, the bike further comprises pedal and crank.

According to an embodiment of the bike, which optionally includes any one or more of previous embodiments, the bike further comprises auxiliary power supply unit.

According to an embodiment, disclosed is a waterbirth device comprising one or more movable panels adapted for entering and exiting of a user; a multi-layer bag is attached to the waterbirth device, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the waterbirth device is adapted for exerting the hydrostatic forces around the portion of the user while sitting or standing in an upright position to experience buoyancy and simulate zero gravity; and wherein the waterbirth device is configured to enclose the portion of the user and is adapted for hydrotherapy.

According to an embodiment of the waterbirth device, which optionally includes any one or more of previous embodiments, the waterbirth device further comprises one or more air pockets on the multi-layer bag, a breathable cover attached to the inner layer, a reservoir comprising a liquid, a temperature control unit integrated with the waterbirth device adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the waterbirth device, an emergency access button adapted for providing access to the user in case of an emergency, one or more vents adapted for providing ventilation in the device for the user, or one or more linear actuators for adjusting one or more of a height, an angle of a backrest and an angle of a footrest of the waterbirth device.

According to an embodiment of the waterbirth device, which optionally includes any one or more of previous embodiments, the waterbirth device comprises wheels adapted for moving the waterbirth device on a floor.

According to an embodiment of the waterbirth device, which optionally includes any one or more of previous embodiments, the multi-layer bag is removable.

According to an embodiment of the waterbirth device, which optionally includes any one or more of previous embodiments, the waterbirth device further comprises cushions.

According to an embodiment of the waterbirth device, which optionally includes any one or more of previous embodiments, the waterbirth device further comprises a collapsible door.

According to an embodiment, disclosed is a dry immersion jacuzzi comprising one or more movable panels adapted for entering and exiting of a user; a multi-layer bag is attached to the dry immersion jacuzzi, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the dry immersion jacuzzi is adapted for exerting the hydrostatic forces around the portion of the user while sitting or standing in an upright position to experience buoyancy and simulate zero gravity; and wherein the dry immersion jacuzzi is configured to enclose the portion of the user and is adapted for hydrotherapy.

According to an embodiment of the dry immersion jacuzzi, which optionally includes any one or more of previous embodiments, the dry immersion jacuzzi further comprises one or more air pockets on the multi-layer bag, a breathable cover attached to the inner layer, a reservoir comprising a liquid, a temperature control unit integrated with the dry immersion jacuzzi adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the dry immersion jacuzzi, an emergency access button adapted for providing access to the user in case of an emergency, one or more vents adapted for providing ventilation in the device for the user, or wheels adapted for moving the dry immersion jacuzzi on a floor.

According to an embodiment of the dry immersion jacuzzi, which optionally includes any one or more of previous embodiments, the multi-layer bag is removable.

According to an embodiment of the dry immersion jacuzzi, which optionally includes any one or more of previous embodiments, the dry immersion jacuzzi further comprises cushions.

According to an embodiment of the dry immersion jacuzzi, which optionally includes any one or more of previous embodiments, the dry immersion jacuzzi further comprises water jets.

According to an embodiment, disclosed is a patient transport device comprising one or more movable panels adapted for entering and exiting of a user; a multi-layer bag is attached to the patient transport device, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the patient transport device is adapted for exerting the hydrostatic forces around the portion of the user while sitting or standing in an upright position to experience buoyancy and simulate zero gravity; and wherein the patient transport device is configured to enclose the portion of the user and is adapted for hydrotherapy.

According to an embodiment of the patient transport device, which optionally includes any one or more of previous embodiments, the patient transport device further comprises one or more air pockets on the multi-layer bag, a breathable cover attached to the inner layer, a reservoir comprising a liquid, a temperature control unit integrated with the patient transport device adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the patient transport device, an emergency access button adapted for providing access to the user in case of an emergency, one or more vents adapted for providing ventilation in the device for the user; or one or more linear actuators for adjusting a height and an angle of the patient transport device.

According to an embodiment of the patient transport device, which optionally includes any one or more of previous embodiments, the patient transport device comprises wheels adapted for moving the patient transport device on a floor.

According to an embodiment of the patient transport device, which optionally includes any one or more of previous embodiments, the multi-layer bag is removable.

According to an embodiment of the patient transport device, which optionally includes any one or more of previous embodiments, the patient transport device further comprises cushions, or a collapsible door.

According to an embodiment, disclosed is a cardiopulmonary resuscitation device comprising one or more movable panels adapted for entering and exiting of a user; a multi-layer bag is attached to the cardiopulmonary resuscitation device, wherein the multi-layer bag comprises an inner layer and an outer layer forming a compartment, and one or more ports; one or more air pockets on the multi-layer bag; a breathable cover attached to the inner layer; a reservoir comprising a liquid; a temperature control unit integrated with the cardiopulmonary resuscitation device adapted to maintain the liquid at a predetermined temperature; one or more sensors to measure one or more of a pressure, a temperature, a humidity, a physiological signal of the user, a presence of the user, a weight of the user; a pump connecting the reservoir and the one or more ports to pump the liquid into the multi-layer bag; a power supply unit adapted to supply power to the pump; a control unit adapted to control the cardiopulmonary resuscitation device; an emergency access button adapted for providing access to the user in case of an emergency; one or more vents adapted for providing ventilation in the device for the user; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the cardiopulmonary resuscitation device is adapted for exerting the hydrostatic forces around the portion of the user while sitting or standing in an upright position to experience buoyancy and simulate zero gravity; and wherein the cardiopulmonary resuscitation device is configured to enclose the portion of the user and is adapted for hydrotherapy.

According to an embodiment of the cardiopulmonary resuscitation device, which optionally includes any one or more of previous embodiments, the cardiopulmonary resuscitation device further comprises one or more linear actuators for adjusting a height and an angle of the cardiopulmonary resuscitation device; and wherein the cardiopulmonary resuscitation device comprises wheels adapted for moving the cardiopulmonary resuscitation device on a floor.

According to an embodiment of the cardiopulmonary resuscitation device, which optionally includes any one or more of previous embodiments, the multi-layer bag is removable.

According to an embodiment of the cardiopulmonary resuscitation device, which optionally includes any one or more of previous embodiments, the cardiopulmonary resuscitation device further comprises chest compression device.

According to an embodiment of the cardiopulmonary resuscitation device, which optionally includes any one or more of previous embodiments, the cardiopulmonary resuscitation device further comprises a mechanism to increase or decrease volume of the fluid.

According to an embodiment of the cardiopulmonary resuscitation device, which optionally includes any one or more of previous embodiments, the cardiopulmonary resuscitation device further comprises a collapsible door.

According to an embodiment, disclosed is a method comprising, positioning a user in a resting area of a device by moving a movable panel adapted to accommodate at least a portion of the user; closing the movable panel of the device such that a multi-layer bag is surrounds the portion of the user, wherein the multi-layer bag is attached to the device, wherein the multi-layer bag comprises an inner layer and an outer layer forming a compartment, and one or more ports, and wherein the inner layer is a thin, flexible, and waterproof membrane that conforms closely to a body shape of the portion of the user and contours such that the user experiences hydrostatic forces and thermal effects of water immersion without direct contact with a liquid;

pumping the liquid, using a pump connected to a reservoir, into the multi-layer bag, wherein the multi-layer bag filled with fluid is folded to surround the portion of the user; controlling one or more of pressure and temperature of the liquid in the multi-layer bag for a hydrotherapy according to one or more of a pre-programmed sequence and in response to real-time input, wherein the control is based on at least one of treatment duration, target anatomical region, intensity level, and feedback from a sensor detecting one or more of a position and physiological response of the user; continuing the hydrotherapy for a predefined period; wherein the device is adapted for exerting the hydrostatic forces around the portion of the user while sitting or standing in an upright position to experience buoyancy and simulate zero gravity; and wherein the device is configured to enclose the portion of the user, and the method is adapted for providing the hydrotherapy.

According to an embodiment, disclosed is a system comprising a device, wherein the device comprises one or more movable panels adapted for entering and exiting of a user; a multi-layer bag attached to the device, wherein the multi-layer bag comprises an inner layer and an outer layer forming a compartment, and one or more ports, and wherein the inner layer is a thin, flexible, and waterproof membrane that conforms closely to a body shape of a portion of the user and contours such that the user experiences hydrostatic forces and thermal effects of water immersion without direct contact with a liquid; a reservoir comprising the liquid; a pump connecting the reservoir and the one or more ports to pump the liquid into the multi-layer bag; a power supply unit adapted to supply power to the pump; one or more air pockets on the multi-layer bag; a temperature control unit integrated with the device adapted to maintain the liquid at a predetermined temperature; a control unit adapted to control the device; an emergency access button adapted for providing access to the user in case of an emergency; and wherein the device is adapted for exerting the hydrostatic forces around the portion of the user while sitting or standing in an upright position to experience buoyancy and simulate zero gravity; and wherein the system is adapted for carrying out the steps comprising, positioning the user in a resting area of the device by moving the one or more movable panels adapted to accommodate at least the portion of the user; closing the one or more movable panels of the device such that the multi-layer bag is surrounding the portion of the user; pumping the liquid, using the pump into the multi-layer bag, wherein the multi-layer bag filled with fluid is folded to surround the portion of the user; controlling one or more of pressure and temperature of the liquid in the multi-layer bag for a hydrotherapy according to one or more of a pre-programmed sequence and in response to real-time input, wherein the control is based on at least one of treatment duration, target anatomical region, intensity level, and feedback from a sensor detecting one or more of a position and physiological response of the user; continuing the hydrotherapy for a predefined period; and wherein the steps are adapted for hydrotherapy.

According to an embodiment, disclosed is a device comprising one or more movable panels adapted for entering and exiting of a user; a layer attached to the device, wherein the layer forms a compartment between the device and the layer; a reservoir comprising a liquid; a pump connecting the reservoir to pump the liquid into the compartment; a power supply unit adapted to supply power to the pump; and wherein the compartment is filled with the liquid such that the layer is folded to surround a portion of the user; wherein the layer is a thin, flexible, and waterproof membrane that conforms closely to a body shape of the portion of the user and contours such that the user experiences hydrostatic forces and thermal effects of water immersion without direct contact with the liquid; wherein the device is adapted for exerting the hydrostatic forces around the portion of the user while sitting or standing in an upright position to experience buoyancy and simulate zero gravity; and wherein the device is adapted for hydrotherapy.

According to an embodiment of the device, which optionally includes any one or more of previous embodiments, the layer comprises one or more layers.

### BRIEF DESCRIPTION OF THE FIGURES

These and other aspects of the present disclosure will now be described in more detail, with reference to the appended drawings showing exemplary embodiments in the present disclosure, in which:

FIG. 1 shows a chair with a flexible door with a zipper opening according to embodiment.

FIG. 2A and FIG. 2B show a chair with a flexible door where the flexible door is in the open position according to an embodiment.

FIG. 3 shows the chair with a flexible bag attached to the chair and the door in an open position.

FIG. 4A shows the multi-layer bag according to an embodiment.

FIG. 4B shows the multi-layer bag with inlet ports and outlet ports according to an embodiment.

FIG. 4C shows a chair with handle area and attachment points of the multi-layer bag to the chair according to an embodiment.

FIG. 4D shows a chair with handle area and attachment points of the multi-layer bag to the chair according to an embodiment.

FIG. 4E shows a chair with a handle area in which the inner and outer layers are attached to the chair according to an embodiment.

FIG. 4F shows the layout of the inner and outer layers and their attachment points for attaching to the chair.

FIG. 5A and FIG. 5B show the multi-layer bag with attachment points according to an embodiment.

FIG. 6 shows a simple chair attached with a removable multi-layer bag according to an embodiment.

FIG. 7A and FIG. 7B show a layout of a removable multi-layer bag according to an embodiment.

FIG. 8A and FIG. 8B show a model of a door for the chair according to an embodiment.

FIG. 9 shows a model of a door for the chair that can be used according to an embodiment.

FIG. 10A, FIG. 10B, FIG. 10C, and FIG. 10D show a model of a door for the chair that can be used according to an embodiment.

FIG. 11 shows a model of a door in open position for the chair according to an embodiment.

FIG. 12A, FIG. 12B and FIG. 12C show arrangement of reservoirs according to an embodiment.

FIG. 13A, FIG. 13B, and FIG. 13C show a reservoir, linear actuators, and collapsible door for the chair according to an embodiment.

FIG. 14 shows the furniture or chair in a reclined position and footrest adjusted to an angle.

FIG. 15 shows the linear actuators positioned under the chair to change the position of the backrest and the foot box to the desired position according to an embodiment.

FIG. 16A, FIG. 16B, and FIG. 16C show the linear actuators positioned under the chair/bed to change the inclination angle of the backrest and the foot box to the desired position according to an embodiment.

FIG. 16D, FIG. 16E, and FIG. 16F show the linear actuators positioned under the chair/bed to change a height, inclination angle of the backrest, inclination angle of the foot box according to an embodiment.

FIG. 17A, FIG. 17B, FIG. 17C, FIG. 17D, and FIG. 17E show a variation of exercise equipment according to an embodiment.

FIG. 18A shows a user exercising in exercise equipment according to an embodiment.

FIG. 18B shows an enclosure for users to use with an exercise device according to an embodiment.

FIG. 18C, FIG. 18D, FIG. 18E, and FIG. 18F show cross-sectional views of FIG. 18B according to an embodiment.

FIG. 19A, FIG. 19B, and FIG. 19C show a treadmill according to one or more embodiments.

FIG. 20, FIG. 21, and FIG. 22 shows a user using the chair according to an embodiment.

FIG. 23A, FIG. 23B, and FIG. 23C show the multi-layer bag that is used for surrounding the user according to an embodiment.

FIG. 24A, FIG. 24B, and FIG. 24C show a chair structure where separate compartments are provided for each leg according to an embodiment.

FIG. 25 shows a walk-in bathtub with storage tank according to an embodiment.

FIG. 26, FIG. 27, and FIG. 28 show a waterbirth chair/bed according to an embodiment.

FIG. 29A shows buoyancy data of the chair under testing according to an embodiment.

FIG. 29B shows cardiovascular ejection fraction according to an embodiment.

FIG. 29C shows data from the prototype testing of the recliner chair with angle adjustable footrest according to an embodiment

FIG. 30A and FIG. 30B show a prototype of the chair according to an embodiment.

FIG. 31 shows a chair comprising a multi-layer bag, entry and exit door, and a collapsible door according to an embodiment.

FIG. 32 shows a jacuzzi comprising a multi-layer bag, entry and exit door according to an embodiment.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and similar expressions, both in the description and in any accompanying claims, serve to differentiate among comparable elements and do not inherently denote a specific sequence or chronological order. These terms are interchangeable under suitable circumstances, allowing the embodiments herein, for instance, to function in sequences different from those explicitly depicted or described. Moreover, the terms “include,” “have,” and their variations encompass a non-exclusive sense, implying that a process, method, system, article, device, or apparatus comprising a list of elements is not strictly limited to those elements. It may involve other elements not explicitly mentioned or inherent to the described process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, the term “one of A, B, and C” shall be understood to mean “only A, only B, or only C,” and not a combination of A, B, and C.

As used herein, the term “one or more of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, the term “at least one of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, two or more elements are “integral” if they comprise the same piece of material or if they operate functionally together. Two or more elements are “non-integral” if each comprises a different piece of material or if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein, the term “component” broadly construes hardware, firmware, and/or a combination of hardware, firmware, and software.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer readable storage medium for execution by, or to control the operation of, data processing apparatus. The computer readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer readable media suitable for storing computer program instructions and data include all forms of non-volatile memory, media and memory devices, including, by way of example, semiconductor memory devices (e.g., Erasable Programmable Read Only Memory (EPROM), Electronically Erasable Programmable Read Only Memory (EEPROM), and flash memory devices), magnetic disks (e.g., internal hard disks or removable disks), magneto optical disks (e.g. Compact Disk Read Only Memory (CD-ROM) disks, Digital Versatile Disk Read Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship between the client and server arises by virtue of computer programs running on the respective computers and having a client-server relationship with each other.

Embodiments may comprise or utilize a special purpose or general-purpose computer including computer hardware. Embodiments within the scope of the present disclosure may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specifications and drawings are illustrative rather than restrictive.

Physical computer readable storage media includes RAM, ROM, EEPROM, CD-ROM or other optical disk storage (such as Compact Disks (CDs), Digital Versatile Disks (DVDs), etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices.

Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Circuit (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

As used herein, the term “IoT” stands for Internet of Things which describes the network of physical objects “things” or objects embedded with sensors, software, and other technologies for the purpose of connecting and exchanging data with other devices and systems over the internet.

As used herein, a “Sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The embodiments described herein can be directed to one or more of a system, a method, an apparatus, and/or a computer program product at any possible technical detail level of integration. The computer program product can include a computer-readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include: a portable computer diskette, a hard disk, a random access memory (RAM), a read only memory (ROM), an erasable programmable read only memory (EPROM or Flash memory), a static random access memory (SRAM), a portable compact disk read only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages. Programming languages may be high level programming languages, low level programming languages, compiled languages, interpreted languages, scripting languages, functional programming languages, markup languages etc. It includes object-oriented programming languages such as Smalltalk, C++ or the like, and/or procedural programming languages, such as the “C” programming language and/or similar programming languages. The computer readable program instructions can execute entirely on a computer, partly on a computer, as a standalone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multi-processor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, standalone computers can practice one or more, if not all aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or non-volatile memory or can include both volatile and non-volatile memory. By way of illustration, and not limitation, non-volatile memory can include read only memory (ROM), programmable ROM (PROM), electrically programmable ROM (EPROM), electrically erasable ROM (EEPROM), flash memory, and/or non-volatile random-access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM

(SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one with ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings, such terms are intended to be inclusive in a manner similar to the term “comprising”, as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the embodiments described. The terminology used herein best explains the principles of the embodiments, the practical application and/or technical improvement over technologies found in the marketplace, and/or to enable others of ordinary skill in the art to understand the embodiments described herein.

As used herein the term “multi-layer bag” also referred to as “multi-layer flexible bag” refers to a structure composed of plurality of distinct, flexible material layers arranged in a manner that contains fluid between the layers. Each layer may serve a unique mechanical, thermal, or chemical function, and the layers are typically bonded, sealed, or independently maintained to create separate internal or interstitial spaces, also referred to as compartment. Interstitial space refers to the gap between the inner and outer layers. The outer layer may be an integral layer of the device on which the multi-layer flexible bag is being used and thus the multi-layer bag is referred to as single-layer bag. It is used to describe the flexible and semiflexible bags that are filled with any liquid, without limitation in order to exert hydrostatic pressure on the person seated in the chair or other devices. The bag together with the device such as chair or the exercise devices disclosed are designed to exert hydrostatic forces on a person, in any position, while standing up, sitting, exercising, or lying down to provide maximum benefits of hydrotherapy in various disease conditions, without the user getting wet. Inner layer can be a thin, flexible, and waterproof membrane that conforms closely to a body shape of the portion of the user and contours such that the user experiences hydrostatic forces and thermal effects of water immersion without direct contact with a liquid. The multi-layer bag is a bag designed to hold liquid. There is no limitation on the layers, as additional fabric on the inside (soft cloth) and/or a net type of fabric with holes may be used to protect the outer layer. The inner protective fabric protects the inner layer and prevents the inner layer contact with the skin of the person, while the outer protective layer with holes (like net) would allow for water to pass through to exert force but protects the outer layer from undue stretching or damage.

As used herein the term “hydrotherapy” and “aquatic therapy” refer to hydrotherapy.

As used herein the term “hydrotherapy chair” or “therapy chair” refers to is a specialized device designed to provide support, adjustability, and therapeutic benefits including hydrotherapy to individuals undergoing medical treatments, physical therapy, or rehabilitation. It is engineered to provide therapeutic interventions, hydrostatic forces, accommodate various medical devices, and accommodate users with various medical conditions or mobility limitations. The chair can also serve relaxation purpose to reduce stress, due to its buoyancy effects on the body and ability to provide massage to the body through various hydro jets and/or massage rollers.

As used herein the term “hydrostatic force” refers to the force exerted by a static (non-moving) fluid on a surface due to the fluid's weight. This force arises from the pressure that a fluid at rest applies at any given point within it, and it acts perpendicular (normal) to any surface in contact with the fluid. The term hydrostatic pressure differential refers to the difference in hydrostatic pressure between two points within a fluid column. Hydrostatic pressure is the pressure exerted by a fluid at equilibrium due to the force of gravity, and it increases with depth in the fluid. The pressure at a given depth is directly proportional to the fluid's density (p), gravitational acceleration (g), and the vertical height (h) of the fluid column above that point. A hydrostatic pressure differential therefore arises when there is a difference in height or fluid properties (such as density) between two locations. This concept is used in determining pressure loads submerged objects and/or calculating buoyant forces.

As used here the term “dry immersion” refers to a method used to simulate the effects of microgravity on the human body by immersing a subject in a thermoneutral water environment while keeping them physically dry. This is typically achieved by suspending the individual into a waterproof, flexible membrane (such as a plastic film or fabric) that separates the body from direct water contact but still allows the body to experience the hydrostatic unloading effects of immersion. The subject floats in a supine or semi-recumbent posture, fully supported by the surrounding water through the membrane.

As used herein the term “liquid” or “fluid” refers to any incompressible liquid that is capable of exerting hydrostatic force and by virtue of its weight in the physical state of liquid to allow it to move freely. It also includes fluids of various densities such as salt solutions. Water is used in certain embodiments disclosed herein, but there is no limitation to use water. Any fluid, or semisolid liquid or a mixture of materials can be used that allow for gradient of forces to be applied.

As used herein the term “suit” or “fluid fillable suit” refers to a flexible multi-layer bag that is shaped according to the size of individual furniture or devices (e.g., a regular chair or a sofa in the house, exercise equipment), and the suit is secured to the furniture or devices by various fasteners, ropes, screws, adhesive or similar means. When the Suit is filled with fluid, it surrounds the person present in the inside the space formed by the inner later of the doubled-layered bag and exerts hydrostatic forces. The outer layer of the bag is supported by the panels, and seat of the furniture, exercise equipment or other devices that are retrofitted with the suit.

As used herein the term “reservoir” or “tank” refers to a reservoir that holds water which can be used to fill the bag and exert hydrostatic forces, or capture the water emptied from the bags to remove the hydrostatic forces from the person seated in the bag. The term “tank” or “reservoir” used in this application is used to capture not only the tank that is placed under the chair, but all other forms of reservoirs that are connected to the chair via a pipe; these include without limitation, for example, an over-head tank that works by gravity, a water pond in the ground connected to the chair via a pump, a pressurized container filled with water, or a container filled with water and fitted with a mechanical springs or a piston, or an expandable pneumatic balloon capable of pushing water into the bags via the connect pipes. The term “tank” or “reservoir” also includes containers that capture the water emptied from bag for storage, or drainpipe connected to empty the back to outside, with the goal removing the hydrostatic forces exerted by the bag on the body. The temperature in the “tank” or “reservoir” may be regulated at the desirable temperature using heating or cooling devices and appropriate sensors and controllers.

As used herein the term “buoyancy” refers to a force that makes object/person/mammal float in a fluid like water. It happens because the fluid pushes upward on the objects/person/mammal, helping to support its weight, the reason why people feel lighter or float when they are in a swimming pool, the water pushes up against objects/person/mammal.

As used herein “zero gravity” (or microgravity) refers to a condition where objects/person/mammal seems to be weightless, like in space. Both buoyancy and zero gravity are referred for the effect that make object/person/mammal feel like they are floating or weightless.

As used herein the term “pump” refers to devices or structures that can be used to fill or empty the bag to exert hydrostatic forces on the body of the person, and which include but not limited to the electric pumps. These include mechanical pumps, mechanisms that take advantage of the gravitational forces to fill or empty the bags, tanks that are at higher or lower level than the device (chair, bed, etc.,) and operate by gravity to fill or empty the bag, containers containing mechanical springs or pistons to push the water out or pull in, containers with pneumatic expandable bladders that can push water out to fill the bags.

As used herein the term “chair” is used to describe in detail the mechanism of action of various other embodiments included in this application, and therefore, it will not be repeated at such depth when describing other individual embodiments, such as bed, waterbirth chair etc. These other embodiments without any limitation include exercise devices, the bed, the fillable water suit that can be laid on top of other furniture and the like.

As used herein the term “door” or “movable panel” refers to an entrance and/or exit into the bag (attached the device), which allows the person to enter into the space surrounded by the inner layer of the multi-layer bag which keeps the person dry and surrounds all sides of the body to enable hydrostatic forces to the exerted on the body. The term also includes other parts of the device, for example, chair or exercise device, where a panel of the supporting frame is attached to the bag, and which is opened or closed along with the bag to facilitate entry or exit of the person into the space surrounded by the inner layer of the bag.

As used herein the term “power supply” refers to a source or system that delivers electrical energy to operate a device, component, or system. It may provide power in the form of direct current (DC) or alternating current (AC), depending on the requirements of the load. Power supplies can be internal, such as built-in batteries or circuit-based converters, or external, such as plug-in units connected to the electrical grid. When a system or device is described as powered, it means that it receives and operates using energy from a power supply. While electricity powered devices are described herein in the figures of this application, this term also includes any other power supply means without any limitation, including powered by stored mechanical energy such as springs, gravitational force, solar, a fossil fuel energy, which may be used to achieve the desired function (e.g., fill and empty bags, heat or cool fluid, motion of linear actuators, rotation of the pedals of a bike).

As used herein the term “port”, “inlet” and/or “outlet” refers to an opening or a port which will act as an inlet opening and/or an outlet opening or just an opening for venting gases. In embodiments, inlet and outlet may be same and may be referring to a port controlled by a valve to act as inlet as well as outlet.

As used herein “emergency button” refers to a user-accessible control feature designed to immediately halt operation, trigger safety protocols, or summon assistance in response to a critical or unsafe condition. Structurally, it can be a prominent, color-coded button, a red button, with a mechanical or electronic activation mechanism that is easily reachable by the patient, caregiver, or operator. Functionally, when activated, it may disconnect power to specific actuators, stop ongoing therapeutic processes, or alert medical staff via alarms and/or communication systems. It is integrated into the embodiment of the devices as disclosed herein, for example, chair/therapy chair, Cardiopulmonary Resuscitation (CPR) chair, bed, waterbirth device etc., to provide an immediate response pathway during equipment malfunction, patient distress, or unforeseen clinical emergencies.

In some embodiments, provided herein is an apparatus that supports all or some of an individual's body or body portions. For example, the apparatus may be adapted to support the feet, legs, seating area (thighs, buttocks), abdomen and back of shoulder, and the like of an individual who is seated or lying down, in outer space or it may be adapted to support body regions or appendages such as the leg, torso, arm, chest, back, breast, belly, knee, ankle, pelvis, head, neck, thigh, calf, shin, hip, elbow, wrist, finger, toe, or any combination thereof. The apparatus can be adapted to accommodate a person in virtually any position, including, prone, seated, standing, kneeling, walking, running, flying, suspended freely, floating, submerged, hanging or supported by limbs, in space in microgravity conditions, on other planets or any one part or combination thereof. Various devices (e.g., chairs, seats, sofas, beds, mattresses, cushions, exoskeletons and the like) may be manufactured to include the principles of the apparatus, or the device may be a standalone unit designed to be worn by person while moving around (e.g. in the form of pants, jacket, backpack, undergarment, and the like), or made as an add-on device, that can be fitted to any existing devices in use (e.g., chairs and mattresses).

Other specific forms may embody the present disclosure without departing from its spirit or characteristics. The embodiments described are in all respects illustrative and not restrictive. Therefore, the appended claims rather than the description herein indicate the scope of the disclosure. All variations which come within the meaning and range of equivalency of the claims are within their scope.

The application is directed at a device and a method for exerting an external gradient of pressure on the body including musculoskeletal, cardiovascular systems as well as intra- and extra-vascular fluid compartments in the body. An objective is to provide a non-pharmacological means to manage adverse changes on various systems in the body resulting from the gravitational forces on the body. The system and method are particularly useful in acting as a crutch or to support the vascular system and interstitial space in various disease conditions that affect these systems, without causing undue shear forces on the surface and underlying structures. An additional objective of the system is to provide a support mechanism that exerts buoyancy forces and zero-gravity on the body to provide relaxation, comfort, rest, restore health, and for recreation purposes.

The sources supporting certain statements presented in this paragraph are listed in the references section. Some examples of various disease conditions in which gravitational forces likely play a significant role include excessive fluid accumulation in the interstitial spaces in the dependent portions of the body in various conditions, including congestive heart failure and chronic kidney disease. Additional conditions include treating preeclampsia in pregnant women, clinical shock, hypertension, heart failure, gestational disorders, chronic venous insufficiency, venous ulcers, lymphedema, sleep apnea, motion sickness, sleep apnea, venous ulcers, pulmonary arterial hypertension, intra-dialytic hypotension, pressure ulcers, arthritis, and the like. Several approved therapeutic options are available to treat selected conditions, including, anti-diuretics (for edema and congestive heart failure), various anti-hypertensive medications (for high blood pressure) and medical devices such as continuous positive air way therapy devices (Continuous Positive Airway Pressure (CPAP) for treatment of sleep apnea). However, for some of the conditions such as preeclampsia, no effective treatment options are available. As a result, for example, preeclampsia alone claims a large number of lives, estimated to be about 70,000 women and 500,000 babies a year worldwide, but no effective treatment options to prevent or treat the conditions are available [Preeclampsia foundation: http://www.preeclampsia.org/health-information/about-preeclampsia; National Institute of Health: https://www.nichd.nih.gov/health/topics/preeclampsia/Pages/default.aspx]. Preeclampsia is associated with increased incidence of fetal congenital birth defects including heart defects, and preeclampsia before 34 weeks of pregnancy is associated with critical heart defects (Auger, et al Association Between Preeclampsia and Congenital Heart Defects, 2015, JAMA, 314:1588). Women who suffer from the preeclampsia condition are also at higher risk of developing cardiovascular disorders at later stages in their life. As maternal preeclampsia has been shown to increase the incidence of the birth defects in the fetus, one of the goal of the current application is to use the chair and the exercise devices to make hydrotherapy more accessible to the pregnant mothers diagnosed with preeclampsia, in order to reduce the incidence and severity of such birth defects in the fetus.

The sources supporting certain statements presented in this paragraph are listed in the references section. Similarly, chronic venous insufficiency and venous ulcers are treated using several invasive procedures (e.g., laser ablation of the affected vein) as well as using external compression (e.g., gradient pressure stockings). However, various external compression devices are either ineffective or too cumbersome and uncomfortable for regular usage, leading to poor patient compliance. The systems and methods proposed in this application are based on several observations that hydrostatic forces applied on the body following partial immersion in water result in significant benefits to cardiovascular and other systems in the body. For example, partial immersion of pregnant women with gestational disorders in a pool resulted in significant improvement in various hemodynamic parameters and biochemical indicators associated with preeclampsia such as renin-angiotensin system and increased amniotic fluid volume.

The sources supporting certain statements presented in this paragraph are listed in the references section. Similarly, head-out immersion of men and women of various age groups resulted in increased central volume, suppression of sympathetic tone, and increased anti-natriuretic system activity. Since a swimming pool may not be convenient for every pregnant person, and in fact be risky in advanced pregnancy, a chair that is enabled to exert hydrostatic forces is described in this application. It is anticipated that the chair can be placed in the home of the person and used frequently without the fear of drowning and avoid getting wet or slipping on a wet surface, while preserving privacy.

The sources supporting certain statements presented in this paragraph are listed in the references section. Gravitational forces also play a significant role in onset of clinical shock, a life-threatening condition that occurs in several disease conditions including sepsis, heart failure, hemorrhage, etc., when adequate blood pressure in the intravascular space is not maintained leading to lack of oxygen and nutrition supply to the critical organs such as brain. Both pharmacological and medical devices (for example, Military anti-shock trousers (MAST)) are used for management of clinical shock, with the objective of maintaining adequate blood pressure in the central compartment. MAST was introduced in the 1970s. The Emergency Medical Services (EMS) started carrying MAST from 1977 as an essential device in all ambulances based on recommendations by the Committee on Trauma of the American College of Surgeons. Although MAST appears to have saved lives, its effectiveness and safety was questioned later in several publications. Therefore, there is an urgent need for safe and effective devices to manage clinical shock.

The sources supporting certain statements presented in this paragraph are listed in the references section. Various medical devices that exert external compression on the body include compression sleeves, compression pumps, bandages (e.g., ACE bandages), gradient compression stockings, External Counter Current Pulsation (ECCP) devices, mercury pressure therapy bath are used to manage various conditions that result in fluid accumulation in lower extremities. However, there is still room for better technologies.

The sources supporting certain statements presented in this paragraph are listed in the references section. Motion sickness is another condition in which gravitational forces appear to play a significant role, which affects a large number of people under various conditions including travel by land or sea; while using simulators or virtual reality applications. Several theories were proposed to explain the mechanism of motion sickness, including sensory conflict and postural instability in humans. The autonomic system plays a critical role in maintaining blood circulation and it uses feedback from visual clues in addition to somato-sensory input. Very often, for example, a person while driving a car does not experience motion sickness, however, the same person may become motion sick, if sitting in the car as a passenger, underscoring the importance of maintaining a synchronous efferent response to the changes in afferent feedback. Therefore, a system and a method that exerts a gradient of pressure on the body and to redistribute weight in order to minimize overall proprioception from primary weight bearing regions of the body to minimize sensory conflict, and in some embodiments enabled to exert pressure on the body synchronized with the anticipated changes in the proprioception based on the visual feedback is described in this application for potential prevention or treatment of motion sickness.

Additionally, the system and method may be useful in management of various other disorders including but not limited to treating preeclampsia in pregnant women, sleep apnea, heart failure, treatment-resistant hypertension, orthostatic hypotension, chronic kidney disease, edema of the lower extremities, loss of tissue fluid in burn patients, to improve the efficiency of dialysis, reduce intra-dialytic hypotension and the like. Reduced blood flow to the brain is considered to be one of the main reasons for dementia and diseases like Alzheimer's disease.

Exercise in a swimming pool has shown some efficacy in increasing blood circulation to the brain. Therefore, the chair may be useful in treatment or prevention of such central nervous system (CNS) diseases.

The sources supporting certain statements presented in this paragraph are listed in the references section. The system and method described includes but is not limited to chairs, vehicle seats, beds, wearable suits to minimize the pressure on the weight bearing regions of the body, such as buttocks, spine, feet, joints, etc. Various embodiments of the chairs, beds and suits are described in the literature. However, none of them teach how to apply gradient pressure on more than one side of the body, and redistribute the weight, to relieve stress on the weight bearing regions.

Based on the stated prior art, present disclosure is to provide a system for exerting a gradient of pressure forces on various body parts of a person and to redistribute the weight to counteract the adverse effects of the gravitational forces on the body. Further, the present disclosure also provides for supporting the vascular system of a person and moving the fluids from the peripheral compartment to the central compartment of the body in order to help treat various disease conditions related to gravitational force on the body. In preferred embodiments, the forces may be similar to hydrostatic forces exerted by fluids. For the purpose of description, the phrases “redistribution of the body weight” and “offloading of the weight” are used interchangeably to refer to the mechanism wherein redistribution of the load from the primary weight bearing regions to the larger surface of the body results in offloading of the weight onto an external supporting structure.

Another objective of the present disclosure is to provide at least one flexible container such as a bladder to hold a substance, which may be a fluid in preferred embodiments, which is conformed around the contours of limb, torso, or other portions of the body.

An additional objective of the present disclosure is to provide a system to allow a person to experience buoyancy forces and/or the feeling of weightlessness without coming into direct contact with the fluid or getting into a swimming pool.

Still an additional objective of the present disclosure is to redistribute the weight of the person from primary weight bearing parts (e.g., feet, ankle, knee, hip, and vertebral joints while standing up right, or buttocks and underside of the thighs while seated in a chair) to larger body surface to minimize the pressure on respective weight bearing areas. The redistribution of weight from the primary weight bearing regions to the larger surface of the body, further decreases the sympathetic activity.

Another objective of the present disclosure is to provide a frame, and a double-layer bag/multi-layer bag containing the medium to enable the medium to exert a gradient of forces on the body.

Still another objective of the present disclosure is to provide an embodiment of a device that can be in the form of a piece of furniture (e.g., chair, bed, seat), a wearable suit, a vest, a cast, or in the form of a stretcher to exert a gradient of forces on the body of the person.

An additional objective of the present disclosure is to provide a device (e.g., an aquatic stationary bike, aquatic treadmill, standard bicycle, stair-climber) that offers the benefits of an aquatic exercise, without the person stepping into a body of water such as a swimming pool for exercising. The device allows the person to exercise at home, without actually getting into a pool and get wet, but still be able to experience the buoyancy forces and therefore can be used for therapeutic exercise by wide variety of people (e.g., young, or old persons, pregnant women, heart failure or arthritis patients).

An additional objective of the system is to provide a device to reduce resistance to the blood flow and improve blood circulation in an individual undergoing cardiopulmonary resuscitation, either via manual or automated chest and/or abdominal compressions to improve blood circulation with the hope of keeping the person alive until reaching a hospital where specialist care is available.

Yet another objective of the present disclosure is to provide an external compressive system that exerts a gradient of variable pressure force depending on the position of individual body parts.

Still another object of the present disclosure is to provide a system and method for treating various conditions, related to the adverse effects of the gravitational forces on the body, including but not limited to preeclampsia, heart failure, clinical shock, hypertension, edema, lymphedema of arms and legs, sleep apnea, pressure ulcers, compartment syndrome, intra-dialytic hypotension that occurs during or after dialysis and the like.

Another objective of this application is to provide a system and method to minimize discomfort to people while seated, lying down, traveling by reducing the load on the musculoskeletal system, joints, and for minimizing adverse effects related to motion sickness while traveling or using virtual or augmented reality applications for entertainment purposes.

Still another objective of the disclosure is to provide a system and method for reducing the vascular sympathetic tone and total peripheral resistance in the body. When a person is seated in the current chair embodiment, the water surrounding the person acts as a support system for the blood and lymph vessels in legs and other portions of the body under water. As a result, the vascular tone is reduced resulting in reduced total peripheral resistance. Further, as the body weight is off-loaded onto the surrounding water, it also helps in lowering the peripheral resistance. Because of this, the blood pressure of the person is reduced. The load on the heart is also further reduced due to increased pre-load from increased central volume.

The water temperature can be maintained at a desired level using a water heater or other means. In some embodiments, an additional layer of thermal fabric placed between the inner layer and the person may be heated (e.g., a thermal garment that uses electric coil to heat the fabric and provide gentle warmth for the person).

Without limitation, by way of example, several embodiments of the system including a chair, a suit, and a stretcher to exert pressure on the body are described. In the preferred embodiment, the present disclosure relates to a chair that comprises a double-layer bag/multi-layer bag containing a substance to exert a gradient of pressure forces on the body and a frame to redistribute and support the weight of the person. Potential applications of the technology, without any limitation, include treatment of hypertension, to manage intra-dialytic hypotension or hypertension, pulmonary arterial hypertension, musculoskeletal disorders, heart failure, pregnancy disorders including preeclampsia, to manage intra-dialytic hypotension or intra-dialytic hypertension, musculoskeletal disorders, chronic venous insufficiency, venous ulcers, lymphedema, pressure ulcers, clinical shock, edema, nausea and vomiting, motion sickness, dialysis, compartment syndrome and sleep apnea. The technology may also be useful in various consumer products including seats, beds, chairs and the like. It may be used as an anti-gravity chair, for relaxing at home, for simulation of forces on the body, for simulating conditions of low gravity environment on astronauts in training, etc.

Several methods and devices are disclosed in this application. These include a chair that exerts buoyancy forces and massage forces on the body for relaxation, an interconvertible chair/bed and several exercise devices for physical rehabilitation.

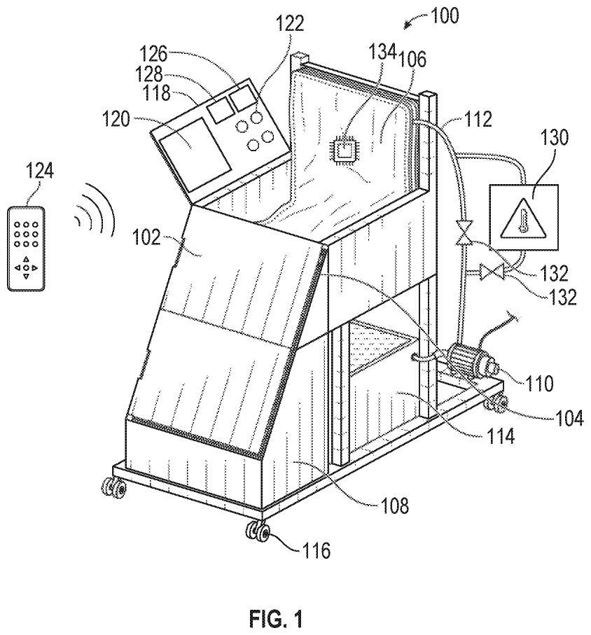

FIG. 1 shows a chair 100 with a flexible door 102 with a zipper 104 for opening and closing the door according to embodiment. The door is made of flexible material, and the door is shown in the closed position. The door has a zipper opening so that the user can walk in and have a seating position. Further the chair comprises a single-layer or multi-layer bag 106 attached to the chair. The chair comprises a foot box 108. A pump 110 pumps the fluid, for example water, through tube 112 into the single-layer or multi-layer bag 106. The pump is connected to a water reservoir 114. The chair can comprise wheels 116 for easy mobility of the chair. The chair can comprise temperature control unit 130 for controlling the temperature of the fluid. The control of fluid can be controlled using digital valves 132. The chair can comprise a control unit 118. The control unit can be an integrated component within the system or chair that governs the operation of various components by processing input signals and issuing corresponding control commands. It functions as the central coordinating entity, interpreting sensor data from the sensors 134, user inputs received from touch display 120, input buttons 122, and from a remote-control unit 124 or programmed instructions in the memory 126 to regulate actuators, motors, valves, or other controlled elements. The control unit 118 typically includes a microcontroller, processor, or programmable logic 128 that executes predefined algorithms to maintain desired operational states. For example, in the therapy chair 100, the control unit 118 may adjust recline angle, temperature, or timing sequences based on user selection or feedback signals. It achieves control through electronic signals, often using pulse-width modulation, voltage regulation, or digital protocols.

The device/chair simulates hydrostatic forces—that is, the distributed pressure exerted by a fluid in the single-layer or multi-layer bag on a body part of the user using the device/chair would be similar to the distributed pressure experienced by the user immersed in a body of water.

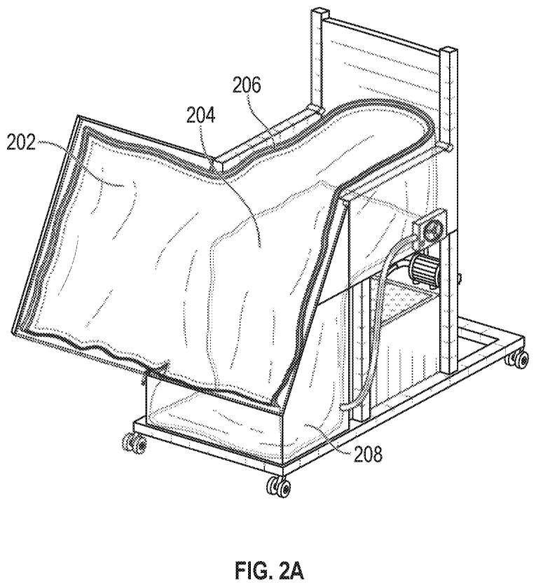

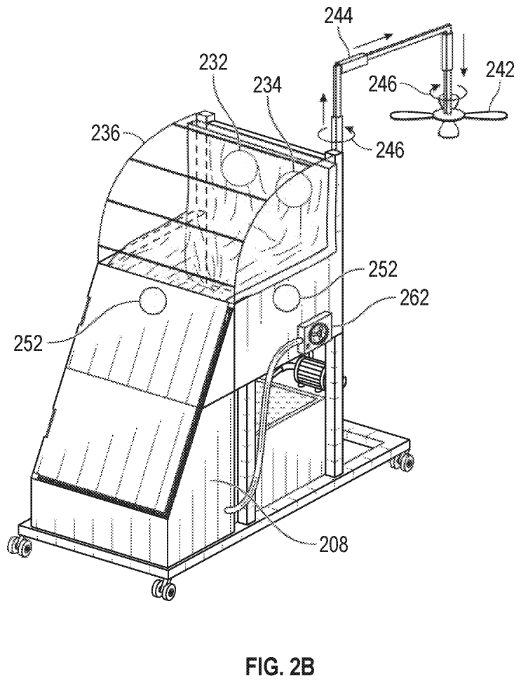

FIG. 2A and FIG. 2B show a chair with a flexible door 202 where the flexible door is in the open position according to an embodiment. The zipper in the footrest area is completely open to one side and the user can just walk into the seating area and comfortably sit. The zipper can then be closed either by the user or by another helper. In an embodiment, any other means to secure the flexible door may be used. In embodiments, the seating area 204 and the arm rest area 206 may be completely covered with the single-layer or multi-layer bag.

In an embodiment, the door can be made of any other material, not necessarily flexible material and the closure can be facilitated by any other means such that the door portion is movable so that the user can walk in easily into the sitting area. In an embodiment, the flexible sheet is included to allow for raising of the foot box. Alternatives include net, waterproof sheets, foldable structures, etc. This also allows for volume of the water to be kept to a minimum.

If the foot box is long enough, then the need for such a flexible bag is not required, as in this case the person can stretch legs without any limitation, in the large amount of water/space in the foot box.

The foot box 208 is reclinable and allows for comfortable positioning and resting of the person in the chair. It also allows for changing the gradient of hydrostatic forces on the body, for e.g., when the foot box is down perpendicular to the seat, the person experiences higher gradient of hydrostatic forces on the feet. When raised to be parallel (for example, 180 degrees to the seat position, or any angle) it allows for conversion of the chair into a bed when the backrest is laid flat.

Further the chair comprises emergency access button 252 providing access to the patient in case of emergency. Placement of the button could be varied based on the type of device. It could be at a place where it is easily accessible to the patient as well as the nurse/physician. It could even be integrated into a touch screen display. In embodiments, it could be in the chair handles. In case the person collapses while using the chair, pressing the emergency button would follow the revival standard. The head portion in the chair or device is tilted so that the blood flow to the head is uninterrupted as per the regulations. The emergency personnel, nurse/physician, may have to perform the CPR when the patient is in the chair or device. Emergency procedures include draining the fluid/liquid out of the single-layer or multi-layer bag, retracting the railings, unlocking the doors automatically, collapsing the collapsible door automatically, opening or loosening the single-layer or multi-layer bag tying points for easy removal of the bag enclosure, so the patient can be accessed easily.

When the user presses the emergency button, all the water in the single-layer or multi-layer bag gets drained right away. The water will be pumped back into the tank/reservoir at a faster rate using suction pumps or booster pumps and/or opening the outlet holes which can drain the water under gravity in a desired time limit. In an embodiment, pushing the emergency button will start buzzing and calling attention of the nurse or physician. In an embodiment, an emergency alarm goes off when the emergency button is pushed.

Super rapid discharge: For achieving super-fast discharge rates of liquids from a reservoir, high-capacity centrifugal pumps, positive displacement pumps, or turbine pumps driven by high-speed electric motors or hydraulic motors can be employed, depending on the liquid properties and system design. Centrifugal pumps, particularly multi-stage or high flow impeller types can be used for large volumes of low-viscosity fluids and can be powered by industrial-grade AC motors operating at high RPMs (e.g., 2900 RPM or higher). For highly viscous fluids or where precise flow control is needed, rotary vane, gear, or screw-type positive displacement pumps driven by variable-speed motors offer high-pressure, high-volume discharge. In high-demand applications such as emergency drainage, turbine pumps or jet pumps may also be used for their ability to maintain high flow under varying head conditions. Additionally, hydraulic motors can drive discharge mechanisms where electrical sources are limited, providing powerful torque and rapid operation in mobile or field settings. The pump selection considers factors such as fluid viscosity, required flow rate (e.g., liters per minute), head height, and compatibility with tank outlet size and pressure tolerances. Properly matched motor and pump assemblies are used to control rapid evacuation of contents from the single-layer or multi-layer bag.

Further the chair may comprise an enclosure, for example, a dome 236 creating a fully enclosed space. The dome may be integrated or removable and may be collapsible for easy use.

Further the chair comprises ventilation for air circulation which can be provided using one or more of vents 232, 234 and one or more powered fans 242, 262. Fans may be adjusted in spatial position and orientation by means of linear adjustments 244 and swivel and rotational adjustments 246. Exhaust fans, intake fans or blowers, create a continuous airflow for the user. Vents could be used as inlets for providing filtered air inlets. Placement of ventilation components is chosen such that the user feels comfortable and not suffocated. Ventilation can be provided through integrated inlet vent 232 and outlet vent 234, and/or integrated fans 262, attached fans 242, often assisted by low-noise axial or centrifugal fans that maintain continuous air exchange without disturbing the user. Fresh air is introduced through intake vents equipped with air filters, such as HEPA or activated carbon filters, to remove particulates, pathogens, or odors, while stale or humid air is expelled through exhaust vents to prevent accumulation of carbon dioxide or heat. The system may be designed to operate under positive pressure, pushing filtered air into the therapy chair to prevent external contamination, or under negative pressure where internal air is continuously drawn out to protect the environment. Airflow rates are calibrated based on the therapy chair volume, typically maintaining several air changes per hour (ACH) to support respiratory comfort and thermal regulation. Additionally, sensors may be integrated to monitor CO₂ concentration, humidity, and temperature, enabling automated control of fan speed and airflow direction.

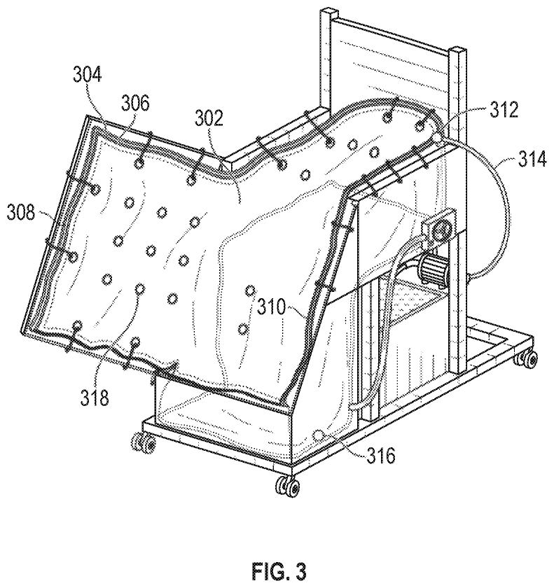

FIG. 3 shows the chair with a multi-layer bag 302 attached to the chair and the flexible door in open position. The door is made of flexible material such as Tarpaulin or any other material that is flexible and holds water pressure. The door and the chair also show a multi-layer bag that is wrapped around the chair area, footrest area and the door area. The multi-layer bag has two layers and is referred to as double-layer bag. One is outer layer 304, and the other is inner layer 306. The two layers are sealed together on all the sides of the multi-layer bag 302 according to an embodiment. One end 308 of the sealed sheets is attached to the first side of the zipper area on the flexible door and the other end 310 of the sealed sheets is attached to the chair portion near the foot area where the zipper is used to facilitate closing when the flexible door is brought to be in closed position. In an embodiment, the multi-layer bag comprises rollers 318 for providing a massage to the user. These rollers or plurality of massage elements may be disposed within or beneath the support surface, multi-layer bag, chair area, wherein the massage elements are operable to generate mechanical stimulation in the form of compression, vibration, or rolling motion. These rollers or plurality of massage elements may be powered independently and activated independently of each other or in groups. In an additional embodiment, the outer layer is not present, instead the support structure of the furniture forms the outer layer.

The multi-layer bag is completely sealed on all sides and the outer layer 304 may be fixed to the chair, the flexible door area, and footrest area covering the full area of the chair. The multi-layer bag comprises inlet hole/inlet port 312 (or inlet holes, in case more than one inlet is provided) connected to inlet pipe 314 for allowing the water or any medium inside of the multi-layer flexible bag and holding the water between the outer layer and the inner layer. Inlet pipe 314 is connected to inlet port 312 and reservoir via a pump to fill the liquid/water in the multi-layer bag. In embodiments, outer layer may be made of multiple layers and inner layer may also be made of multiple layers. In an embodiment, the inlet ports may be placed at the top of the multi-layer bag so as to facilitate the filling of water. The inner layer is completely sealed with the outer layer with no ports and no openings. The user sitting in the seating area and placing the feet in the footrest area will not get wet as the multi-layer bag is completely sealed on all sides. The inner layer 306 of the multi-layer bag may be more flexible and/or more in areas such that when filled with water the inner layer 306 expands and collapses or surrounds the area around the user with water pressure. The user sitting in the seating area will experience water pressure just like sitting in the swimming pool but will not get wet as the user and the water are separated by inner layer 306. The multi-layer bag has outlet port 316. The outlet port 316, or outlet ports in case or more than one port is provided, are in closed position when the water is filled and are in open position when the multi-layer bag needs to be emptied. The outlet ports are opened for the water to be completely drained. The number and size of outlet ports depend on how quickly the water needs to be drained. The position of the outlets is placed such that the gravity can be taken advantage of, that is at the bottom area of the multi-layer bag and the chair. In an embodiment, it may be under the chair. In an embodiment, the bottom port may be used to fill and drain the medium. In case of emergency to the user, the water can be drained rapidly, as per predefined set time limits, to access the user or get the user out of the chair.

The inner layer, which may also be referred to as an inner membrane, is a component designed to replicate the physical effects of water immersion without direct contact between the user and the water. To fulfill this function, the inner layer is designed to possess specific material and structural properties. It is made of a waterproof material to prevent any liquid penetration yet remain highly flexible and elastic to conform closely to the contours of the body, enabling uniform transmission of hydrostatic pressure. The inner layer is typically very thin, generally ranging from approximately 50 micrometers (0.05 mm) to 200 micrometers (0.2 mm) in thickness, however higher thickness outside the ranges are possible as long as the structural properties are fulfilled, to minimize any barrier effect between the water and the skin, thereby ensuring physiological simulation. Additionally, it can also be designed to be biocompatible and comfortable for prolonged skin contact, with non-irritating, hypoallergenic surface characteristics. Moderate thermal conductivity is also required to allow effective heat exchange between the water and the body, helping to maintain a stable and thermoneutral environment. Suitable materials for such inner layers can include, but not limited to thin polyurethane films, thermoplastic elastomers, and medical-grade silicones, all of which provide the necessary combination of impermeability, softness, flexibility, and mechanical integrity for safe and effective use in hydrotherapy application with dry immersion.

The layer referred to as inner layer 306 may be mandatory. But the outer layer 304 is not required if the chair and the tarpaulin provide waterproof enclosure and then the multi-layer bag is referred to as single layer bag. In single layer bag, the outer layer may be an integrated layer with the chair/furniture/device and is waterproof.

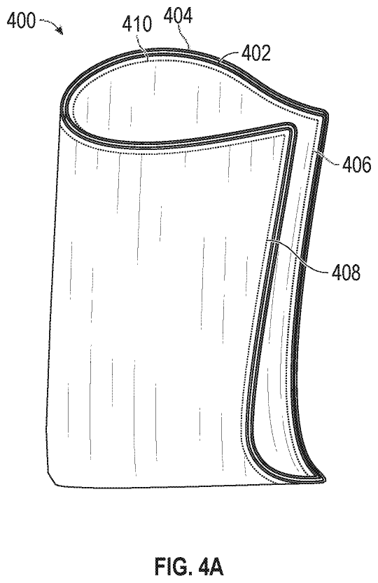

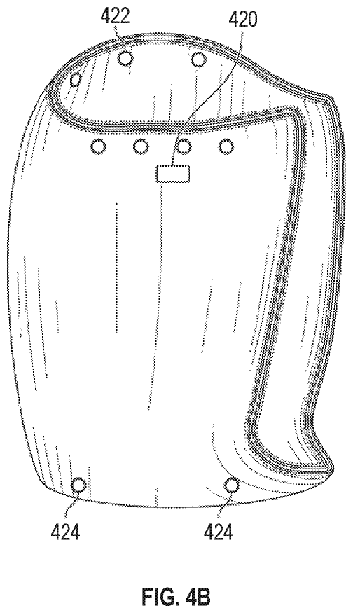

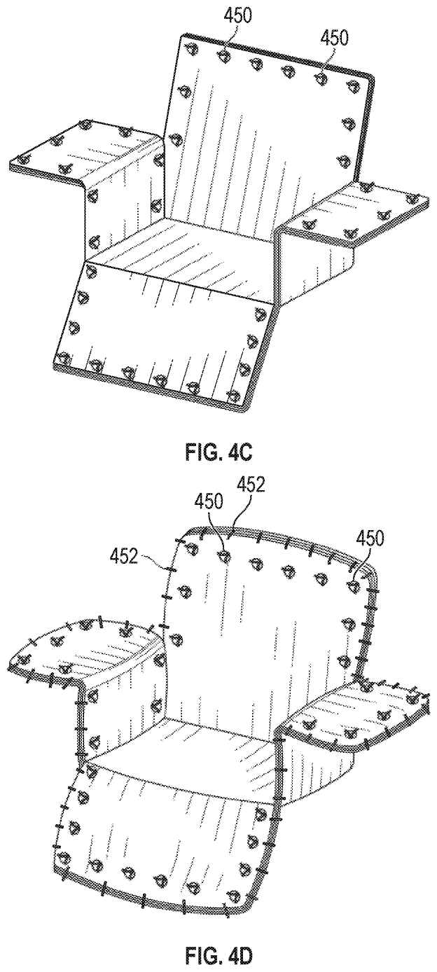

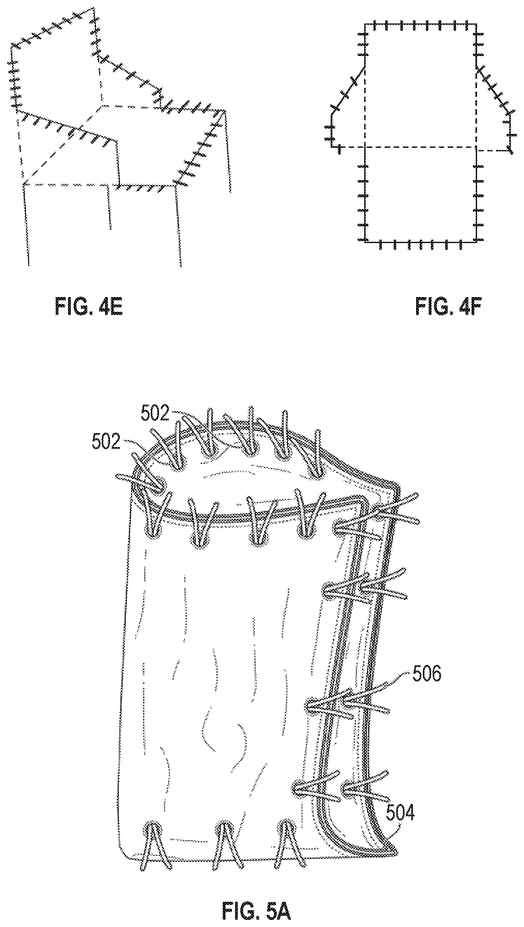

FIG. 4A shows the multi-layer bag according to an embodiment. multi-layer bag 400 is formed in the following way. The inner layer 402 is first folded and the bottom of the folded part of the inner layer is sealed. Likewise, the outer layer 404 is also folded and the bottom of the folded part of the outer layer is sealed. Then the inner layer is placed inside the outer layer and both layers are sealed to each other on the right 406, left 408, and top 410 along the dotted line as shown to form multi-layer bag 400. This structure allows for complete coverage of the chair and the foot box with the chair having an opening for the user to walk in such that the foot of the user is also covered by the multi-layer bag. In this way the inner layer is free floating in the outer layer at the bottom, which makes the multi-layer bag more comfortable when using. But it is apparent to those skilled in the art to provide layering in all portions of the furniture and there are so many ways of achieving the surrounding of the body part of interest of the user with the layered bag to apply pressure without the user body part getting wet.

A multi-layer bag refers to a containment structure comprising at least two pliable, and independently deformable layers, namely, an inner layer and an outer layer, with an interstitial space or compartment defined between them. The inner flexible layer forms the primary containment boundary towards the user aiding to keep the user dry and yet experience the hydrostatic forces/pressure, typically configured to hold a fluid, gas, or the like, while the outer flexible layer serves as a secondary barrier or protective envelope. The material composition of each layer is selected for properties such as elasticity, chemical resistance, durability, and compliance under variable pressure or load.

In an embodiment, the outer layer may be an integral part of the device/furniture to which the multi-layer bag is being attached, which makes the inner layer appear as the sole layer between the device/furniture to which it is attached and the user who is using the device/furniture and thus referred to as single-layer bag.

In an embodiment, a multi-layer bag is a multi-layered deformable containment system characterized by at least two sealed, flexible membranes with an intervening space. The inner layer may further have more than one layer or more layers forming additional inner layers comprising soft breathable cover for medical purposes and refers to such a textile or fabric layer designed to be placed over surfaces that come into contact with the human body, primarily for enhancing comfort, hygiene, and skin protection. This type of soft cover is engineered to combine soft tactile properties with air and moisture permeability, thereby supporting long-term patient contact without compromising thermal regulation or skin integrity. The soft breathable cover can be constructed from materials such as medical-grade polyester, cotton-polyester blends, or advanced microfiber fabrics, selected for their combination of softness, durability, and hygienic compatibility. Structurally, it can feature a fine, porous weave or knit that allows air and moisture vapor to pass through, promoting breathability and thermal regulation. Functionally, it provides a gentle, non-abrasive surface suitable for prolonged skin contact, while also supporting moisture wicking to reduce the risk of skin maceration. The cover is designed to be hypoallergenic, washable, and resistant to microbial contamination, making it appropriate for repeated clinical/medical use.

In an embodiment, sealing gaskets on the doors are used to make these bags and the chair leak proof. Any other sealing methods known in the art may be used to seal to make the furniture leak proof when filled with water.

In an embodiment, the apparatus or device can be used by three different types of patients. For example, a pregnant woman can walk in, open the door, sit in there, close the door, and then turn on the pumps to fill the multi-layer bag. Once it is filled with the water, it exerts the hydrostatic pressure gradient pressure on the person. By doing that the pregnant person, especially one with preeclampsia will reduce load on the heart. Also, the device is potentially useful for the treatment of edema in the dependent portions of the body. When a person with edema and swelling in the legs is seated in the chair, and exerts the pressure, the gradient of hydrostatic forces facilitate pushing the fluids from the legs into the central compartment, and as a result the person makes more urine and thereby reduces the edema. As a result of the reduction in excess volume, it also reduces the load on the heart. In an embodiment, it can be used by the person with congestive heart failure or heart failure, or various stages of heart failure. The person can walk into the chair and use it in the same manner as described above, which will help with reduction in load on the person by reducing peripheral resistance, reducing the fluid volume, and increasing the pre-load on the heart. The device is also potentially useful in treatment of intra-dialytic hypertension (or intra-dialytic hypertension) in people undergoing hemodialysis, which potentially lead to adverse cardiovascular effects, and is responsible for up to 10 to 15% of the mortality in this population. Hemodialysis patients tend to develop intra-dialytic hypotension when the fluid is removed rapidly or due to other comorbidities. The use of the device to prevent intra-dialytic hypotension is similar to the description of use in other conditions. Instead of using a standard chair, the patient will sit in the chair described above in this application and will close the door and the hemodialysis treatment is initiated. Any time during the dialysis, as needed based on the clinical signs (e.g., leg cramps) or as indicated by the hemodynamic parameters, the surrounding multi-layer bag is filled with water to the appropriate level (e.g., typically up to the umbilical level). The gradient of hydrostatic forces exerted by the bag prevents the development of intra-dialytic hypotension. Clinical proof of reduction of intra-dialytic hypotension using water immersion technique has been reported (PMID: 29436152 DOI: 10.1111/hdi.12634). It can also be used by a person as a gaming chair, for example, this can be synchronized with the pressure and the system can be synchronized with the movement or action on the screen. The pressure on the body can be increased or decreased so that he or she feels gravity force or simulate the sensation on the body by increasing or decreasing the pressure synchronized with the action on the body. As the system offloads the body weight of the user it can potentially be applied to simulate either flying, floating or weightlessness simulations.

Multi-layer bag has an inner layer 402 and an outer layer 404. In an embodiment, the inner layer 402 may be made of more flexible material than the outer layer 404. The outer layer 404 may be stiffer than the inner layer 402. In another embodiment, the inner layer 402 may have more width and/or more length when compared to the outer layer 404 and attached in such a manner that the corners of the both inner layer 402 and outer layer 404 match creating a loose inner layer 402 inside the outer layer 404. When the user sits in the chair and the water is filled between the inner layer 402 and outer layer 404, the inner layer 402 flexes towards the user and the outer layer 404 tries to bulge outwards towards the structure it is attached to. Between the structure and the user, the multi-layer bag filled with water tries to apply the pressure on the various body parts of the user. The pressure can be measured using various sensors attached at various positions in the multi-layer bag. In an embodiment, the multi-layer bag can be of any shape such that it conforms to the whole of the closure area with edges of the inner and outer layers matching and all the edges sealed such that no leakage of water takes place and yet forms a continuous channel to hold the water. The outer layer may be attached to the corners of the chair, corners of the footrest, corners of the door etc., however the inner layer is attached only to the periphery forming a continuous channel between the inner and outer layers. While the outer layer conforms to the chair, footrest, door shapes, the inner layer is free floating except at the sealed periphery and conforms to the user and the posture of the user. In an embodiment, the inner layer at the bottom is sealed separate from the outer layer.

The term multi-layer bag is used in this application, in general, to describe all bags, including a single, double, or multiple layer bags. The bag is designed such that, when filled with water, the inner layer of the bag closely hugs the person within the inner space and conforms to the size and contours of the body similar to water in a swimming pool. While the outer layer of the bag is designed to be rugged and any thickness, the material and the physical properties of the inner layer are chosen to be flexible, stretchable and move together with the water and the body of the person and supports weight of the immersed part of the body all the time, regardless of the position. The physical and structural properties of the inner layer also allows the bag to apply a continuous gradient of the pressure on the body.

FIG. 4B shows the multi-layer bag with inlet port 420 and outlet ports 424 according to an embodiment. In an embodiment, the inlet port 420 is an opening on the outer layer to fill the medium that may be used to connect the outer bag to a side tank, to allow for excess water, for example, when the foot box is raised, to flow into the tank or back into the bag. The multi-layer bag is also designed to surround the user when the back rest is laid flat. In this case, the inner layer loose enough and still surrounds the person/user, when the chair is in a flat position. In an embodiment, there are side raised edges to the back rest and tarpaulin on the sides of the back rest to hold water when the chair is laid back flat. In an embodiment, the multi-layer bag may also have air vents 422 through which air escapes when the multi-layer bag is being filled with water.

Inlet port 420 and outlet port 424 can be placed anywhere and can be controlled via individual valves or common valves for a group of inlets. Inlets can be of any shape and size. A pump can be used at the inlets to pump the water inside the multi-layer bag. In an embodiment, a suction pump may be used at the outlet valves to drain the water quickly. In an embodiment, the drain holes, or outlet ports 424 may be a combination of free drain holes without any suction motors and some with suction motors. Placement of the inlet, outlet/drain holes can be anywhere with proper valves and seals.

Not shown in the figures, there can be an additional layer that can be added between the user and the inner layer, which will allow for escape of air and moisture and allow skin to breathe for better user comfort. The layer can also be heated for more comfort. The inner or the outer layers may be made of waterproof fabrics or material that are tightly woven or made of polymers (e.g., such as GORE-TEX® fabric), which may also be breathable, to prevent accumulation of moisture and for increased comfort. There is no limitation on the type of material used for the inner and outer layers. Other types of materials such as polyethylene, silicone, etc. may be used. They are selected such that the inner and/or outer layers are tear resistant and biocompatible, without causing any irritation to skin. In some embodiments the outer layer may be omitted, as the shell of the chair is made water resistant and configured for containment of the water.

FIG. 4C shows a chair with handle area and attachment points of the multi-layer bag flexible bag to the chair according to an embodiment. FIG. 4D shows a chair with handle area and attachment points of the multi-layer bag to the chair according to an embodiment. In an embodiment, the outer layer can be attached at more points to the furniture or structure than the inner layer. The outer layer can be attached at attachment points 450 so as to conform to the shape of the furniture. In embodiment shown in FIG. 4C, the outer layer and inner layer are attached to the furniture at attachment points 450. In embodiment shown in FIG. 4D the inner layer is attached only at the edges shown as stitch marks or crossed lines 452 while the outer layer can be attached at attachment points 450, such that the inner and outer sheets form a continuous channel for the medium such as water. FIG. 4C shows a chair with handle area and attachment points of the multi-layer bag to the chair according to an embodiment. FIG. 4D shows a chair with handle area and attachment points of the multi-layer bag to the chair according to an embodiment. FIG. 4E shows a chair with a handle area in which the inner and outer layers are attached to the chair according to an embodiment. FIG. 4F shows the layout of the inner and outer layers and their attachment points for attaching to the chair. When viewed in FIG. 4E and FIG. 4F, the dotted lines show the additional points where the outer layer could be attached to the chair to conform to the shape of the chair while the stitch or cross marks show where the inner and outer layers are attached together such that there is a continuous channel between the inner and outer sheets. The inner and outer layers do not form multiple segments or multiple partitions between inner and outer layers when attached to the chair. In an embodiment, the outer and inner layers are attached along the periphery of the chair only.

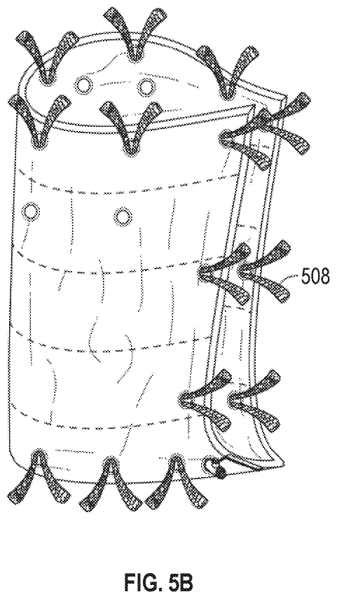

FIG. 5A and FIG. 5B show the multi-layer bag with attachment points 502 according to an embodiment. In an embodiment, the inner layer of the multi-layer bag is attached to itself at the bottom 504 but attached to the outer layer on the top and sides. The attachment means could be by way of tying with ropes 506, Velcro® 508 (shown in the figures), or snap buttons which are not shown in the figures. Other attachment means are contemplated.

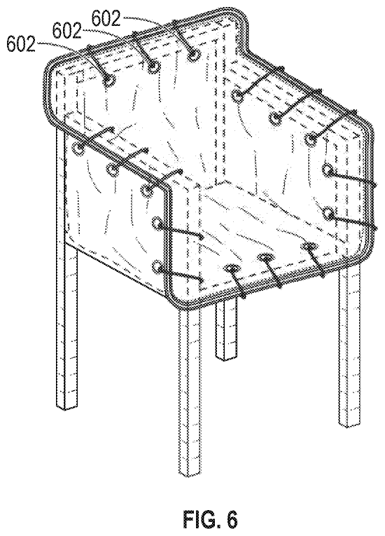

FIG. 6 shows a simple chair attached with a multi-layer bag according to an embodiment. This can be visualized as two layers attached along the boundary of the chair and when tried to pull from the chair seating area both sheets are free to come out of the seating area but are attached along the periphery. In an embodiment, the multi-layer bag is removable and may be attached when needed using the attachment points 602. Attachment points could be tying holes, snap buttons etc.

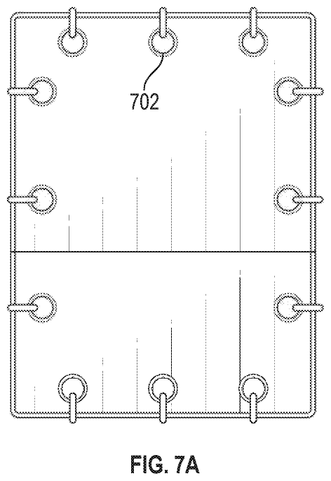

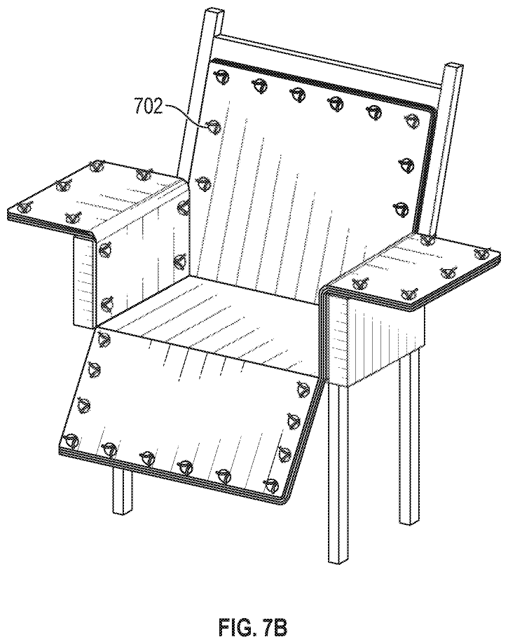

FIG. 7A and FIG. 7B show a layout of a removable multi-layer bag according to an embodiment. The multi-layer bag may be provided with attachment points 702 as shown in the figures.

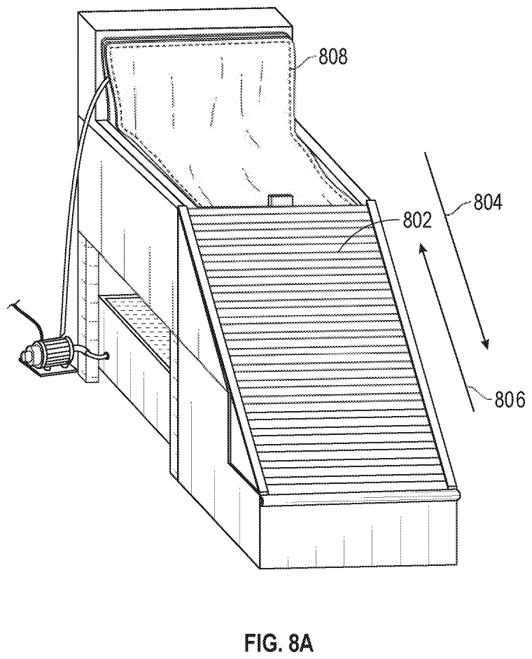

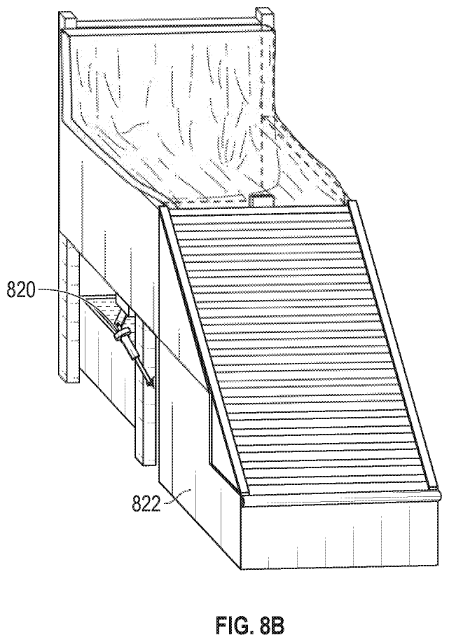

FIG. 8A and FIG. 8B show a model of a door 802 for the chair according to an embodiment. It is a roll shutter door 802 and can be opened in the direction 804 as roll shutter open direction. The user can walk in and once the user is in a seating position, the door can be pulled up along the roll shutter close direction 806 so that the door is in the closed position. The multi-layer bag 808 comprises two layers inner layer and outer layer, however, these two layers are sealed along the periphery and form a continuous water channel inside and also ensure that there is no leakage of the water at the boundary area. Further, the figures show linear actuator 820 for adjusting the angle of the foot box 822.

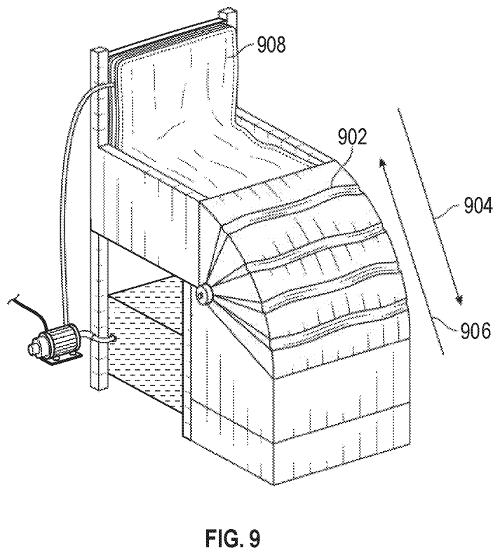

FIG. 9 shows a model of a door for the chair that can be used according to an embodiment. It is a roll open door 902 and can be rolled open in the direction 904 as shutter open direction. The user can walk in and once the user is in a seating position, the door can be rolled along the shutter close direction 906 so that the door is in the closed position. The multi-layer bag 908 comprises two layers, inner layer and outer layer, however, these two layers are sealed along the periphery and form a continuous water channel inside and also ensure that there is no leakage of the water at the boundary area.

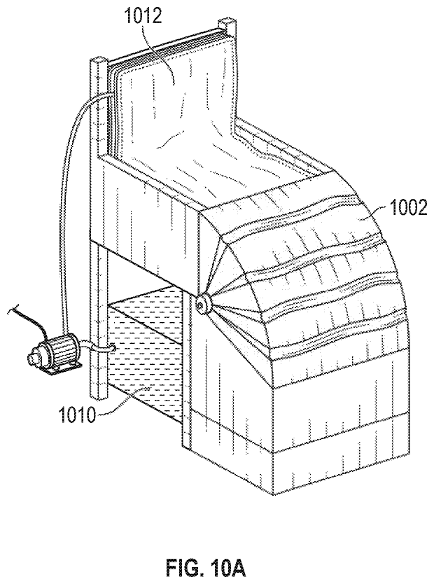

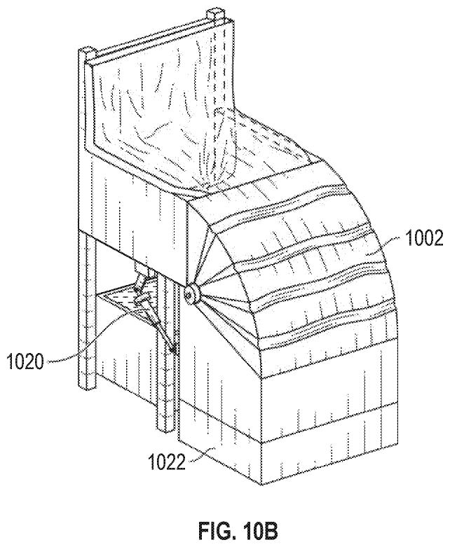

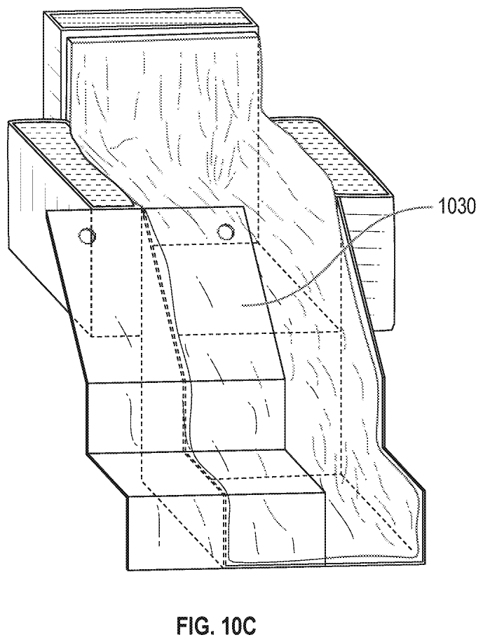

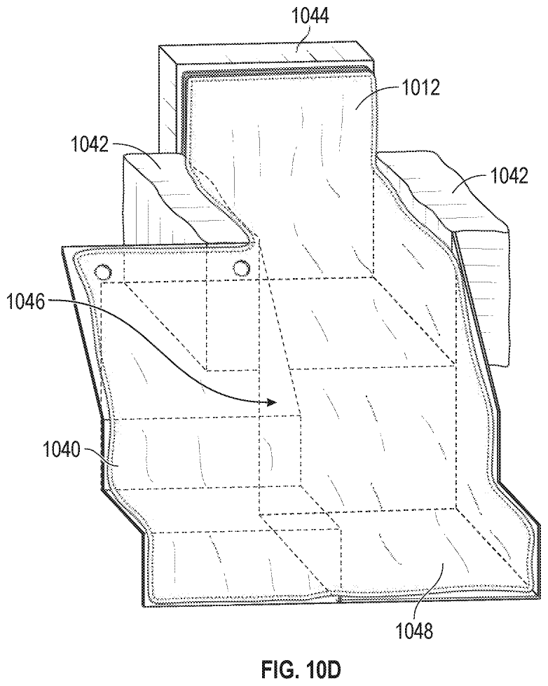

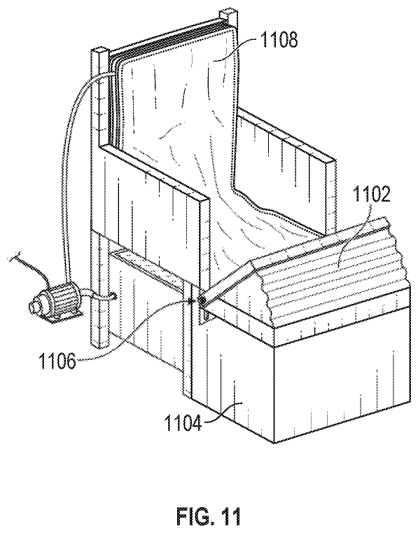

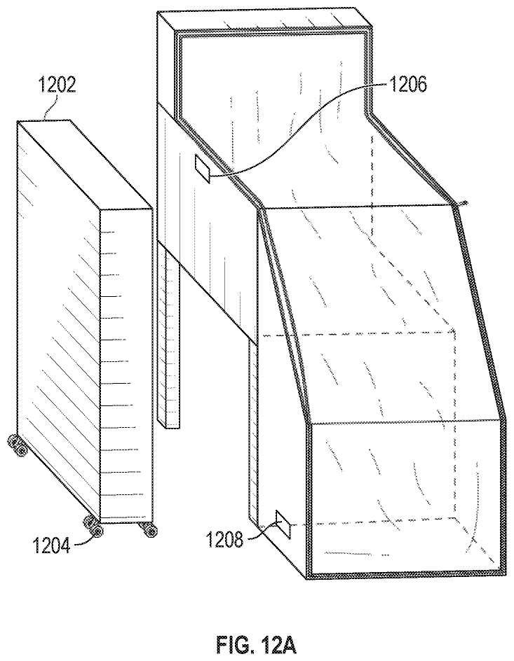

FIG. 10A, FIG. 10B, FIG. 10C, and FIG. 10D show a model of a door for the chair that can be used according to an embodiment. The user can walk in and once the user is in a seating position, the door can be closed to the closed position. The multi-layer bag 1012 comprises two layers, inner layer and outer layer, however, these two layers are sealed along the periphery and form a continuous water channel inside and also ensure that there is no leakage of the water at the boundary area. In an embodiment, placement of a water reservoir is shown at the bottom 1010 of the chair. A pump can be used to pump the fluid/water through the inlet 1012 into the multi-layer bag. A variation in the footbox/door may be used. The water reservoirs can be one or more. Their height of the water reservoir can be variable. In case of multiple water reservoirs, all of them or some of them can be connected or all of them may be independent. The chair system can include a submersible pump or external pump. They can include a water heater and/or an insulation outside the water reservoir and/or multi-layer bag to maintain the water at a desired temperature. Further, the figures show linear actuator 1020 for adjusting the angle of the foot box 1022. Figures show a roll open door 1002 (a collapsible door), a sliding door 1030, and a hinge door 1040. Other types of doors are contemplated. Placement of water reservoirs can be as per convenience and design of the chair/device. For example, side water reservoirs 1042, water reservoir at the back of the chair 1044, at the bottom of the chair 1046. Users can walk in as shown in the direction 1048 after opening the door.

FIG. 11 shows a model of a door shown in open position for the chair according to an embodiment. It is a roll open door and can be opened and closed along by rolling the door about the pivot point 1106. The user can walk in and once the user is in a seating position, the door can roll close to the closed position. The multi-layer bag 1108 comprises two layers, inner layer and outer layer, however, these two layers are sealed along the periphery and form a continuous water channel inside and also ensure that there is no leakage of the water at the boundary area. The chair comprises foot box 1104 in which the user can place the legs and can be used to submerge the legs in the potion of the multi-layer bag 1108 provided/spanning in the foot area.

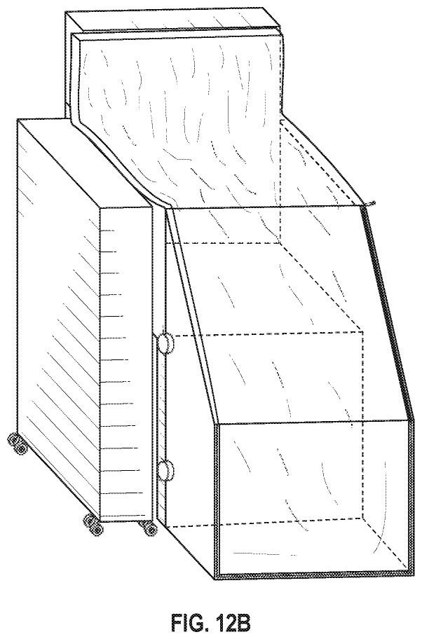

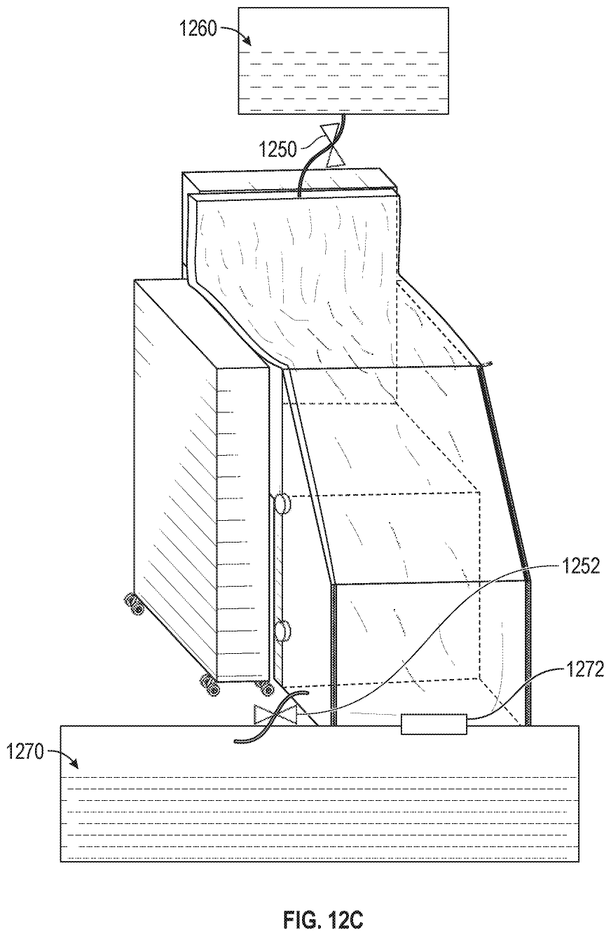

FIG. 12A, FIG. 12B and FIG. 12C show arrangement of reservoirs according to an embodiment. The fluid/water/liquid reservoir 1202 can be a detachable one or a fixed one. The water reservoir 1202 can be placed on wheels 1204. The water reservoir 1202 can be connected to the inlet ports 1206 and/or outlet ports 1208 via valve (1250 and valve 1252). The valves can be digital valves and can be electronically controlled for flow rates, open times, and/or shut times. Digital valves used for control of fluid flow are electronically actuated valve systems that allow precise and programmable regulation of liquid or gas movement through the system. These valves are integrated with sensors, microcontrollers, or programmable logic controllers (PLCs), enabling real-time adjustment of flow rate, pressure, or direction based on system demands or user-defined parameters. Structurally, digital valves may employ solenoid actuation, stepper motor drive, or proportional control mechanisms to modulate the valve position. Functionally, they enable closed-loop control where flow conditions are continuously monitored and adjusted automatically. Digital valves used are compatible with remote or networked control interfaces.

Valve 1250 may be connected to inlet water reservoir 1260 and valve 1252 may be connected to outlet water reservoir. In the embodiment shown in FIG. 12C the system is designed to work based on gravity. Inlet tank 1260 is at a height greater than the multi-layer bag feeding the water through the inlet valve 1250 based on gravity when the inlet valve 1250 is opened. When the multi-layer bag is to be emptied then the outlet valve 1252 may be controlled to empty the water from the multi-layer bag into the outlet tank 1270 based on the gravity as the outlet tank 1270 may be below the level of multi-layer bag such that the bag can be fully emptied by draining out. In embodiments, there can be an emergency draining port 1272 to dump all the water in less than a matter of seconds into the outlet tank 1270.

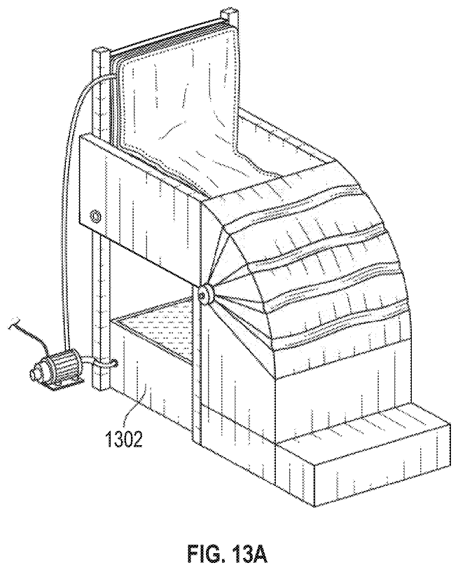

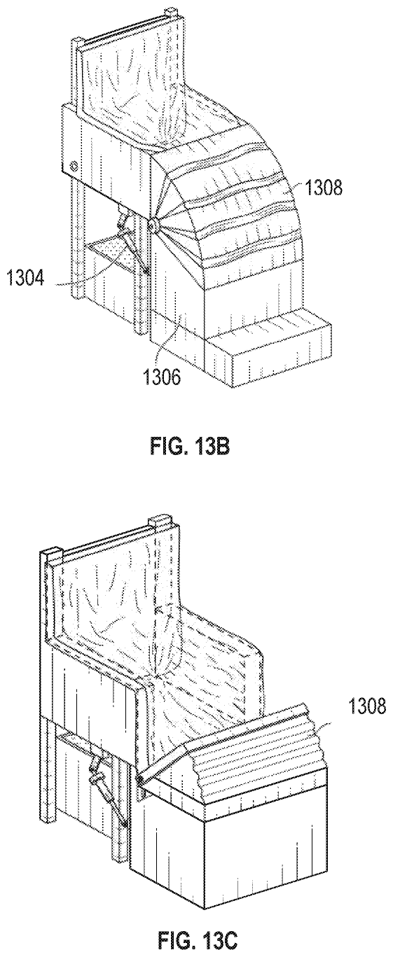

FIG. 13A, FIG. 13B, and FIG. 13C show a reservoir, linear actuators, and collapsible door for the chair according to an embodiment. The water reservoir 1302 can be a detachable one or a fixed one. The water reservoir 1302 can be placed on wheels and under the chair. The water reservoir 1302 can be connected to the inlet ports and/or outlet ports via valves. The valves can be electronically controlled for flow rate, open times, and/or shut times. Further, the figures show linear actuator 1304 for adjusting the angle of the foot box 1306. Further figures show collapsible door 1308 in closed and open positions.

Water beds, which were very popular in the USA in the late 70's became out of fashion because of mainly the water leakage and damage to the houses. Therefore, there is a need for a chair/furniture to contain a minimum amount of water. In an embodiment, the whole chair is placed on a stage, a raised platform, (box of about 3-4 inches high) with perforated top. Any water that leaks will go in and collect in the bottom box. In an embodiment, a multi-layer bag is connected to this stage so as to collect any excess water or connect the stage to a drainpipe that goes outside of the building. In some embodiments the whole chair is on the perforated stage.

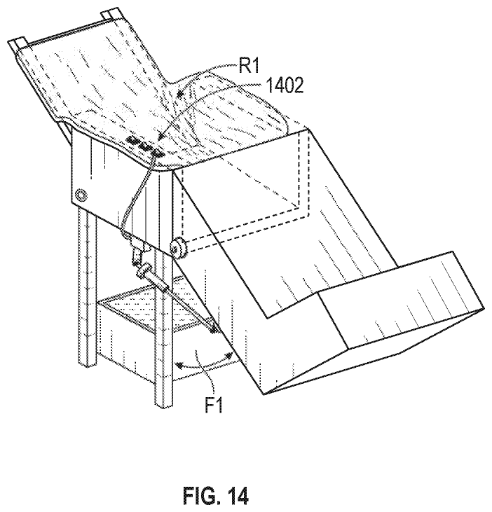

FIG. 14 shows the furniture or chair in a reclined position and footrest adjusted to an angle according to an embodiment. The chair can be adjusted for backrest reclination for an angle R1 and footrest reclination for an angle F1. R1 can be in the range of 0 to 90 degrees and F1 can be in the range of 0 to 90 degrees. When R1 and F1 are at zero the chair will be in upright position and when R1 and F1 are at 90 degrees the chair is configured into a bed. In an embodiment the ranges can be modified based on the movement and position required for the furniture. For example, the footrest reclination angle can be above 90 degrees such that the feet are in raised position compared to the user body. Figure further shows control switches 1402 to control the functions of the chair such as recline angle, footbox angle, water temperature, water pumping, water draining, closing the dome of the chair, etc. In embodiments, the controls can be based on touch display. In embodiments, the controls can be based on voice commands. In embodiments, the controls can be based on gestures or prompts. In embodiments, the controls can be done remotely.

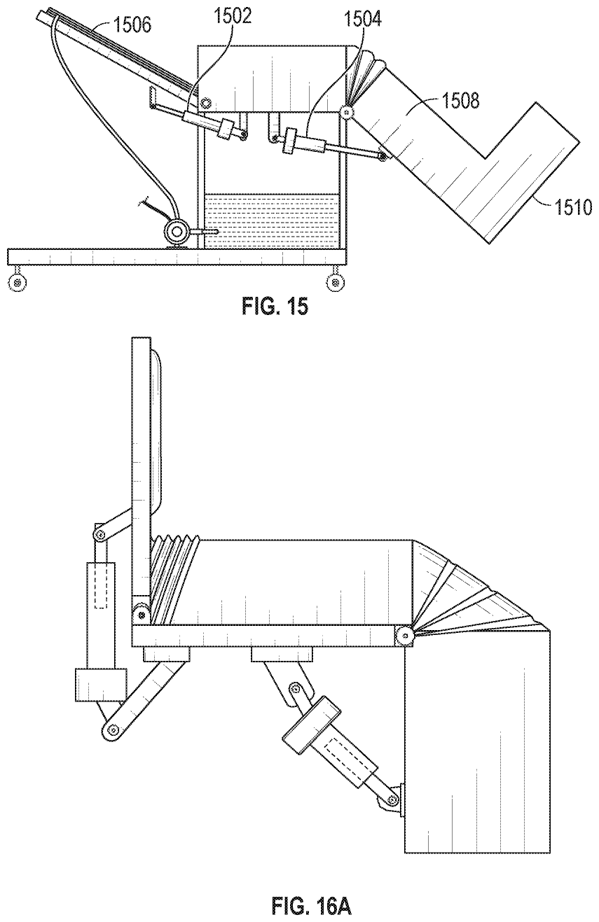

FIG. 15 shows the linear actuators positioned under the chair to change the position of the backrest and the foot box to the desired position. Linear actuator 1502 will control the reclination angle of the headrest 1506 and the linear actuator 1504 will control the reclination angle of the footrest 1508. Footbox 1510 may be connected to the footrest and is inclined along with the footrest 1508. In embodiment, the footrest may also be connected to another linear actuator (not shown) or a swivel mechanism controlling the foot swivel independently of the footrest inclination.

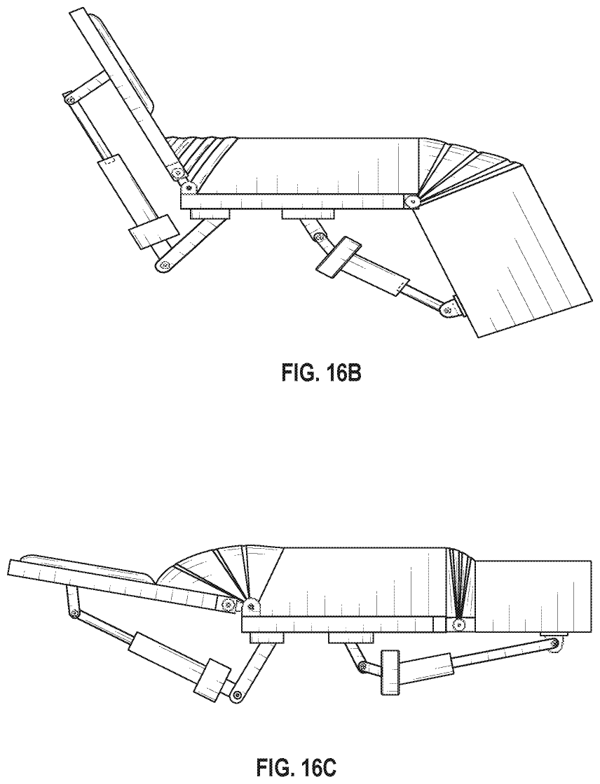

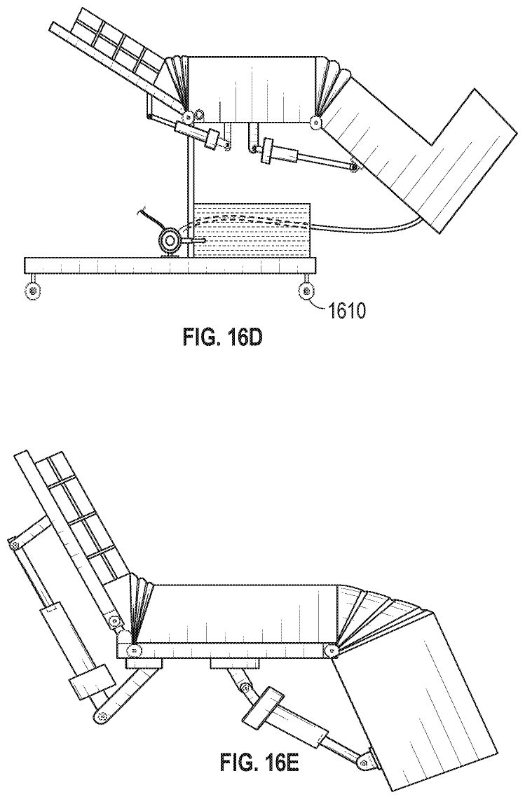

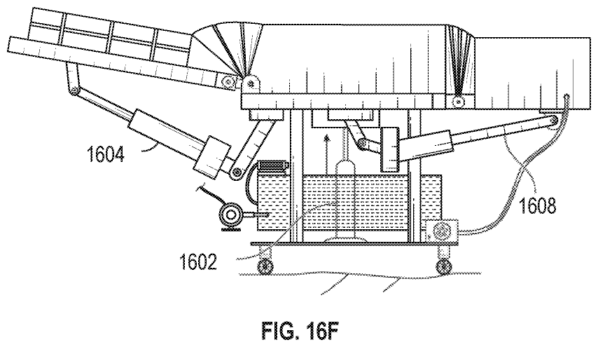

FIG. 16A, FIG. 16B, and FIG. 16C show the linear actuators positioned under the chair and/or bed to change the inclination angle of the backrest and the foot box to the desired position according to an embodiment. Linear actuators used in chairs are electromechanical devices that enable adjustment of movable sections, like the headrest and the leg rest. These actuators operate by converting electrical energy into linear motion through a motor-driven screw mechanism, allowing controlled extension or retraction of a telescoping shaft. For headrest adjustment, a linear actuator is mounted beneath the back section of the chair frame; when activated, it raises or lowers the headrest to support various reclining positions such as supine, semi-recumbent, or Fowler's position, which are essential for patient comfort, respiratory function, and clinical procedures. Similarly, a separate actuator is positioned to control the leg rest section, enabling elevation or flexion of the lower limbs to improve circulation, relieve pressure, and assist in therapeutic positioning. These actuators are governed by a central control unit or user-operated hand-held control device designed to allow patients or caregivers to operate adjustable functions and includes built-in limit switches or sensors to ensure synchronized, and reliable movement. The hand-held control device comprises a set of clearly labeled push-button controls or soft-touch switches that correspond to specific motions or settings such as raising or lowering the headrest, leg rest, or entire device (chair) height.

FIG. 16D, FIG. 16E, and FIG. 16F show the linear actuators positioned under the chair/bed to change a height 1602, inclination angle of the backrest 1604, inclination angle of the foot box 1608 according to an embodiment. The bed comprises wheels 1610 for easy transportability.

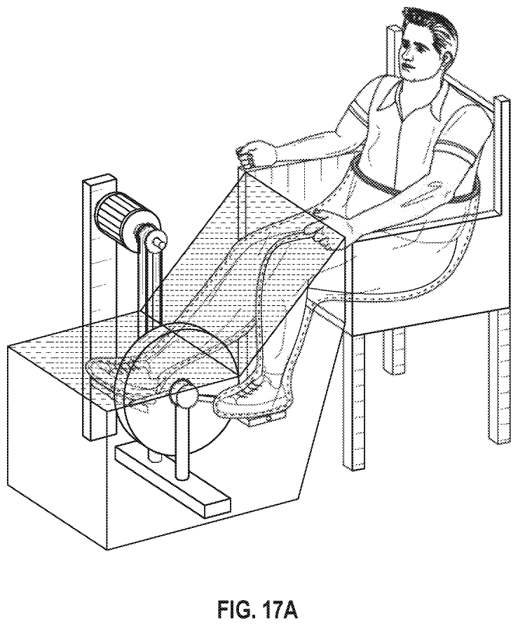

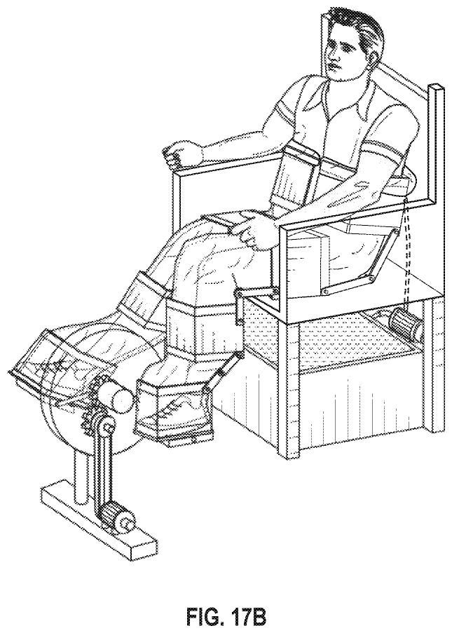

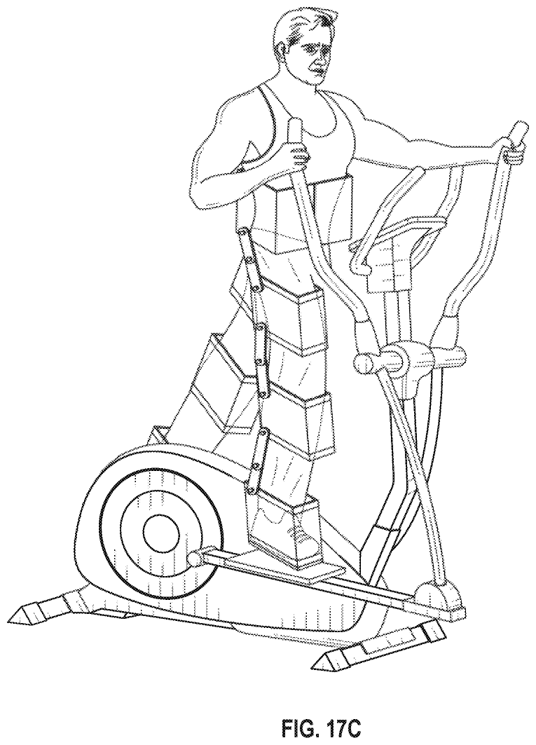

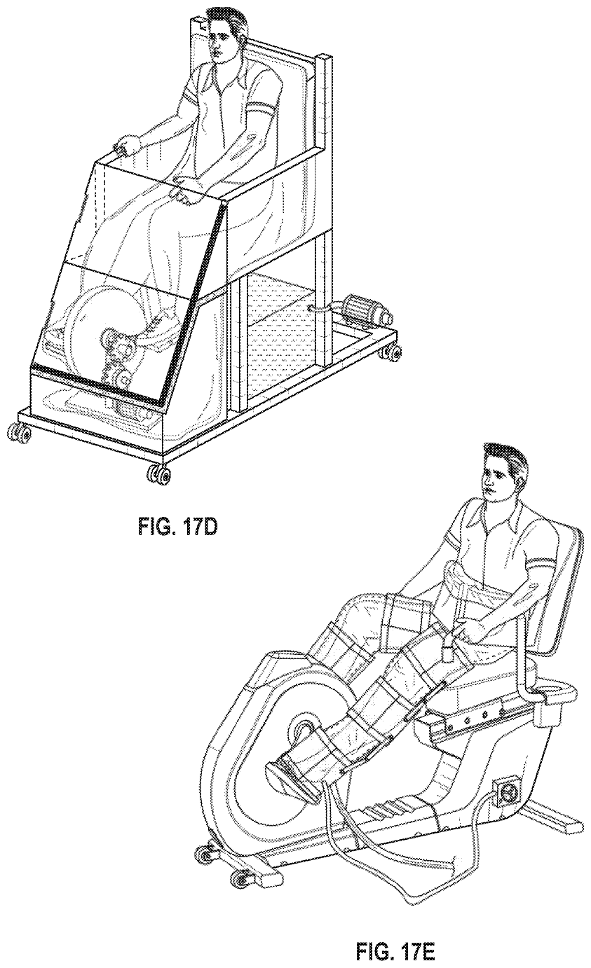

FIG. 17A, FIG. 17B, FIG. 17C, FIG. 17D, and FIG. 17E show a variation of exercise equipment according to an embodiment. The stationary bicycle could be of standing or sitting version, one of such embodiments, a sitting variation. Not shown in the figure are the connection to the tank and the opening mechanism. The person enters the chair by opening the zippers. The door and the portions covering the legs are covered with flexible material with joints to allow for free movement of the legs while pedaling. A stationary cycle is used by placing the feet with the enclosed portions on the pedals. The multi-layer bag is filled with water. The person pedals the bicycle in the normal way. An auxiliary power source may be used when needed to assist in pedaling. The pressure in the chair and the amount of water volume is adjusted to provide optimum buoyancy. The bicycle is secured to the foot board or is located independent of the chair.

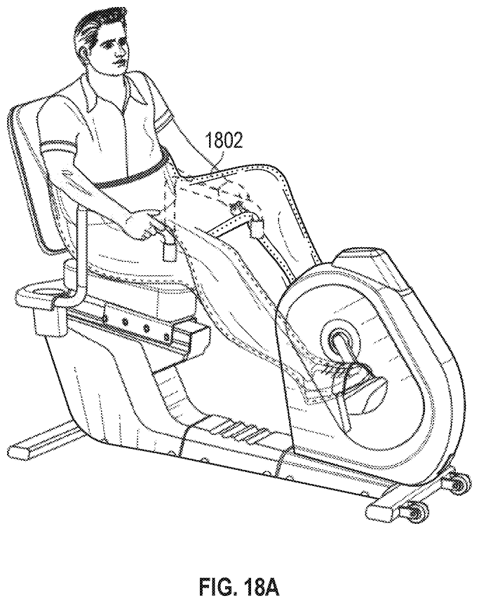

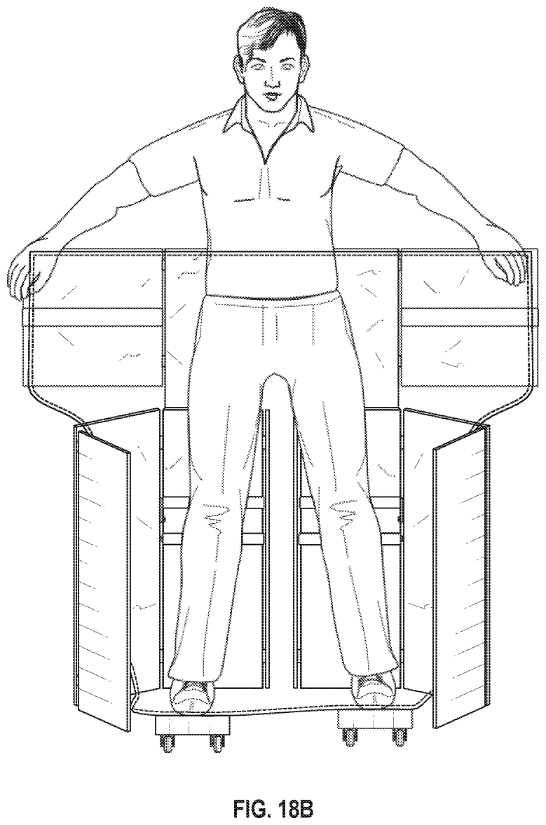

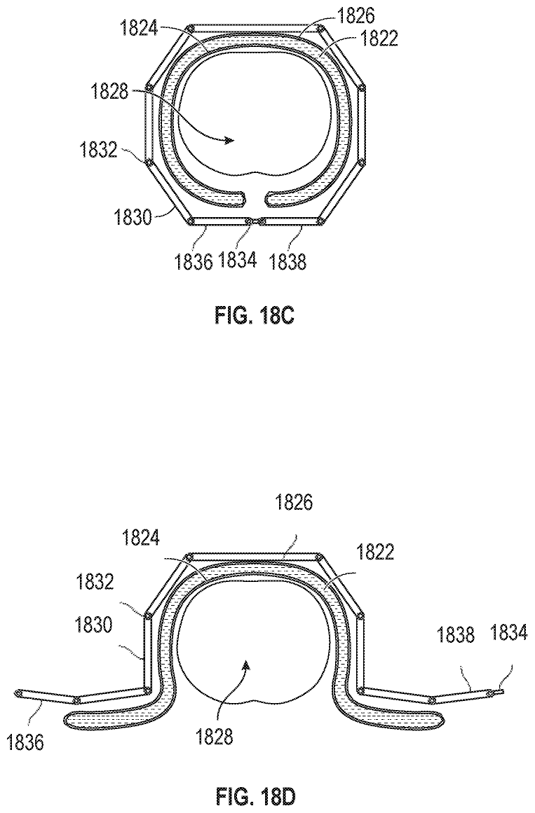

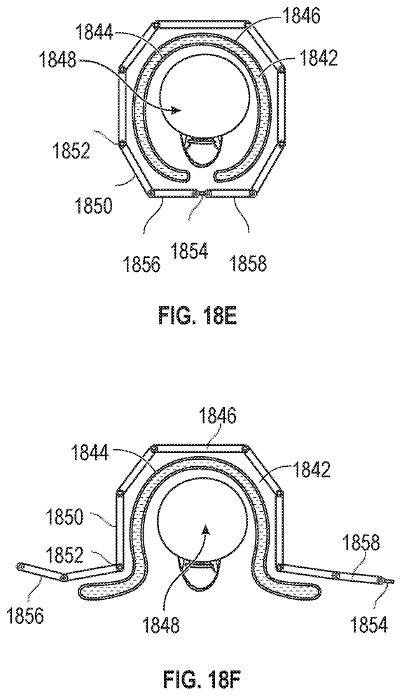

FIG. 18A shows a user exercising in exercise equipment according to an embodiment. FIG. 18A shows a variation of a stationary bicycle according to an embodiment where the user is wrapped in a multi-layer bag 1802.

FIG. 18B shows an enclosure for users to use with an exercise device according to an embodiment. FIG. 18C, FIG. 18D, FIG. 18E, and FIG. 18F show cross-sectional views of FIG. 18B according to an embodiment.

FIG. 18C and FIG. 18D show a cross-sectional view of abdominal region of the user. Figures show a double-layer bag/multi-layer bag 1822 filled with fluid between inner layer 1824 and outer layer 1826 and attached to the frame (attachments not shown). Multi-layer bag 1822 surrounds the abdomen area 1828 of the user. Multi-layer bag 1822 is attached to the frame 1830, where the frame comprises plurality of hinges 1832 to enable multiple degrees of freedom for the user/user body part to move within he frame. The frame comprises doors 1836 and 1838 which can be opened, closed, and locked using locking mechanism 1834. FIG. 18C shows the frame in locked position around the abdominal region whereas FIG. 18D shows the frame in open position.

FIG. 18E and FIG. 18F show a cross-sectional view of leg of the user. Figures show a double-layer bag/multi-layer bag 1842 filled with fluid between inner layer 1844 and outer layer 1846 and attached to the frame (attachments not shown). Multi-layer bag 1842 surrounds the leg 1848 of the user. Multi-layer bag 1842 is attached to the frame 1850, where the frame comprises plurality of hinges 1852 to enable multiple degrees of freedom for the user/user body part to move within he frame. The frame comprises doors 1856 and 1858 which can be opened, closed, and locked using locking mechanism 1854. FIG. 18E shows the frame in locked position around the leg whereas FIG. 18F shows the frame in open position.

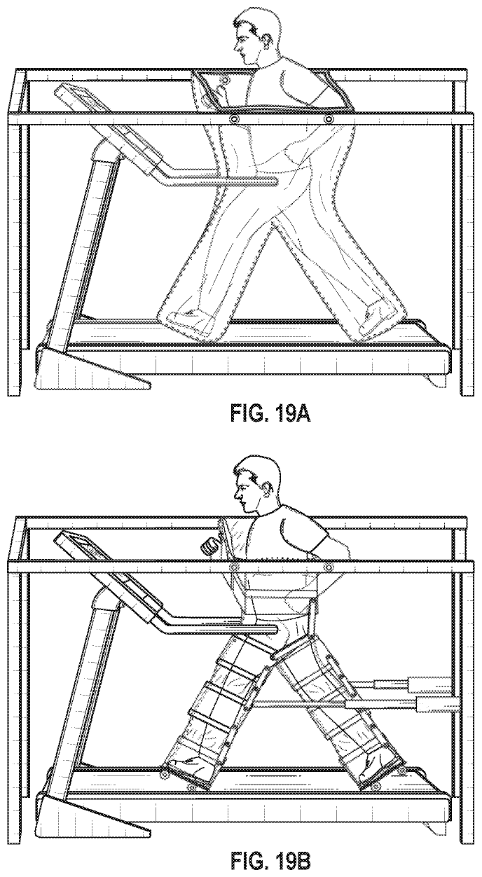

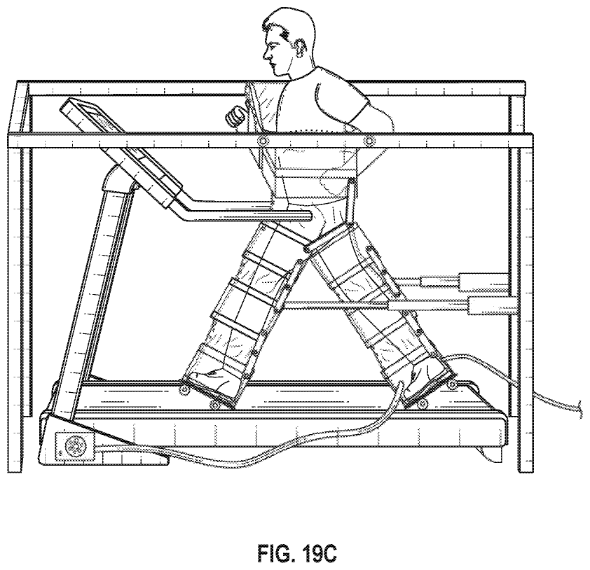

FIG. 19A, FIG. 19B, and FIG. 19C show a treadmill according to one or more embodiments. A treadmill comprises a movable track and a frame comprising a suit to support the person. The suit comprises two separate enclosures for the legs to enable free movement of the joints, a mixture of flexible and hard covering to support the person and the surrounding water in a bag and openings to enter and secure the suit to the body and to the external support frame as appropriate. The outer frame that holds the upper body of the person and contains the multi-layer bag is secured to the supporting frame. The portion that surrounds the legs and contains the double sheet layer part of the chair is free to move on the treadmill. As the weight of the surrounding structure is supported by the frame, the person using the treadmill is able to move their legs on the moving belt without much effort. Forward or backward movement of the legs is helped by optional wheels located under the enclosure provided for the feet. The embodiment also comprises an auxiliary power source to help the person to move the legs forward or upward as needed. Not shown in the above, but a similar system, for example, a stair-climber exercise device can also be used instead of the treadmill for the purpose of exercise. As the weight of the body is off-loaded from the legs by the above suit, the load on the heart reduces when one exercises using the system, and therefore, is potentially useful, for example, for rehabilitation of injured people and those with heart failure.

Exercise equipment can include any of Exercise Bike (Chair combined with pedal exerciser in foot box, recumbent bike, pedal exerciser, elliptical exerciser, upright exercise bike, upper body exercise including weights. Note that all the above-mentioned are possible combinations. In water a person moves against water resistance as well as gravity, similar to how a person on land riding a bike will have to work against the air resistance as well as gravitational force.

The pedal exerciser or the bike combined with a foot box differs from the independent recumbent or the upright exercise bike in two fundamental ways. In the foot box, the pedal exerciser can be placed in the space between the outer and inner layer of the bag and inner layer actually comes into contact with the pedals, when the user places feet on the pedals. So, the person will be pedaling against the water resistance and the gravity as the pedals will be pushing water aside when rotating or going up and down. In this case both legs can be placed in one bag or both legs can be separated. The user has to place the foot exerciser in the space between the inner and outer bag and secure it in the foot box for exercise. To exercise, the user will sit in the chair and fill the multi-layer bag with water and then will start exercising.

To use the independent recumbent bike or the upright bike, the person opens the doors for the legs and the upper body, closes and secures the doors. Note that the enclosure for the feet is secured to the pedals and the enclosure around the buttock region is secured to the seat of the bike. The enclosures contain the multi-layer bag, separated at the pelvic region to accommodate the legs independently. The bags are connected to a water pipe at the pedals to fill and empty the bags. The enclosure has joints to support flexibility at the joints such as ankles, knees and pelvic joints.

Exercise equipment also shows a person using an elliptical exerciser, after entering the bags placed in an outer cover supporting the bags. The person closes the panels to the entrance of the enclosure. The space between the inner and outer layer is filled with water connected to the bags at the pedals, and the pipe in turn is connected to a pump and tank. An auxiliary motor in the elliptical machine will help in movement of the pedals, as it will be difficult for the person exercising to move the pedals without external assistance. Note that additional features of the equipment such as the tank, pump, etc., were not shown in the exercise equipment Figures. A supporting frame (not shown in the figures) may be provided to help with the stability of the patient while using the equipment. The portion that encloses the foot of the user may be secured to the pedals to increase the stability of the person while using the device. The temperature of the water will be regulated to the user's needs as the person gets hot while exercising. After completing the exercise, the person empties the bags, opens the enclosure doors and leaves the elliptical exerciser.

The bike and treadmill are provided here as examples of exercise equipment, without limitation on exercise devices that can be used with the chair or using the method described in the application. A person can exercise the upper body such as the trunk, chest and arms, by lifting weights or other types of loads, while the lower body and the legs can be exercised using a bike and a treadmill. The person gets the benefit of hydrotherapy, regardless of the type of exercise equipment, due to the buoyancy effect on the body and the physiological systems.

Treadmill exercise equipment have rollers on the feet. The user/person moves against the water resistance and gravity. Not against gravity. The frame and the outer shell supporting the legs are connected to a motor that is controlled to lift and move the individual legs forward. This allows the user to move the legs easily. The equipment can be an add on to the chair or independent. These are just examples of exercise devices. Hydrotherapy requires exercise.

The frame and outer shell supporting the bladder and the person is supported by a frame of the treadmill. Auxiliary power supply may be used to move the treadmill.

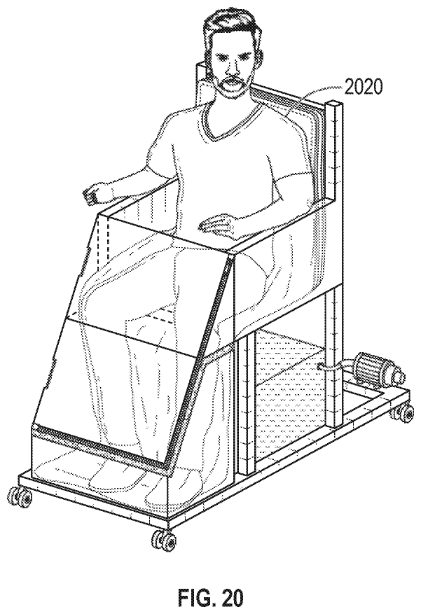

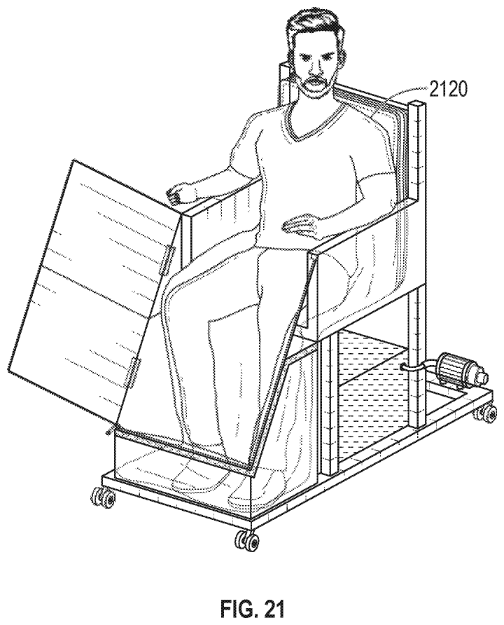

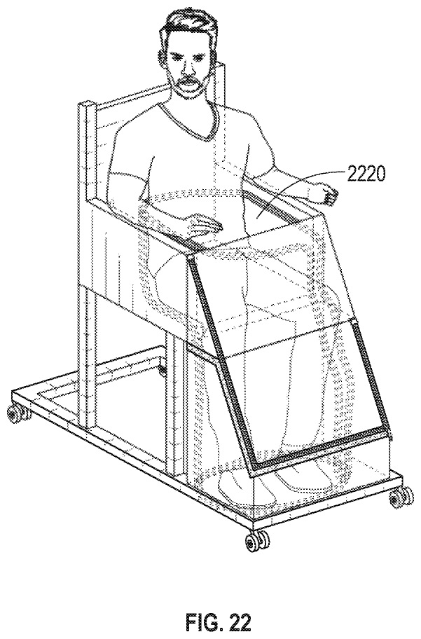

FIG. 20, FIG. 21, and FIG. 22 shows a user using the chair according to an embodiment. Figures show the multi-layer bag 2020, 2120, 2220 surrounding the user.

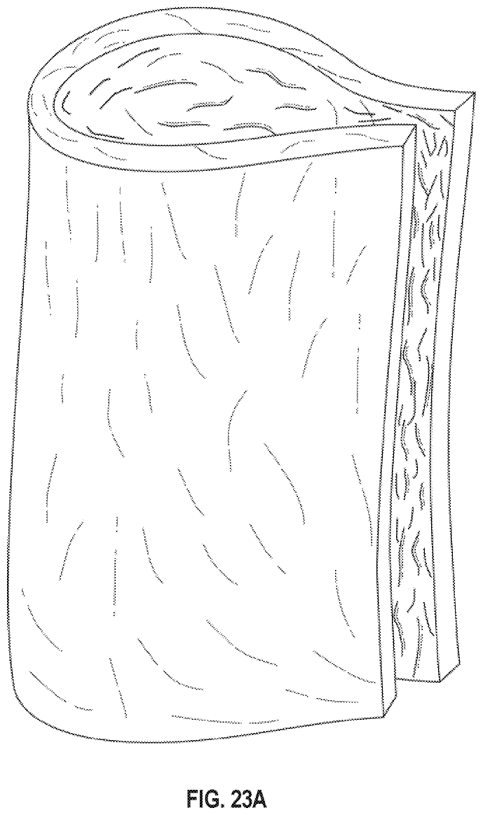

FIG. 23A, FIG. 23B, and FIG. 23C show the multi-layer bag that is used for surrounding the user according to an embodiment.

The multi-layer bag works differently from the water beds. When a person lies down on water beds, the body touching the surface of the bed conforms to the back and sides of the person to distribute the weight and provide comfort. The multi-layer bag surrounds the person in all four directions and exerts buoyancy forces like a swimming pool. Further, as the gravitational force related effects on the circulatory and musculoskeletal systems of the body are relatively high in the standing or sitting upright position, when compared to lying horizontally, the multi-layer bag together with the chair/device works differently from water beds. Additionally, it is to be noted that, while the outer layer of the bag touches the inner surface of the chair to support the weight of the water and the person within, the inner layer of the multi-layer bag conforms to the size and contours of the body and hugs the immersed portion of the body like the water in the swimming pool. While the outer layer of the bag is designed to be rugged and any thickness, the material and the physical properties of the inner layer are chosen to be flexible, stretchable and move with the water and the body to support the weight of the immersed part of the body, during the time when the person is in the chair and surrounded by the water filled multi-layer bag. This also allows for continuous gradient of the pressure exerted on the immersed portion all the time. Multi-layer bag is formed by attaching the inner layer to the outer layer on all sides or at least three sides by matching all the four corners forming an interstitial space between the two layers as shown in FIG. 23A and FIG. 23B.

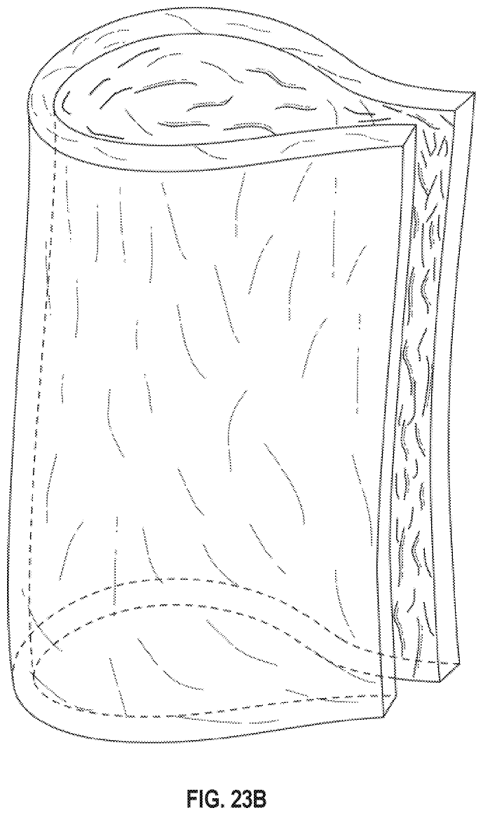

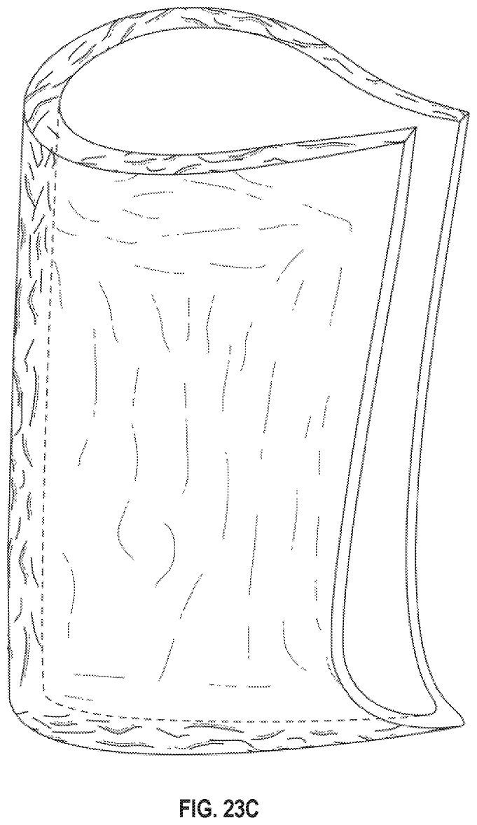

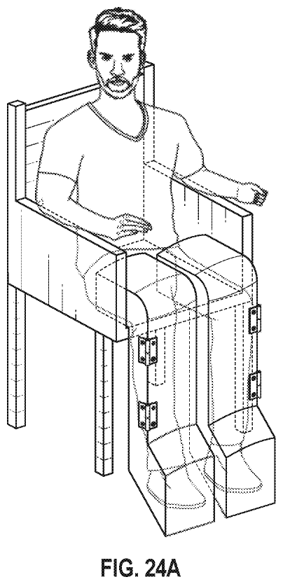

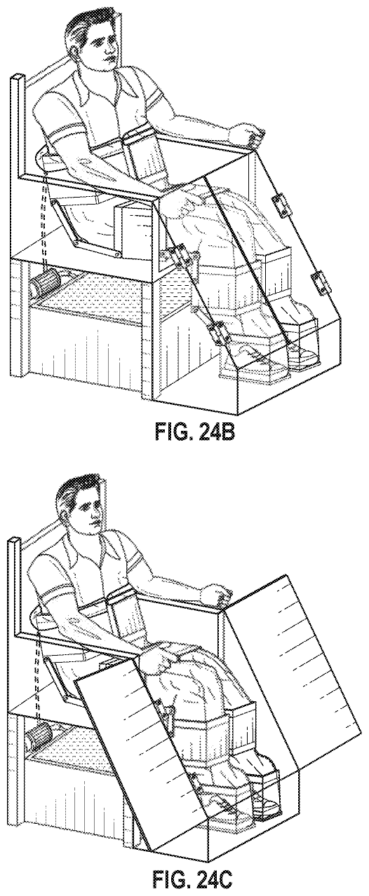

Although, “multi-layer” bag is used to describe the bladder or bag used in this application, there is no limitation on the physical shape, or size, or the physical or chemical properties of either the liquid medium or the bag used. For example, the bag/bladder can have one solid side, such as the panel of the chair, and the rest is made of flexible material. There is no limitation on the number of layers, or the compartment used in the bag. The number of layers in the bag could be one or more, and several layers could be laminated or extruded together to get the desired properties. Additional components such as foam could be placed inside the bag to provide increased comfort and absorb motion of the water while using the equipment. The bag may have shower heads connected to the inner layer to clean the person, or massage rollers and jets located within the space between the inner and outer layers to massage a person without actually coming in direct contact with the body of the person. The bag may have through holes (for example, through both layers in case of the double-layer bag) to allow for air circulation, for cleaning, for draining of any liquids, for passing through cables or other tubes that the person to treat a person, or to access various parts of the body while seated in the chair (e.g., to check vital signs, or to administer a treatment). It is also necessary for the body to cover almost all of the 100% of the immersed portion of the body, and instead there may be gaps allowed in the bag design, to selectively apply to certain portions of the body. The bag can have a continuous single compartment as disclosed herein. In embodiments, the bag with multiple compartments may also be used. The bag may also be connected to the body of the water enclosed in other portions of the chair to provide additional flexibility in design of the chair. Although only one bag is shown here, there is no limitation on the number of bags used to exert buoyancy forces on the body. Heating elements could be incorporated into the space between the outer and inner layers of the multi-layer bag, or the heating element could be incorporated into the inner bag, to keep a person warm. The inner layer could be insulated to minimize exposure to either hot or cold temperatures of the water in the bag. The inner layer of the bag can have sensors attached to monitor various physiological parameters of the body, such as temperature, electrical signals from heart, pulse, blood pressure, oxygen saturation, sympathetic activity, etc. FIG. 24A, FIG. 24B, and FIG. 24C show a chair structure where separate compartments are provided for each leg according to an embodiment.

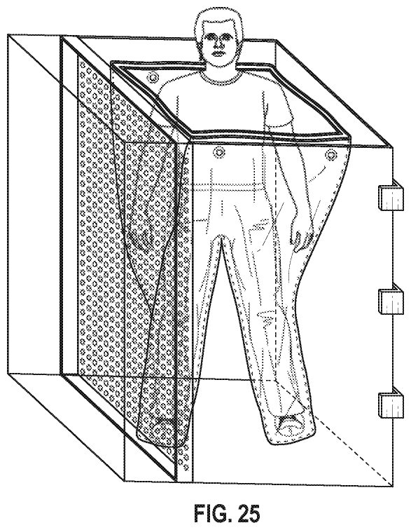

FIG. 25 shows a walk-in bathtub with storage tank according to an embodiment. An embodiment shows a standing shower, a walk-in bathtub, or a horizontal bathtub (not shown in the figure) that uses minimum water but still gives the feeling of the swimming pool. In this embodiment, the walk-in bathtub will have a multi-layer flexible bag secured to the inner walls of the tub. When the person sits or stands in the tub, the water fills the multi-layer flexible bag and gives the feeling of being present in the swimming pool or water filled bathtub, without actually coming into contact with the person. An additional shower may be used to wash the body. Waterspouts or shower heads placed between the inner layer and the person will wet the person and help to clean the body. This way, with a minimum amount of water, a person can take a bath in a tub. At the end of the bath, the water does not have to be emptied and can be returned to the storage tank or reheated and used again to exert hydrostatic pressure next time. This will save a lot of water, especially when climate change is affecting the world.

In a bathtub the user will fill the water and then at the end of the bath they will throw that water out right away because it is contaminated. In an embodiment, as shown in FIG. 25, the user can have a stand/sit in a bathtub or horizontal bathtub stand, or standing bath shower, walk in shower, walk in bathtubs, and let the water be surrounded by the inner membrane and the outer membrane. For example, a perforated sheet on the side is filled with water. The left side of the red color is a perforated sheet. It also has a solid sheet that is separated, and one can open the valves to fill the multi-layer bag (which is not shown in the figure). The user in the water tub now essentially is experiencing the water buoyancy and forces but is not contacting water and thus the water can be reused multiple times and for multiple users.

Walk-in tub: Bathtubs, either the regular or those that are walk-in tubs are filled with hot water for taking a bath. At the end of the bath most of the water in the bathtubs is drained out as it is dirty, wasting both the power and the water. People often take baths and enjoy immersion in water, because of the buoyancy effects the water exerts on their bodies. The bathtub disclosed in this application saves energy and water, by using a multi-layer bag to create the buoyancy effect on the body, while a separate built-in shower in the bag or in the tub can be used to clean the body. At the end of the bath, the dirty water, which will be a relatively smaller amount, can be drained off, while the water that is contained in the multi-layer back can be returned to the insulated tank, as it never comes into contact with a person. This saves both energy and water. The tank for the tub can be placed at a distance away from the tub and the tub may have other additional features such as jets to provide massage to the body. The jets can be placed in the double-inner layer of the multi-layer bag covers around the body of the person. The multi-layer bag is designed and placed in the bag, so as to allow for easy drainage of any dirty water from the shower (e.g., by either pulling the bags apart either manually, automatically, or providing drain outlets through the multi-layer bag to remove the dirty water. The bag also covers all sides and door of the tub, and the ends of the bag are sealed, but kept apart at the door, so as to allow easy entry and exit of the person.

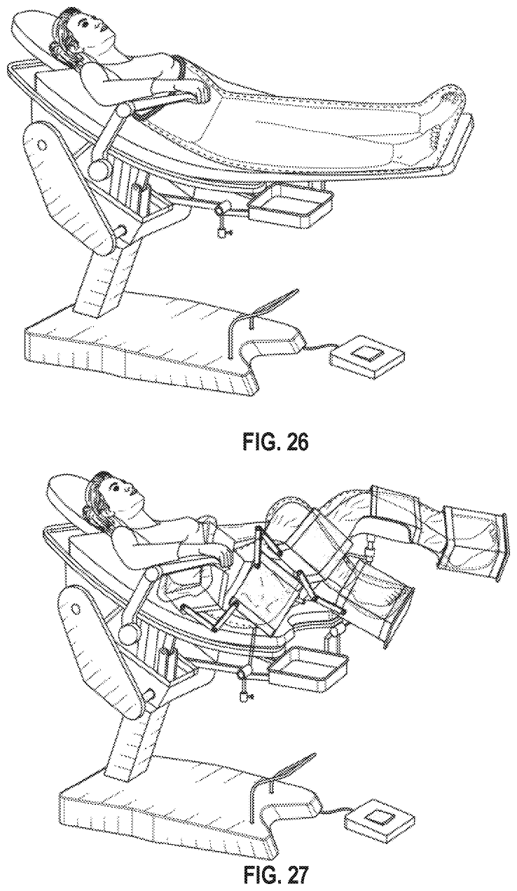

FIG. 26, FIG. 27, and FIG. 28 show a delivery chair/bed according to an embodiment. In an embodiment, a variation of above-mentioned, a horizontal bathtub may potentially be used by an expectant mother in hospital for delivery of the baby to provide a more comfortable experience. A significant amount of literature is available on waterbirth, where during the labor, the mother is placed in a tub filled with water and the baby is delivered underwater. Due to the reduced-weight environment provided by the water and other reasons it has been reported that such a delivery method offers a less painful alternative to standard delivery. However, one drawback of such delivery is the potential infection risk and additional precautions it requires. Therefore, the proposed device offers a direct contract-free underwater delivery method.

Waterbirth (Immersion in water during labor and delivery): Immersion in water during the first stage of labor may be associated with shorter labor and decreased use of spinal and epidural analgesia and may be offered to healthy women with uncomplicated pregnancies between 37 0/7 weeks and 41 6/7 weeks of gestation (American College of Obstetrics and Gynecology, Committee Opinion No. 679, Reaffirmed 2021: Immersion in Water During Labor and Delivery|ACOG). While waterbirth is popular in some countries like the Netherlands (up to 20%), the use is less frequent in other countries. One of the main reasons for wide adoption of waterbirth, despite its benefits, is lack of adequate infrastructure and perceived dangers to the mother and fetus, such as aspiration and infection risk. Therefore, the chair shown in figures, and a modified waterbirth delivery chair shown in FIGS. 26, 27, and 28 with the multi-layer bag, the tank, foot box, and the leg supports would be a convenient option for the expectant mother to experience waterbirth, while safely delivering baby. The expectant mother who is experiencing the contractions will be seated in the chair, with a clean multi-layer bag and sheets, and the bag will be filled with warm water to the desired level, to create a relaxing environment. When the mother is ready to deliver the baby, the bag is emptied, to allow for staff to help the mother with the delivery process. After the mother leaves the chair, the sheets are changed and the chair sanitized before use by another patient. As the baby never comes into contact with the water directly when delivered, the potential risk of aspiration is minimized.

Still another embodiment as described above can potentially be used to prevent loss of water from a burn patient when the extent of burns are significantly high resulting in significant fluid loss from the body. When the patient with burn injuries is placed in the horizontal bathtub-like device described herein, the resulting external application of the gradient hydrostatic forces can act as a counterforce to the capillary leak and the loss of fluids.

Similar applications of the device in other embodiments include treatment of leg edema in various patients, including pregnant women, relief of lymphatic edema from dependent portions of the body, and treatment of chronic venous ulcers.

In an additional embodiment, the chair can be combined with massaging features to enhance comfort and relaxation.

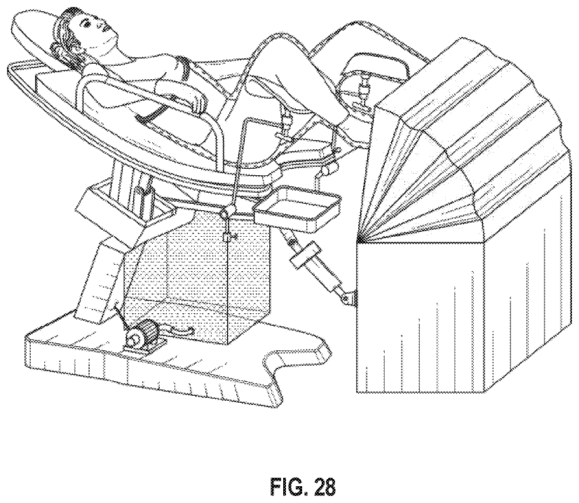

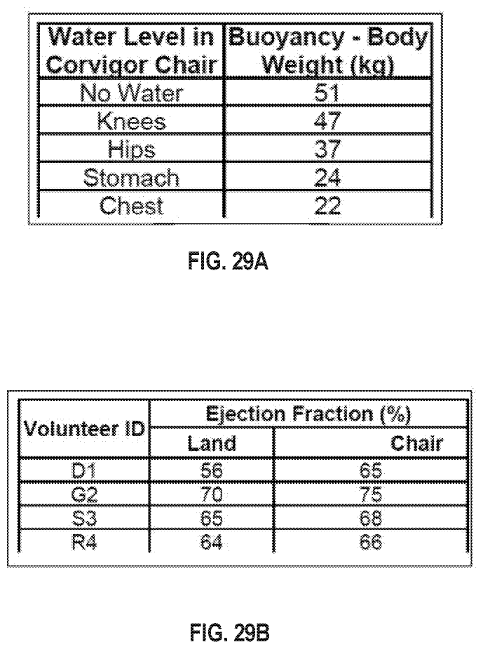

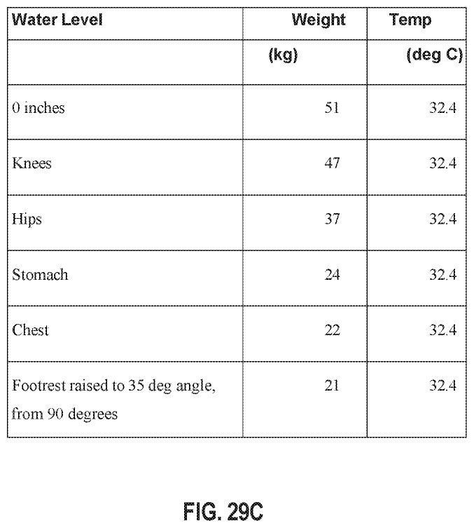

Preliminary Results with the Chair: FIG. 29A shows buoyancy data of the chair under testing according to an embodiment. Hydrostatic pressure measurements reached 2.1 psi at 5 feet level, consistent with values in standard swimming pools at that depth. Buoyancy effects were observed through a reduction in apparent body weight from 51 kg to 22 kg as water levels rose as shown in FIG. 29A, indicating offloading similar to pool-based hydrotherapy. FIG. 29B shows cardiovascular ejection fraction according to an embodiment. Preliminary testing of the Chair in male volunteers demonstrated its ability to replicate key physiological features of aquatic immersion. Increases in cardiac ejection fraction were observed in adult volunteers (ages 24-65) following 5-15 minutes of seated immersion as shown in FIG. 29B, consistent with results from hydrotherapy studies reported in the literature. Together, these findings support that the chair simulates swimming pool conditions while keeping the user dry.

Water is used as a catch-all generic term in this application. Any fluid can be used instead of water. There is no limitation on the type of materials used to exert forces similar to a gradient of forces experienced in a swimming pool. These include but are not limited to salt solutions, a mixture of various liquids, semisolid or gel-like substances, powder, or balls or a mixture of them to impart the optimal characteristics to the fluid.

Compartmentalization of fluid in the bladders to minimize leakage and use minimum energy to operate the device: In some embodiments, in order to minimize the pumping of water into the multi-layer bag and emptying every time a user has to enter and exit the chair, the water may be put in compartments that are separated by a stretchable or flexible membrane such that they still exert pressure on each other, although they are physically separated by a layer. For example, if one fills a drum of water with some free water and some water filled balloons or bags, the pressure gradient is still maintained even though the water is separated. In such an embodiment, all the water contained in these bags need not be emptied every time a person enters and exits the chair. It is enough to remove the required amount of water, which can substantially lower the amount, compared to if all the water is in one multi-layer bag.

Additional option to minimize amount of water in the chair: In some embodiments, a drum comprising a rigid body and thin membrane on one side can be used as a pressure chamber to exert pressure on the water, to increase the pressure on the water and in turn on the person seated in the chair. An additional option is to use a piston type device to increase the pressure on the water contained in the chair. In an embodiment, salt solution is used to increase density of water.

Retrofit device: The multi-layer bag along with the footrest/box, and the door can easily be attached to any standard chair. This can be accomplished by placing the bag and the surrounding side and back walls on an appropriate chair and attaching the foot box and the front flexible door to the chair. Based on the design of the chair, additional means to raise the footrest and lean the backrest may be added. A reservoir to hold the water and a pump to fill and drain the bag may be included as well. Such a retrofit device will allow for transforming any existing household chair to exert hydrostatic forces on a person.

Changing pressure gradient and buoyancy force on the body: In a swimming pool there is usually not an opportunity to change the gradient of pressure or the buoyancy unless one changes the depth of immersion. However, in this present embodiment, the volume of the water present in the multi-layer bag can be altered, while keeping the same height (depth of immersion). This will allow for either reducing or increasing the total buoyancy force on the body, without affecting the pressure gradient (as the height of the water column remains the same). This is an important aspect since it allows for customization for individual disease conditions. Also, it allows for accommodating people with different dimensions, weight, and size.

Pressure gradient: The pressure gradient can be changed as disclosed herein elsewhere, by either using various densities of the fluid (e.g., salt solution), using a piston type of device to increase pressure in the bag (the bag in this case does not expand-which can accomplished by placing a seal or extra weight on the top of the bag while in chair), or even changing the height of the tank in relation to the person. It is not possible to accomplish changing forces at a given position while in a swimming pool.

In one embodiment the chair comprises an inner perforated seat and side and back walls of the chair, as well as a footrest area, which is surrounded by an outer solid compartment. The water is located in the outer solid compartment. The multi-layer bag is designed differently for this embodiment; in this the outer layer is perforated, but the inner layer is intact without any perforations. The multi-layer sheet is secured to the perforated sheet and surrounds the person. The sheet can be continuous or can be attached to individual sections. When the perforated sheet with the person is lowered into the outer compartment, the water pushes through the outer layer, fills the bag, and exerts hydrostatic force on the person. Instead of lowering the person and the perforated seat into the outer compartment, it is possible to raise the outer compartment to push water into the multi-layer. The reverse operation will allow for draining of the water from the multi-layer bag and the person to exit the chair.

FIG. 29C shows data from the prototype testing of the recliner chair with angle adjustable footrest according to an embodiment. The data shows the difference in the weight of the person as the water is filled to various levels such as until knee level, hip level, stomach level, chest level of the seated person. Further, the data also shows the change in the weight as the footrest/recliner is adjusted. In an embodiment, the apparatus is designed such that it can be retrofitted to an existing furniture, for example, recliner, anti-gravity, massage chair, beautician chair, or therapy chairs.

In an embodiment, a high-density fluid is used to minimize the volume of the water but get the same effect as that of regular water.

In an embodiment, a piston or weight on the top of the water storage tanks or on the multi-layer bag is used to increase the pressure with less amount of water.

In an embodiment, an ability to reduce or increase the amount of water surrounding a person so we can alter how much weight is off-loaded. In a swimming pool, it is always the same buoyancy depending on the depth of immersion. In the current apparatus, one can vary the gradient of forces to simulate the depth of immersion.

Simulating a condition of floating or immersion in a fluid (with or without any support), however, is more challenging for the existing conventional technology. Therefore, described in this disclosure are methods and some embodiments of devices to simulate motions that provide the feeling of floating over, or immersed in a fluid, staying suspended or staying at the bottom of a pool, without the requirement to physically place the user in actual fluid. One of the objectives is to provide the user with a feeling of floating freely, for example, in the water, or submerged underwater, and suspended freely or standing on a supporting structure in the water. The simulation may be used for simulating swimming, various water sports and activities, defense or space research training, virtual reality games in water, etc. In some embodiments, the device may look like a chair or other equipment and covers only a part of a body or a whole body.

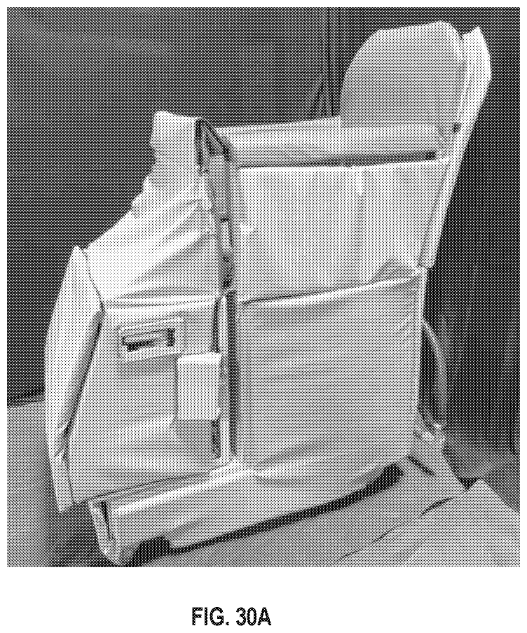

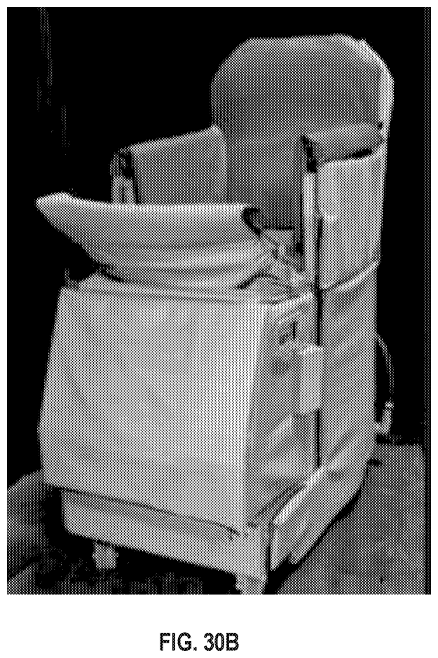

FIG. 30A and FIG. 30B show a prototype of the chair according to an embodiment.

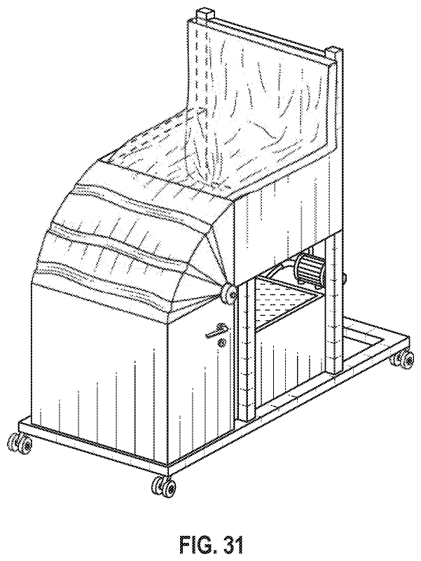

FIG. 31 shows a chair comprising a multi-layer bag, entry and exit door, and a collapsible door according to an embodiment.

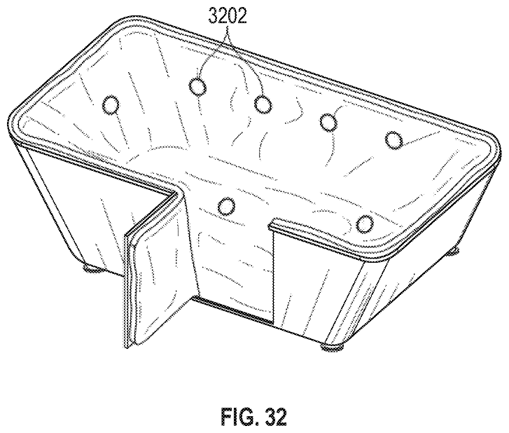

FIG. 32 shows a jacuzzi comprising a multi-layer bag, entry and exit door according to an embodiment. Jets are placed in areas 3202 such that the effect of the jet is felt by the user without the user actually getting wet. The specialized fabric uses water jets in the areas 3202 which may have different flexibility and let the user feel different pressure. Ares 3202 may be more flexible than the rest of the inner layer area.

Arrhythmia and hypertension crisis: Cardiac arrhythmias could lead to dysfunction of the heart. Immersion in warm water has been reported to the severity of arrhythmia in patients. The anti-arrhythmic effect in warm water is likely due to reduced workload on the heart, due to increased preload, and reduced afterload aided by vascular dilation, and return of blood to central compartment from the periphery due to hydrostatic forces on the lower portions of the body. Therefore, the chair as disclosed herein in this application may be used to reduce severity and incidence arrhythmia in patients. To treat a patient suffering from arrhythmia, a patient will be seated in the chair and the bag is filled to a desired position while monitoring the patient's ECG and other cardiac parameters, while under the care of a physician.

Intradialytic hypotension (IDH): IDH is one of the most frequent complication of hemodialysis treatments affecting up to 12% of patients with chronic kidney failure and is associated with ischemic stress to heart and brain and increased mortality. Reduction of ≥20 mmHg systolic blood pressure or ≥10 mmHg mean arterial pressure is defined as IDH (K/DOQI Workgroup, 2005, Am J Kidney Dis, 2005, 45: S1, PMID 1586502). Several strategies are used to mitigate the risk and manage the risk, nevertheless improved therapeutic options are needed. It was reported that immersion in water batch during hemodialysis has reduced the incidence of IDH (Doenyas-Barka et al, 2018, Hemodial Intern, 22:377, DOI: 10.1111/hdi.12634). However, as immersion in a bathtub or pool is not practical due to the clean environment required for hemodialysis, it is proposed that the chair shown in FIG. 2A in this application can be used for management of IDH. To use the device, patients undergoing hemodialysis will be seated in the chair shown in FIG. 2A, the door closed. At an appropriate time after initiation of hemodialysis, the multi-layer bag is filled with water to desired level and the blood pressure of the patient is monitored throughout the procedure, either by a technician or a nephrologist. The hydrostatic pressure of the water in the bag minimizes the risk of hypotension during the procedure. At the completion of the procedure, the water level in the bag is slowly reduced over a period and then the patient is asked to go home, if it is determined that there is no risk of IDH or IDH-related adverse effects.

Nocturia: Nocturia is defined as need for patients to get up at night regularly to urinate, and it is considered most bothersome of all urinary symptoms and affects up to 24% in males in adults over 55 years of age. Both hypertension and heart failure are commonly associated with nocturia. In patients with heart failure, the nocturnal supine position leads to increase in central fluid volume due to increase in venous return, from the periphery, leading to natriuresis and the need for frequent urination at night (Ohishi, et al 2021, Hypertension Res., 44:733, DOI: 10.1038/s41440-021-00634-0). Thiazide diuretics and loop diuretics are often used to manage nocturia. Hydrotherapy is known to cause increased diuresis, and therefore, the chair described in FIG. 2A in this application may be used to promote diuresis before going to bed, to help avoid excess fluid from the body. To minimize nocturia, therefore, the user can sit in the chair shown in FIG. 2A, prior to bed, which helps to avoid at least some of the excess water and sodium in the body, thereby reducing the trips to bathroom in the night.

Hypertension: Hypertension affects about 1.28 billion people worldwide (WHO Key facts, https://www.who.int/news-room/fact-sheets/detail/hypertension). Hypertension is defined as systolic blood pressure from 130 to 139 and diastolic blood pressure from 80 to 89 mmHg. Hypertension leads to several serious health complications including heart failure, stroke, kidney disease, vision loss and peripheral artery disease. Although several therapeutic options are available, additional innovative approaches are needed to prevent and treat hypertension. As hypertension is considered to be related to the gravitational effects on the body, the current application describes innovative systems and methods to counteract the gravitational effects using buoyancy force. A large number of studies in people have demonstrated the benefits of hydrotherapy in reducing blood pressure. Water immersion has been shown to reduce 24-hour blood pressure in a randomized study (Roxburgh et al, 2025, Temperature, DOI: 10.1080/23328940.2025.2465025). However, aquatic hydrotherapy in a heated pool is not accessible to everyone. Therefore, the system and methods included in this application can be used to manage hypertension. To use the device, the user sits in the chair and closes the door, and then the bag is filled with water to the desired depth. As hydrostatic forces reduce the sympathetic tone, redistribute blood from feet to the central compartment when seated, reduces plasm volume due to increased urinary output and reduces the workload on the heart, it is anticipated that users will experience a reduction in the blood pressure when seated in the chair and for some time, after leaving the chair. Because of the ability of the system to modify so many factors described above that play a critical role in development of hypertension, it is likely to reduce the number of various therapeutics including diuretics, vasodilators, and calcium channel blockers that are used to maintain hypertension. The duration and frequency of use of the chair or the exercise device is based on the clinician's assessment of the user's condition and response.

Use of the Device in heart attack during CPR: The average survival rate for out of hospital CPR is very low, ranging from 10-20%. The predominant form of CPR by chest compressions (Merchant et. Al., 2020, Circulation. 142 (suppl 2): S337-S357. DOI: 10.1161/CIR.0000000000000 918). Chest compressions during CPR work by increasing intermittent pressure in the cardiac chambers, and large blood vessels and moving the blood forward. Vascular resistance to blood flow is a significant hurdle for the free flow of the blood when the heart is not beating or not functioning properly. External counter pressure devices such as the Military Anti-Shock Trousers (MAST) are advocated as aid to CPR (Patrick et al 1984, MAST usage in Cardiopulmonary resuscitation, Ann. Emerg. Med; 13:9, P833-834, DOI: 10.1016/S0196-0644 (84) 80453-9), and used to be carried around by emergency personnel, but their efficacy in CPR has been questioned (Lateef, F. and Kelvin, T, 2008, J. Emerg Trauma Shock, 1:63-69; DOI: https://doi.org/10.4103/0974-2700. 43181). Several automated chest compression and some experimental abdominal compression devices are in use, but nevertheless, these do not reduce the vascular resistance in an individual that is affected with cardiac arrest and undergoing CPR. Therefore, it is disclosed that the chair and other devices disclosed herein can be used to reduce the vascular resistance in a patient. It is known that vascular resistance is reduced when a person is immersed in warm water, due to buoyancy forces and vasodilation. In order to revive a person, the body of the person suffering from heart-attack will be placed either upright, at an angle or flat in the chair shown in FIG. 2A. The multi-layer bag is then filled with water at the desired temperature. An automated chest compression device (or abdominal compression device) is strapped to the patient following relevant guidelines and the compressions are initiated. The person is then transported to the hospital, along with the chair while administering the CPR, for treatment by medical personnel. The chair disclosed herein, or a modified version of the chair, for example one that resembles a bed or a stretcher, but comprising of double layer bag could be included as standard equipment in an ambulance for such emergencies.

Blood in the vessels generally flows from arteries to veins in one direction, and back flow is generally prevented due to the presence of valves, especially in the lower limbs. When a person enters a swimming pool at a reasonable depth, due to hydrostatic forces, about 700 mL of blood is usually redistributed to the abdominal compartment. Using this principle, it is possible to maintain circulation using the chair shown in FIG. 2A, in this application. When the multi-layer bags are filled with water, the blood that accumulates in the abdomen and chest makes the chest compressions more effective, as more blood is pumped out with each compression. Additionally, to encourage blood, the hydrostatic pressure on the body can be reduced and increased to promote movement of the blood from lower portion of the body to the abdomen and chest area, and such changes in the hydrostatic pressure may be synchronized with the chest/abdominal compressions. Several methods including rapid filling and emptying of the bag with water using pumps, changing the position of the patient from vertical to the horizontal and back repeatedly, while continuing the compressions. Using cold water, instead of warm water has also shown to reduce metabolic demands of the cells, and increase survival chances and therefore, the temperature of the water in the bag may be reduced to desirable temperature using the cooling apparatus attached to the tank.

In addition to the above, blood flow in the person suffering from cardia arrest or other cardiovascular conditions may be further helped by applying pressure over the leg or arm muscles, in such a manner that the pressure is applied all around the leg or the arm, from surface to the deep inside the arm, so as to focus the pressure on the deep arteries such as brachial, redial or femoral arteries. Applying the pressure based on the anatomic location and adjusting the pressure such that the radial pressure applied is focused on the arterial supply, but not on the veins which are present on the surface will promote the arterial blood flow. Additionally, roller type devices can also be sequentially pressed on the arms and legs in the direction of blood flow at anatomical locations where the arteries are close to surface of the skin will also promote blood flow. Care should be taken to avoid major veins at the pressure points in order prevent venous pooling. To promote venous blood flow towards the heart, one could apply slight pressure either on the surface of the arms and legs or along the known anatomical location of the veins. Additionally, the hydrostatic pressure with additional jects applied on the legs can also be modified and synchronized with chest compressions in heart attack patients who is unconscious. Such hydrostatic pressure with jets may also promote both the interstitial as well as vascular blood flow increasing the chances of a heart attack patient.

Chair for Relaxation and to Relieve Stress: The chair disclosed herein for example, FIG. 1, can be useful for relaxation purposes, as it offloads the weight of the body from the feet and spine. The beneficial effects of hydrotherapy and spa therapy are well known. However, access to such facilities, or to the equipment that provides such benefits at home such as Jacuzzi or a massage chair are expensive and space occupying, and therefore not enjoyed by everyone. Therefore, a multipurpose chair or a seat that can serve as regular chair, that does not take up additional space, in the office or at home, in the car or in other transportation modalities and does not get a person while using it has the potential to provide relaxation as well as health benefits to the users. The chair and the multi-layer bag as disclosed herein, which is fitted with jets and rollers for massage rollers. When the person is seated surrounded by the water in the bag, this provides buoyancy. Additionally, the jets and rollers may be used to provide massage to the selected areas of the body and promote blood circulation and relieve stress on the musculoskeletal system as well as psychological well-being. At some places the tank can be part of a chair, or it can be located separately, like in the trunk of the car.

For use of the technology in automobiles including cars, buses and airplanes: People that travel long distances often experience stress and tiredness due to prolonged sitting and the load on the spine and back muscles. Current seats in automobiles allow for reclining the seat backwards, or provide lumbar supports, but these features are often adequate for long distance travelers, resulting in either stress on the back or leading to conditions like deep vein thrombosis, due to pressure on the lower limbs from prolonged sitting compromising the blood circulation. Therefore, in this application, a seat is proposed for use in automobiles or other travel modes, where the seat is provided with a multi-layer bag, and/or chair with separate legs as disclosed herein. The tank may be located away from the seat, for example in the trunk of the car. The multi-layer back is supported by the backrest and flexible side panels of the seat. The multi-layer bag surrounding the legs will be supported by a flexible but strong frame that touches the floor of the car or other vehicles where the person is sitting. The person sits in the seat and secures the flexible panels, and fills the bag with water, when required to offload the stress on the back and on the blood circulation to the limbs

Musculoskeletal disorders including backpain, injuries to vertebral column and spinal cord, sciatica, scoliosis, sports injuries that require rehabilitation, arthritis-related pain, cerebral palsy, quadriplegia and paraplegia: Musculo disorders and injuries to spinal cord and other structures affect many people. Despite advanced therapies including pharmaceutical, surgical and medical devices, there is no effective device that could minimize or prevent the loading on the injured portion. Hydrotherapy is considered effective in these conditions as it temporarily relieves the weight of the upper body on these injured portions. However, due to inherent limitations, hydrotherapy can only be administered for only a limited amount of time every day. As the chair and exercise devices mentioned in this application, act by offloading the body weight and reducing the load on the lower weight bearing portions of the body, they have the potential role in the management of these conditions. Several reports in the literature have shown that aquatic exercise improves musculoskeletal conditions. Chronic backpain (Ma et al, 2022, BMC Musculoskelet Disord. 23:1050. doi: 10.1186/s12891-022-05981-8; Harvard Health Report-https://www.health.harvard.edu/pain/pool-therapy-beats-physical-therapy-for-chronic-low-back-pain), spinal cord injury (Palladino, et al. 2023, 61:317). Therefore, any patients with the above-described conditions will likely benefit from the use of devices disclosed herein, including the chair and the exercise devices for rehabilitation purposes when done under appropriate clinician's or physical therapist's supervision. To use the chair or the exercise device, the user enters the devices and closes the door and the chair, and the exercise devices as disclosed herein. The device, type of rehabilitation, and the frequency and duration will be determined by the physician and therapist.

Blood in the vessels generally flows from arteries to veins in one direction, and back flow is generally prevented due to the presence of valves, especially in the lower limbs. When a person enters a swimming pool at a reasonable depth, due to hydrostatic forces, about 700 mL of blood is usually redistributed to the abdominal compartment. Using this principle, it is possible to maintain circulation using the chair shown in FIG. 1, in this application. When the multi-layer bags are filled with water, the blood that accumulates in the abdomen and chest makes the chest compressions more effective, as more blood is pumped out with each compression. Additionally, to encourage blood, the hydrostatic pressure on the body can be reduced and increased to promote movement of the blood from the lower portion of the body to the abdomen and chest area, and such changes in the hydrostatic pressure may be synchronized with the chest/abdominal compressions. Several methods including rapid filling and emptying of the bag with water using pumps, changing the position of the patient from vertical to the horizontal and back repeatedly, while continuing the compressions. Using cold water, instead of warm water, has also shown to reduce metabolic demands of the cells, and increase survival chances and therefore, the temperature of the water in the bag may be reduced to desirable temperature using the cooling apparatus attached to the tank.

Amnioinfusion: Amnioinfusion involves infusion of normal saline or other fluids into the amniotic cavity through a catheter. Amnioinfusion is done in several conditions of the pregnancy, including oligohydramnios, fetal heart deceleration, meconium-stained amniotic fluid and preterm premature rupture of membranes. These conditions endanger the fetal wellbeing and are often serious. Although amnioinfusion is beneficial, it is not without risks such as infection, over distention of the uterus and preterm labor. Several reports in the literature cited increased amniotic fluid levels in pregnant women that exercise in an aquatic environment in a pool (References: Siccardi 2017; Sechrist 2014). The increased levels of the blood volume in the central compartment and responsible for such increase in the amniotic fluid level (measured by determining the Amniotic Fluid Index). Therefore, it is proposed that the chair as disclosed in FIGS. 1, 26, 27, and 28, in the current application will benefit the pregnant mothers who are experiencing reduced amniotic fluid levels or leakage. As the process is non-invasive, and does not require external fluid administration, it is considered to be relatively less risk to the mother, if done under appropriate medical supervision. For this, the mother diagnosed with low levels of amniotic fluid volume will rest in the Chair shown in FIGS. 1, 26, 27, and 28, and the amniotic fluid levels are periodically monitored. The duration of the treatment and the frequency is determined by the physician.

Cold Therapy: Immersion in cold water has extensively been used for quick recovery from sever exercise or a sport, while providing benefit of hydrotherapy and other health benefits. The chair described in FIG. 2A, may be used to provide hydrotherapy, as the water in the tank can be cooled to desired low temperature using the cooling mechanism incorporated in the device. Unlike ice water immersion, the desired temperature of the device can be controlled using the inbuilt sensors. The sensors that measure the vital signs can also be monitored and appropriate interventions or changes to the conditions made based on these measurements. As the patient stays dry during the cold hydrotherapy, the device provides a very convenient way to exert hydrotherapy under close supervision.

Orthostatic Hypotension and Astronauts Returning from Prolonged Stay in the Space: Orthostatic Hypotension affects up to 5% of people under 50 years of age and up to 20% of the people above 75 years of age (Kim and Farrell, 2022, Am Fam Physician, 105:39-49, PMID 3502990), and defined as a decrease in blood pressure of 20 mmHg Systolic or 10 mmHg diastolic. The condition leads to significant risk of cardiovascular risk and falls and increased mortality. Some of the treatment options are effective but more are needed.

Astronauts returning from prolonged sojourn in the space suffer from cardiovascular deconditioning and lose ability to maintain required blood pressure, immediately on return to earth due to gravitational effects on the cardiovascular system.

In both conditions described above, the devices described in this application, including the chair and the exercise devices may provide an effective solution to reduce the severity of clinical signs, and help with the rehabilitation or maintenance of the blood pressure.

According to an embodiment, disclosed is a device comprising one or more movable panels adapted for entering and exiting of a user; a multi-layer bag is attached to the device, wherein the multi-layer bag comprises an inner layer and an outer layer forming a compartment, and one or more ports; a reservoir comprising a liquid; an inlet pipe connecting the reservoir and the one or more ports to fill the liquid into the multi-layer bag; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the device is adapted for exerting the hydrostatic forces around the portion of the user while sitting or standing in an upright position to experience buoyancy and simulate zero gravity; and wherein the device is configured to enclose the portion of the user and is adapted for hydrotherapy.

According to an embodiment of the device, which optionally includes any one or more of previous embodiments, the device further comprises a pump connecting the reservoir and the inlet pipe to pump the liquid into the multi-layer bag, a power supply unit adapted to supply power to the pump, one or more air pockets on the multi-layer bag to vent out the air when the liquid is being filled, a control unit adapted to control the device, an emergency access button adapted for providing access to the user in case of an emergency, a breathable cover attached to the inner layer, a temperature control unit integrated with the device adapted to maintain the liquid at a predetermined temperature, one or more sensors to measure one or more of a pressure, a temperature, a humidity, a physiological signal of the user, a presence of the user, a weight of the user, one or more vents adapted for providing ventilation in the device for the user, or one or more linear actuators adapted to adjust an angle of a part of the device.

According to an embodiment of the device, which optionally includes any one or more of previous embodiments, the device further comprises cushions, one or more of wheels, a collapsible door, or water jets.

According to an embodiment of the device, which optionally includes any one or more of previous embodiments, the device further comprises roller blades, or pedal and crank.

According to an embodiment of the device, which optionally includes any one or more of previous embodiments, the device is adapted for rapid discharge of the liquid.

According to an embodiment of the device, which optionally includes any one or more of previous embodiments, the device further comprises auxiliary power supply unit.

According to an embodiment of the device, which optionally includes any one or more of previous embodiments, the multi-layer bag is a removable bag.

According to an embodiment of the device, which optionally includes any one or more of previous embodiments, the device is configured as a chair, a bed, a suit, a treadmill, a bike, a waterbirth device, a dry immersion jacuzzi, a patient transporter, or a cardiopulmonary resuscitation device.

According to an embodiment of the device, which optionally includes any one or more of previous embodiments, the device is further configured to increase or decrease volume of water in the multi-layer bag.

According to an embodiment of the device, which optionally includes any one or more of previous embodiments, the device is configured for use in treatment using the hydrotherapy in preeclampsia, clinical shock, hypertension, orthostatic hypotension, intradialytic hypotension, edema of lower extremities, burn injuries, sleep apnea, cardiovascular diseases, cardiopulmonary resuscitation, or dialysis.

According to an embodiment of the device, which optionally includes any one or more of previous embodiments, the device is adapted to be controlled remotely.

According to an embodiment of the device, which optionally includes any one or more of previous embodiments, the reservoir is adjustable in height.

According to an embodiment of the device, which optionally includes any one or more of previous embodiments, the device further comprises chest compression device.

According to an embodiment of the device, which optionally includes any one or more of previous embodiments, the power supply unit is connected to one of an external power supply and a battery.

According to an embodiment of the device, which optionally includes any one or more of previous embodiments, the one or more movable panels comprises one of a shutter door, roller door, a sliding door, and a hinged door.

According to an embodiment of the device, which optionally includes any one or more of previous embodiments, the emergency access button is adapted to change a configuration of the device for emergency access of the user and emptying the multi-layer bag of liquid within a predetermined time, wherein the predetermined time as per a medical regulation.

According to an embodiment, disclosed is a chair comprising one or more movable panels adapted for entering and exiting of a user; a multi-layer bag is attached to the chair, wherein the multi-layer bag an inner layer and an outer layer forming a compartment, and one or more ports; a reservoir comprising a liquid; one or more air pockets on the multi-layer bag; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the chair is adapted for exerting the hydrostatic forces around the portion of the user while sitting or standing in an upright position to experience buoyancy and simulate zero gravity; and wherein the chair is configured to enclose the portion of the user and is adapted for hydrotherapy.

According to an embodiment of the chair, which optionally includes any one or more of previous embodiments, the chair further comprises a pump connecting the reservoir and the one or more ports to pump the liquid into the multi-layer bag, a power supply unit adapted to supply power to the pump; a breathable cover attached to the inner layer, a temperature control unit integrated with the chair adapted to maintain the liquid at a predetermined temperature, one or more sensors to measure one or more of a pressure, a temperature, a humidity, a physiological signal of the user, a presence of the user, a weight of the user, a control unit adapted to control the chair, an emergency access button adapted for providing access to the user in case of an emergency, one or more vents adapted for providing ventilation in the chair for the user, or one or more linear actuators for adjusting one or more of an angle of a backrest and an angle of a footrest of the chair.

According to an embodiment of the chair, which optionally includes any one or more of previous embodiments, the chair comprises wheels adapted for moving the chair on a floor.

According to an embodiment of the chair, which optionally includes any one or more of previous embodiments, the multi-layer bag is removable.

According to an embodiment of the chair, which optionally includes any one or more of previous embodiments, the chair further comprises cushions.

According to an embodiment of the chair, which optionally includes any one or more of previous embodiments, the chair further comprises a collapsible door.

According to an embodiment, disclosed is a bed comprising one or more movable panels adapted for entering and exiting of a user; a multi-layer bag is attached to the bed, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the bed is adapted for exerting the hydrostatic forces around the portion of the user while sitting or standing in an upright position to experience buoyancy and simulate zero gravity; and wherein the bed is configured to enclose the portion of the user and is adapted for hydrotherapy.

According to an embodiment of the bed, which optionally includes any one or more of previous embodiments, the bed further comprises a reservoir comprising a liquid, one or more air pockets on the multi-layer bag, a breathable cover attached to the inner layer, a temperature control unit integrated with the bed adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the bed, an emergency access button adapted for providing access to the user in case of an emergency, one or more vents adapted for providing ventilation in the bed for the user, or one or more linear actuators for adjusting one or more of an angle of a backrest and an angle of a footrest of the bed.

According to an embodiment of the bed, which optionally includes any one or more of previous embodiments, the bed comprises wheels adapted for moving the bed on a floor.

According to an embodiment of the bed, which optionally includes any one or more of previous embodiments, the multi-layer bag is removable.

According to an embodiment of the bed, which optionally includes any one or more of previous embodiments, the bed further comprises cushions.

According to an embodiment of the bed, which optionally includes any one or more of previous embodiments, the bed further comprises a collapsible door.

According to an embodiment, disclosed is a suit comprising one or more openings adapted for entering and exiting of a user; a multi-layer bag is attached to the suit, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the suit is adapted for exerting the hydrostatic forces around the portion of the user while sitting or standing in an upright position to experience buoyancy and simulate zero gravity; and wherein the suit is configured to enclose the portion of the user and is adapted for hydrotherapy.

According to an embodiment of the suit, which optionally includes any one or more of previous embodiments, the suit further comprises one or more air pockets on the multi-layer bag, a breathable cover attached to the inner layer, a reservoir comprising a liquid, a temperature control unit integrated with the suit adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the suit, an emergency access button adapted for providing access to the user in case of an emergency, or one or more vents adapted to provide ventilation in the suit for the user, and wherein the multi-layer bag is removable.

According to an embodiment, disclosed is a treadmill comprising one or more movable panels adapted for entering and exiting of a user; a multi-layer bag is attached to the treadmill, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the treadmill is adapted for exerting the hydrostatic forces around the portion of the user while sitting or standing in an upright position to experience buoyancy and simulate zero gravity; and wherein the treadmill is configured to enclose the portion of the user and is adapted for hydrotherapy.

According to an embodiment of the treadmill, which optionally includes any one or more of previous embodiments, the treadmill further comprises one or more air pockets on the multi-layer bag, a breathable cover attached to the inner layer, a reservoir comprising a liquid, a temperature control unit integrated with the treadmill adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the treadmill, an emergency access button adapted for providing access to the user in case of an emergency, one or more vents adapted for providing ventilation in the device for the user, or roller blades.

According to an embodiment of the treadmill, which optionally includes any one or more of previous embodiments, the treadmill further comprises auxiliary power supply unit.

According to an embodiment, disclosed is a bike comprising one or more movable panels adapted for entering and exiting of a user; a multi-layer bag is attached to the bike, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the bike is adapted for exerting the hydrostatic forces around the portion of the user while sitting or standing in an upright position to experience buoyancy and simulate zero gravity; and wherein the bike is configured to enclose the portion of the user and is adapted for hydrotherapy.

According to an embodiment of the bike, which optionally includes any one or more of previous embodiments, the bike further comprises one or more air pockets on the multi-layer bag, a breathable cover attached to the inner layer, a reservoir comprising a liquid, a temperature control unit integrated with the bike adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the bike, an emergency access button adapted for providing access to the user in case of an emergency, one or more vents adapted for providing ventilation in the device for the user, or wheels adapted for transportability of the bike.

According to an embodiment of the bike, which optionally includes any one or more of previous embodiments, the bike further comprises pedal and crank.

According to an embodiment of the bike, which optionally includes any one or more of previous embodiments, the bike further comprises auxiliary power supply unit.

According to an embodiment, disclosed is a waterbirth device comprising one or more movable panels adapted for entering and exiting of a user; a multi-layer bag is attached to the waterbirth device, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the waterbirth device is adapted for exerting the hydrostatic forces around the portion of the user while sitting or standing in an upright position to experience buoyancy and simulate zero gravity; and wherein the waterbirth device is configured to enclose the portion of the user and is adapted for hydrotherapy.

According to an embodiment of the waterbirth device, which optionally includes any one or more of previous embodiments, the waterbirth device further comprises one or more air pockets on the multi-layer bag, a breathable cover attached to the inner layer, a reservoir comprising a liquid, a temperature control unit integrated with the waterbirth device adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the waterbirth device, an emergency access button adapted for providing access to the user in case of an emergency, one or more vents adapted for providing ventilation in the device for the user, or one or more linear actuators for adjusting one or more of a height, an angle of a backrest and an angle of a footrest of the waterbirth device.

According to an embodiment of the waterbirth device, which optionally includes any one or more of previous embodiments, the waterbirth device comprises wheels adapted for moving the waterbirth device on a floor.

According to an embodiment of the waterbirth device, which optionally includes any one or more of previous embodiments, the multi-layer bag is removable.

According to an embodiment of the waterbirth device, which optionally includes any one or more of previous embodiments, the waterbirth device further comprises cushions.

According to an embodiment of the waterbirth device, which optionally includes any one or more of previous embodiments, the waterbirth device further comprises a collapsible door.

According to an embodiment, disclosed is a dry immersion jacuzzi comprising one or more movable panels adapted for entering and exiting of a user; a multi-layer bag is attached to the dry immersion jacuzzi, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the dry immersion jacuzzi is adapted for exerting the hydrostatic forces around the portion of the user while sitting or standing in an upright position to experience buoyancy and simulate zero gravity; and wherein the dry immersion jacuzzi is configured to enclose the portion of the user and is adapted for hydrotherapy.

According to an embodiment of the dry immersion jacuzzi, which optionally includes any one or more of previous embodiments, the dry immersion jacuzzi further comprises one or more air pockets on the multi-layer bag, a breathable cover attached to the inner layer, a reservoir comprising a liquid, a temperature control unit integrated with the dry immersion jacuzzi adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the dry immersion jacuzzi, an emergency access button adapted for providing access to the user in case of an emergency, one or more vents adapted for providing ventilation in the device for the user, or wheels adapted for moving the dry immersion jacuzzi on a floor.

According to an embodiment of the dry immersion jacuzzi, which optionally includes any one or more of previous embodiments, the multi-layer bag is removable.

According to an embodiment of the dry immersion jacuzzi, which optionally includes any one or more of previous embodiments, the dry immersion jacuzzi further comprises cushions.

According to an embodiment of the dry immersion jacuzzi, which optionally includes any one or more of previous embodiments, the dry immersion jacuzzi further comprises water jets.

According to an embodiment, disclosed is a patient transport device comprising one or more movable panels adapted for entering and exiting of a user; a multi-layer bag is attached to the patient transport device, wherein the multi-layer bag comprises an inner layer and an outer layer forming a compartment, and one or more ports; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the patient transport device is adapted for exerting the hydrostatic forces around the portion of the user while sitting or standing in an upright position to experience buoyancy and simulate zero gravity; and wherein the patient transport device is configured to enclose the portion of the user and is adapted for hydrotherapy.

According to an embodiment of the patient transport device, which optionally includes any one or more of previous embodiments, the patient transport device further comprises one or more air pockets on the multi-layer bag, a breathable cover attached to the inner layer, a reservoir comprising a liquid, a temperature control unit integrated with the patient transport device adapted to maintain the liquid at a predetermined temperature, one or more sensors to measure one or more of a pressure, a temperature, a humidity, a physiological signal of the user, a presence of the user, a weight of the user, a pump connecting the reservoir and the one or more ports to pump the liquid into the multi-layer bag, a power supply unit adapted to supply power to the pump, a control unit adapted to control the patient transport device, an emergency access button adapted for providing access to the user in case of an emergency, one or more vents adapted for providing ventilation in the device for the user; or one or more linear actuators for adjusting a height and an angle of the patient transport device.

According to an embodiment of the patient transport device, which optionally includes any one or more of previous embodiments, the patient transport device comprises wheels adapted for moving the patient transport device on a floor.

According to an embodiment of the patient transport device, which optionally includes any one or more of previous embodiments, the multi-layer bag is removable.

According to an embodiment of the patient transport device, which optionally includes any one or more of previous embodiments, the patient transport device further comprises cushions, or a collapsible door.

According to an embodiment, disclosed is a cardiopulmonary resuscitation device comprising one or more movable panels adapted for entering and exiting of a user; a multi-layer bag is attached to the cardiopulmonary resuscitation device, wherein the multi-layer bag comprises an inner layer and an outer layer forming a compartment, and one or more ports; one or more air pockets on the multi-layer bag; a breathable cover attached to the inner layer; a reservoir comprising a liquid; a temperature control unit integrated with the cardiopulmonary resuscitation device adapted to maintain the liquid at a predetermined temperature; one or more sensors to measure one or more of a pressure, a temperature, a humidity, a physiological signal of the user, a presence of the user, a weight of the user; a pump connecting the reservoir and the one or more ports to pump the liquid into the multi-layer bag; a power supply unit adapted to supply power to the pump; a control unit adapted to control the cardiopulmonary resuscitation device; an emergency access button adapted for providing access to the user in case of an emergency; one or more vents adapted for providing ventilation in the device for the user; and wherein the multi-layer bag is filled with liquid and folded to surround a portion of the user; wherein the inner layer is a thin, flexible, and waterproof membrane that conforms closely to a body shape of the portion of the user and contours such that the user experiences hydrostatic forces and thermal effects of water immersion without direct contact with the liquid; wherein the cardiopulmonary resuscitation device is adapted for exerting the hydrostatic forces around the portion of the user while sitting or standing in an upright position to experience buoyancy and simulate zero gravity; and wherein the cardiopulmonary resuscitation device is configured to enclose the portion of the user and is adapted for hydrotherapy.

According to an embodiment of the cardiopulmonary resuscitation device, which optionally includes any one or more of previous embodiments, the cardiopulmonary resuscitation device further comprises one or more linear actuators for adjusting a height and an angle of the cardiopulmonary resuscitation device; and wherein the cardiopulmonary resuscitation device comprises wheels adapted for moving the cardiopulmonary resuscitation device on a floor.

According to an embodiment of the cardiopulmonary resuscitation device, which optionally includes any one or more of previous embodiments, the multi-layer bag is removable.

According to an embodiment of the cardiopulmonary resuscitation device, which optionally includes any one or more of previous embodiments, the cardiopulmonary resuscitation device further comprises chest compression device.

According to an embodiment of the cardiopulmonary resuscitation device, which optionally includes any one or more of previous embodiments, the cardiopulmonary resuscitation device further comprises a mechanism to increase or decrease volume of the fluid.

According to an embodiment of the cardiopulmonary resuscitation device, which optionally includes any one or more of previous embodiments, the cardiopulmonary resuscitation device further comprises a collapsible door.

According to an embodiment, disclosed is a method comprising, positioning a user in a resting area of a device by moving a movable panel adapted to accommodate at least a portion of the user; closing the movable panel of the device such that a multi-layer bag is surrounds the portion of the user, wherein the multi-layer bag is attached to the device, wherein the multi-layer bag comprises an inner layer and an outer layer forming a compartment, and one or more ports, and wherein the inner layer is a thin, flexible, and waterproof membrane that conforms closely to a body shape of the portion of the user and contours such that the user experiences hydrostatic forces and thermal effects of water immersion without direct contact with a liquid; pumping the liquid, using a pump connected to a reservoir, into the multi-layer bag, wherein the multi-layer bag filled with fluid is folded to surround the portion of the user; controlling one or more of pressure and temperature of the liquid in the multi-layer bag for a hydrotherapy according to one or more of a pre-programmed sequence and in response to real-time input, wherein the control is based on at least one of treatment duration, target anatomical region, intensity level, and feedback from a sensor detecting one or more of a position and physiological response of the user; continuing the hydrotherapy for a predefined period; wherein the device is adapted for exerting the hydrostatic forces around the portion of the user while sitting or standing in an upright position to experience buoyancy and simulate zero gravity; and wherein the device is configured to enclose the portion of the user, and the method is adapted for providing the hydrotherapy.

According to an embodiment, disclosed is a system comprising a device, wherein the device comprises one or more movable panels adapted for entering and exiting of a user; a multi-layer bag attached to the device, wherein the multi-layer bag comprises an inner layer and an outer layer forming a compartment, and one or more ports, and wherein the inner layer is a thin, flexible, and waterproof membrane that conforms closely to a body shape of a portion of the user and contours such that the user experiences hydrostatic forces and thermal effects of water immersion without direct contact with a liquid; a reservoir comprising the liquid; a pump connecting the reservoir and the one or more ports to pump the liquid into the multi-layer bag; a power supply unit adapted to supply power to the pump; one or more air pockets on the multi-layer bag; a temperature control unit integrated with the device adapted to maintain the liquid at a predetermined temperature; a control unit adapted to control the device; an emergency access button adapted for providing access to the user in case of an emergency; and wherein the device is adapted for exerting the hydrostatic forces around the portion of the user while sitting or standing in an upright position to experience buoyancy and simulate zero gravity; and wherein the system is adapted for carrying out the steps comprising, positioning the user in a resting area of the device by moving the one or more movable panels adapted to accommodate at least the portion of the user; closing the one or more movable panels of the device such that the multi-layer bag is surrounding the portion of the user; pumping the liquid, using the pump into the multi-layer bag, wherein the multi-layer bag filled with fluid is folded to surround the portion of the user; controlling one or more of pressure and temperature of the liquid in the multi-layer bag for a hydrotherapy according to one or more of a pre-programmed sequence and in response to real-time input, wherein the control is based on at least one of treatment duration, target anatomical region, intensity level, and feedback from a sensor detecting one or more of a position and physiological response of the user; continuing the hydrotherapy for a predefined period; and wherein the steps are adapted for hydrotherapy.

According to an embodiment, disclosed is a device comprising one or more movable panels adapted for entering and exiting of a user; a layer attached to the device, wherein the layer forms a compartment between the device and the layer; a reservoir comprising a liquid; a pump connecting the reservoir to pump the liquid into the compartment; a power supply unit adapted to supply power to the pump; and wherein the compartment is filled with the liquid such that the layer is folded to surround a portion of the user; wherein the layer is a thin, flexible, and waterproof membrane that conforms closely to a body shape of the portion of the user and contours such that the user experiences hydrostatic forces and thermal effects of water immersion without direct contact with the liquid; wherein the device is adapted for exerting the hydrostatic forces around the portion of the user while sitting or standing in an upright position to experience buoyancy and simulate zero gravity; and wherein the device is adapted for hydrotherapy.

According to an embodiment of the device, which optionally includes any one or more of previous embodiments, the layer comprises one or more layers.

According to an embodiment, disclosed is a bag comprising an inner layer and an outer layer, wherein the inner layer and the outer layer are rectangular in shape; the inner layer comprising a first inner edge comprising a first inner corner and a second inner corner, a second inner edge comprising a second inner corner and a third inner corner, a third inner edge comprising a third inner corner and a fourth inner corner, and a fourth inner edge comprising a fourth inner corner and a first inner corner; the outer layer comprising a first outer edge comprising a first outer corner and a second outer corner, a second outer edge comprising a second outer corner and a third outer corner, a third outer edge comprising a third outer corner and a fourth outer corner, and a fourth outer edge comprising a fourth outer corner and a first outer corner; wherein the first inner edge, the second inner edge, the third inner edge, is attached to the first outer edge, the second outer edge, the third outer edge; wherein the fourth inner edge is folded such that the first inner corner is aligned with the fourth inner corner and attached along the folded edge; and wherein the fourth outer edge is folded such that the first outer corner is aligned with the fourth outer corner and attached along the folded edge; and wherein the inner layer is contained within the outer layer; and wherein the bag is a multi-layer bag.

According to an embodiment of the device, which optionally includes any one or more of previous embodiments, it is a device comprising a multi-layer bag; wherein the multi-layer bag is according to one or more embodiments described herein; and wherein one end of the bag is attached to the device and the other end is attached to a movable panel of the device.

### INCORPORATION BY REFERENCE

All references, including granted patents and patent application publications, referred herein are incorporated herein by reference in their entirety:
U.S. Application Publication US20200016025A1 titled “System and method for exerting a gradient of compressive forces on a body”
U.S. Patent Publication U.S. Pat. No. 10,265,237B2 titled “Systems and methods for exerting force on bodies”

### REFERENCES

1. Maynard, S. E., and Karumanchi, S. A. (2011) Semin Neprhol. DOI: 10.1161/HYPERTENSIONAHA.116.0642
2. Cooke, W. R., Jones, G. D. et al., (2021) Maternal-Fetal Med. DOI: 10.1097/FM9.0000000000000093.
3. Perry, H., Khalil, A., et al. (2018) Trends Cardiovasc Med. DOI: 10.1016/j.tcm.2018.04.009
4. Hahn, R. G. (2024) Int J Obstet Anesth. DOI: 10.1016/j.ijoa.2023.103963
5. Alikhajeh, Y., Afroundeh, et al., (2025) Biol Res Nurs. DOI: 10.1177/10998004241263943
6. Elvan-Taspinar, A., Franx, A., et al. (2006) Am J 10.1016/j.ajog.2006.05.007 Obstet Gynec. DOI:
7. Alexander, B. T., South, A. M., (2023) Hypertension. DOI: 10.1161/HYP.00000000000002
8. Yoshihara, T., Zitsu, M. et al (2020) Sci Rep. DOI: 10.1038/s41598-020-59598
9. Linhares, G. M., Machado, A. V., Malachias, M. V. B. (2020). Arq Bras Cardiol. DOI: 10.36660/abc.20190055
10. Schuker, J. L., Mercer, B. M., et al., (1996) Am J Obstet Gynecol. DOI: 10.1016/s0002-9378 (96) 80045-7
11. Katz, V., Ryder, R. M., et al., (1990) Obstet Gynaec. PMID: 2300341
12. Siccardi, M., (2017) J Perinatal Med. DOI: 10.13140/RG.2.2.30304.17927
13. Sechrist, D. M., Tiongco, C. G., et al. (2015). Occup Ther Health Care. DOI: 10.3109/07380577.2014.982314
14. Strong, T., 1993
15. [Epstein, M., 1992; Epstein, M., 1987; Grossman, et al 1992; Miwa et al 1996]
16. [Dickinson K, Roberts I. MAST for circulatory support in patients with trauma. The Cochrane Library; 2001], [O'Connor R E, Domeier R. 1997, Use of Pneumatic Anti-Shock Garment (PASG): NAEMSP Position Paper. Prehosp Emerg Care. 1:32-5]
17. [Lateef F and Kelvin T., 2008 Military anti-shock garment: Historical relic or a device with unrealized potential? J Emerg Trauma Shock. 1 (2): 63-69.], [Krishna G G, Danovitch G M., 1984, Renal response to lower body positive pressure produced by military anti-shock trousers., Am J Nephrol., 4 (1): 13-8]
18. [Reference: Cartier, C. J., 1988, Pressure Therapy Using a Mercury Bath. Indications, and Results., Phlebologie, 1988, 41:379-390]
19. [Bertolini, G and Straumann, D., 2016, Moving in a Moving World: A Review on Vestibular Motion Sickness., Frontiers in Neurology. 2016; 7:141.
20. [Kokot, et al, 1983, Katz, et al 1990, Katz, et al 1992, Elvan-Taspinar 2006]
21. [Smart L J Jr, Stoffregen T A, Bardy B G. 2002, Hum Factors, 44 (3): 451-65]
22. (U.S. Pat. Nos. 4,738,486, 4,189,181, 4,838,613, 4,391,466; Rothchild—U.S. Pat. No. 8,007,046—Assisting passenger while sleeping; Sereboff—U.S. Pat. No. 4,761,011—water cushion stress reducing assemblies for chairs and other seating devices),
23. (PMID: 29436152 DOI: 10.1111/hdi.12634)

1.-63. (canceled)

64. A device comprising:
one or more movable panels adapted for entering and exiting of a user;
a multi-layer bag attached to the device, wherein the multi-layer bag comprises an inner layer and an outer layer forming a compartment, and one or more ports;
a reservoir comprising a liquid;
a pump connecting the reservoir and the one or more ports to pump the liquid into the multi-layer bag;
a power supply unit adapted to supply power to the pump;
a control unit adapted to control the device;
an emergency access button adapted for providing access to the user in case of an emergency; and
wherein the multi-layer bag is filled with fluid and folded to surround a portion of the user;
wherein the inner layer is a thin, flexible, and waterproof membrane that conforms closely to a body shape of the portion of the user and contours such that the user experiences hydrostatic forces and thermal effects of water immersion without direct contact with the liquid;
wherein the device is adapted for exerting the hydrostatic forces around the portion of the user while sitting or standing in an upright position to experience buoyancy and simulate zero gravity; and
wherein the device is configured to enclose the portion of the user and is adapted for hydrotherapy.

65. The device according to claim 64, wherein the device further comprises
one or more sensors to measure one or more of a pressure, a temperature, a humidity, a physiological signal of the user, a presence of the user, a weight of the user,
an auxiliary power supply unit,
one or more valves,
one or more vents adapted for providing ventilation in the device for the user,
one or more cushions,
one or more water jets,
one or more massage units,
a collapsible door,
a breathable cover attached to the inner layer,
one or more linear actuators adapted to adjust an angle of a part of the device, or
one or more wheels.

66. The device of claim 64, wherein the multi-layer bag is a removable bag.

67. The device of claim 64, wherein the movable panels comprises one of a shutter door, roller door, a sliding door, and a hinged door.

68. The device of claim 64, wherein the device further comprises chest compression device.

69. The device of claim 64, wherein the emergency access button is adapted to change a configuration of the device for emergency access of the user and emptying the multi-layer bag of liquid within a predetermined time.

70. The device of claim 64, wherein the reservoir is adjustable in height.

71. The device of claim 64, wherein the device is adapted to be controlled remotely.

72. The device of claim 64, wherein the device is configured for use in treatment using the hydrotherapy in
preeclampsia,
clinical shock,
hypertension,
orthostatic hypotension,
intradialytic hypotension,
edema of lower extremities,
burn injuries,
sleep apnea,
cardiovascular diseases,
cardiopulmonary resuscitation, or
dialysis.

73. The device of claim 64, wherein the device further configured to increase or decrease volume of water in the multi-layer bag.

74. The device of claim 64, wherein the device further comprises a temperature control unit integrated with the device and adapted to maintain the liquid at a predetermined temperature.

75. The device of claim 64, wherein the device further comprises one or more air pockets on the multi-layer bag to vent out the air when the liquid is being filled.

76. The device of claim 64, wherein the power supply unit is connected to one of an external power supply and a battery.

77. The device of claim 64, wherein the movable panels are one of a shutter door, roller door, a sliding door, and a hinged door.

78. The device of claim 64, wherein the device is adapted for rapid discharge of the liquid.

79. The device of claim 64, wherein the device is configured as a chair, a bed, a suit, a treadmill, a bike, a waterbirth device, a dry immersion jacuzzi, a patient transporter, or a cardiopulmonary resuscitation device.

80. A method comprising,
positioning a user in a resting area of a device by moving a movable panel adapted to accommodate at least a portion of the user;
closing the movable panel of the device such that a multi-layer bag is surrounds the portion of the user, wherein the multi-layer bag is attached to the device, wherein the multi-layer bag comprises an inner layer and an outer layer forming a compartment, and one or more ports, and wherein the inner layer is a thin, flexible, and waterproof membrane that conforms closely to a body shape of the portion of the user and contours such that the user experiences hydrostatic forces and thermal effects of water immersion without direct contact with a liquid;
pumping the liquid, using a pump connected to a reservoir, into the multi-layer bag, wherein the multi-layer bag filled with fluid is folded to surround the portion of the user;
controlling one or more of pressure and temperature of the liquid in the multi-layer bag for a hydrotherapy according to one or more of a pre-programmed sequence and in response to real-time input, wherein the control is based on at least one of treatment duration, target anatomical region, intensity level, and feedback from a sensor detecting one or more of a position and physiological response of the user;
continuing the hydrotherapy for a predefined period;
wherein the device is adapted for exerting the hydrostatic forces around the portion of the user while sitting or standing in an upright position to experience buoyancy and simulate zero gravity; and
wherein the device is configured to enclose the portion of the user, and the method is adapted for providing the hydrotherapy.

81. The method of claim 80, wherein the method is configured for use in treatment using the hydrotherapy in
preeclampsia,
clinical shock,
hypertension,
orthostatic hypotension,
intradialytic hypotension,
edema of lower extremities,
burn injuries,
sleep apnea,
cardiovascular diseases,
cardiopulmonary resuscitation, or
dialysis.

82. The method of claim 80, wherein the method is implemented using the device, wherein the device is configured as chair, bed, suit, treadmill, bike, waterbirth device, dry immersion jacuzzi, patient transporter, or cardiopulmonary resuscitation device.

83. A system comprising:
a device, wherein the device comprises
one or more movable panels adapted for entering and exiting of a user;
a multi-layer bag attached to the device, wherein the multi-layer bag comprises an inner layer and an outer layer forming a compartment, and one or more ports, and wherein the inner layer is a thin, flexible, and waterproof membrane that conforms closely to a body shape of a portion of the user and contours such that the user experiences hydrostatic forces and thermal effects of water immersion without direct contact with a liquid;
a reservoir comprising the liquid;
a pump connecting the reservoir and the one or more ports to pump the liquid into the multi-layer bag;
a power supply unit adapted to supply power to the pump;
one or more air pockets on the multi-layer bag;
a temperature control unit integrated with the device adapted to maintain the liquid at a predetermined temperature;
a control unit adapted to control the device;
an emergency access button adapted for providing access to the user in case of an emergency; and
wherein the device is adapted for exerting the hydrostatic forces around the portion of the user while sitting or standing in an upright position to experience buoyancy and simulate zero gravity; and
wherein the system is adapted for carrying out the steps comprising,
positioning the user in a resting area of the device by moving the one or more movable panels adapted to accommodate at least the portion of the user;
closing the one or more movable panels of the device such that the multi-layer bag is surrounding the portion of the user;
pumping the liquid, using the pump into the multi-layer bag, wherein the multi-layer bag filled with fluid is folded to surround the portion of the user;
controlling one or more of pressure and temperature of the liquid in the multi-layer bag for a hydrotherapy according to one or more of a pre-programmed sequence and in response to real-time input, wherein the control is based on at least one of treatment duration, target anatomical region, intensity level, and feedback from a sensor detecting one or more of a position and physiological response of the user;
continuing the hydrotherapy for a predefined period; and
wherein the steps are adapted for hydrotherapy.
